(19) United States
(12) Patent Application Publication
(10) Pub. No.: US 2022/0227994 A1
(43) Pub. Date: Jul. 21, 2022

(54) POLYMERIC COMPOSITIONS COMPRISING POLYLACTIC ACID (PLA) AND COPOLYMERS THEREOF

(71) Applicant: Xyleco, Inc, Wakefield, MA (US)

(72) Inventors: Christopher G. Cooper, Rehoboth, MA (US); Nathan J. Tyburczy, Billerica, MA (US); Marshall Medoff, Brookline, MA (US); Thomas Craig Masterman, Rockport, MA (US); David A. Jablonski, Whitman, MA (US)

(21) Appl. No.: 17/606,975

(22) PCT Filed: Apr. 29, 2020
(86) PCT No.: PCT/US20/30365

§ 371 Date: Oct. 27, 2021

Related U.S. Application Data
(60) Provisional application No. 62/937,023, filed on Nov. 18, 2019.
(60) Provisional application No. 62/889,890, filed on Aug. 21, 2019.
(60) Provisional application No. 62/840,948, filed on Apr. 30, 2019.

(51) Int. Cl. C08L 67/04; C08L 67/02

(52) U.S. Cl. CPC C08L 67/04; C08L 67/025

(57) ABSTRACT

In various embodiments, the present invention provides polymeric compositions that combine polylactic acid (PLA) (or heteropolymers of lactic acid) with additives (organic or inorganic), such as elastomeric additives and/or co-polymer additives. Such polymeric blends may exhibit improved mechanical properties and/or degradation rates compared to PLA homo-polymer (or a lactic acid heteropolymer).

### FIELD OF THE INVENTION

The present invention relates to polymeric compositions comprising polylactic acid (PLA) homo-polymer or a heteropolymer of lactic acid and one or more other monomers, combined with one or more additives (organic or inorganic), such as elastomeric additives and/or co-polymer additives, to improve the mechanical properties and/or degradation rate of the polymeric composition compared to PLA homo-polymer or a lactic acid heteropolymer.

### BACKGROUND OF THE INVENTION

Commercial plastics such as polyethylene, polypropylene, and polyethylene terephthalate are typically derived from the distillation and polymerization of nonrenewable petroleum reserves. They have very long degradation times—generally estimated in the range of 500 to 1,000 years or more—in the environment under ambient conditions. Synthetic textiles that are used to make apparel and certain disposable household, personal care, and medical products also often contain polymers (such as, e.g., polyester or nylon) that can take up to 200-1,000 years to fully degrade.

In 2015, the world created 448 million tons of plastic—more than twice the amount produced in 1998. Plastic is choking marine life in the oceans, especially in regions of the world where the oceans are dumps for municipal waste. Therefore, in recent decades, there has been a focus on degradables, such as biodegradable plastics derived from renewable sources that can be decomposed by bacteria or other living microorganisms.

Polylactic acid (PLA) is a thermoplastic polymer that is synthesized from lactic acid or lactide, which are derived from renewable raw material such as biomass (as opposed to nonrenewable fossil fuel reserves). PLA is also biocompatible, such that its monomer unit (lactic acid) can be easily processed by living organisms. At the same time, however, commercial PLA is brittle and has a long degradation time under ambient conditions. These characteristics limit its usefulness in items like cutlery and consumer goods packaging.

### SUMMARY OF THE INVENTION

A need exists for PLA polymeric blends that exhibit improved mechanical properties (such as modulus of elasticity, maximum tensile strength, impact resistance, cold temperature performance, and ductility (strain to failure)) and/or that degrade more quickly than PLA homo-polymer. Such polymeric blends of PLA can be used for a wide range of industrial and consumer products, as described herein. In addition, because PLA can be made from renewable raw material such as biomass (for example, lignocellulosic biomass such as corn cobs), using PLA polymeric blends instead of polymeric materials made primarily from non-renewable fossil fuel sources can reduce reliance on fossil fuels, reduce plastic waste in the environment, and decrease global warming.

While some of the polymeric compositions (e.g., intimate or physical polymeric blends) described herein include degradable (e.g., biodegradable) and non-degradable materials (e.g., inorganic materials or non-degradable additives including non-degradable elastomers), the compositions largely degrade (break down) in the environment, and they therefore may be described as degradable polymeric compositions or blends. Because they largely degrade in the environment, their use can materially contribute to the reduction of plastic waste in the environment, to the reduction of global warming, and to the reduction of blue water consumption, thereby conserving precious world resources for future generations. The polymeric compositions described herein degrade in the environment with the assistance of moisture and warmth, conditions that exist nearly everywhere on earth, including in the oceans. While no microorganisms are needed for degradation of any polymeric composition described herein, in some instances, the rate of degradation may be enhanced by utilizing various enzymes (e.g., esterases, proteases, cellulases, and/or amylases as purified enzymes or enzyme preparations), or by utilizing an organism that produces one or more of these enzymes (such as bacterial, yeast, or fungal organisms, examples of which include lactobacillus, soil bacteria such as one or more of clostridium bacteria and thermus bacteria (found in common composters), or one or more organisms found in fresh water or sea water). In addition, while chemicals and other substances are not required for degradation of the polymeric compositions described herein, in some instances, chemicals or other substances can enhance their degradation rate. For example, the saline in seawater can enhance hydrolysis of many of the polymeric blends described herein. Further, while neither oxygen nor light is required for degradation of the polymeric compositions described herein, for some compositions, either or both can enhance degradation rates; for example, oxygen combined with ultraviolet (UV) light, e.g., UV-C light (280-100 nm) and/or UV-B light (315-280 nm), may enhance degradation rates.

The present invention provides polymeric compositions (e.g., binary, ternary, and quaternary polymeric compositions that are polymer blends (which include, for example, polymer alloys)) that combine polylactic acid (PLA) or heteropolymers (also called copolymers) of lactic acid (such as, e.g., heteropolymers of lactic acid and glycolic acid) with organic or inorganic additives, e.g., elastomeric additives (for example, thermoplastic elastomers) and/or co-polymer additives, to improve the mechanical properties (such as modulus of elasticity, maximum tensile strength, impact resistance, cold temperature performance, and ductility) and/or degradation rates of the polymeric compositions compared to PLA or a lactic acid heteropolymer, as described herein. Such additives can be solids or liquids at room temperature.

Generally, PLA and/or heteropolymers of lactic acid can be blended with one or more additives (inorganic or organic), in any particular weight percentages, as described herein, to produce materials having tailored mechanical properties and/or degradation rates. For example, a polymer blend (e.g., polymer alloy) may include two organic additives (e.g., two different elastomers, as described herein), or may include two organic additives (such as two different elastomers) and an inorganic additive (e.g., calcium carbonate or talc). In still other embodiments, the polymer blend (e.g., polymer alloy) may include one organic additive (e.g., an elastomeric additive or a rigid additive such as a rigid thermoplastic polyurethane) and one inorganic additive (e.g., calcium carbonate). In another embodiment, the polymer blend (e.g., polymer alloy) may include two organic additives, with one organic additive being an elastomeric additive and the other organic additive being an organic dispersing agent, and one inorganic additive (e.g., clay or talc).

As described herein, a polymer blend may be an intimate melt blend, for example, an alloy (e.g., a compatible alloy), or a physical blend that is, for example, formed by dry blending pellets of the PLA (and/or heteropolymer of lactic acid) and of the different additives. Such dry blends may then become intimate melt blends upon, for example, melt processing. In some instances, dry blends may be preferable, for example, from a cost point of view because their production may involve fewer processing steps. In other instances, dry blends may be preferable to reduce the thermal history of the blends and thereby enhance the properties of the finished goods. In instances where the additive is a liquid, it can be dry blended by providing the additive as an encapsulated product. In other embodiments, some additives may be pre-compounded to form a masterbatch, and the masterbatch is dry blended with the other ingredients of the blend.

In some embodiments, the polymeric composition comprises PLA (or a heteropolymer of lactic acid) and four, five, six, or seven different additives, which can be elastomeric additives and/or co-polymer additives. The polymeric compositions may comprise inorganic or organic materials, for example, fibers such as cellulose fibers or glass fibers. Other additives include, for example, minerals, clays, carbon black, cross-linked plastics, and cross-linked hydrogels. Silica, talc, or calcium carbonate may also be included in the polymeric compositions described herein; such materials may be used, for example, to reduce the amount of plastic used to make an item (which may reduce production cost), to improve mechanical or physical properties of the composition (e.g., improve heat deflection temperature), and/or to improve processing parameters (e.g., improve cycle or manufacturing process time).

In any particular embodiment described herein, the blend may be an intimate binary polymeric blend of a PLA in any stereoisomeric purity (such as, for example, greater than 90 percent of the L-isomer, or greater than 90 percent of the D-isomer) and a polyester (e.g., a copolyester; copolyesters include rigid and elastomeric copolyesters and therefore include copolyester elastomers, such as copolyester elastomers having polyether soft blocks, polyethylene glycol, polypropylene glycol, or poly(tetramethylene) ether glycol (polyTHF)). Optionally, this embodiment may further include an inorganic filler such as calcium carbonate. In a specific embodiment, a physical blend comprising PLA, a copolyester, and a masterbatch of calcium carbonate in PLA is made by physically mixing pellets of each of the foregoing.

In some embodiments, the polymeric composition is a binary polymeric blend comprising PLA (or a heteropolymer of lactic acid) and one elastomeric additive. In other embodiments the polymeric composition is a ternary polymeric blend comprising PLA (or a heteropolymer of lactic acid) and two elastomeric additives. In still other embodiments, the polymeric composition is a quaternary polymeric blend comprising PLA (or a heteropolymer of lactic acid) and three elastomeric additives. In addition, blends of PLA homo-polymer and co-polymer additives, or blends of heteropolymers of lactic acid and co-polymer additives, may be utilized in such polymeric compositions comprising elastomeric additive(s), as described herein. In certain embodiments, the polymeric composition is a polymer alloy comprising PLA, a co-polyester elastomer, and a polyolefin elastomer (POE) such as a styrene-isobutylene-styrene (SIBS) block copolymer, a styrene-butadiene-styrene (SBS) block copolymer, or a styrene-ethylene-butadiene-styrene block copolymer (SEBS). In specific embodiments, the POE is a SIBS block copolymer—for example, embodiments of the polymeric blends described herein include polymer alloys of PLA, a co-polyester elastomer, and a SIBS block copolymer.

In some embodiments, the polymeric composition is a binary polymeric blend comprising PLA (or a heteropolymer of lactic acid) and one co-polymer additive. In other embodiments, the polymeric composition is a ternary polymeric blend comprising PLA (or a heteropolymer of lactic acid) and two co-polymer additives. In still other embodiments the polymeric composition is a quaternary polymeric blend comprising PLA (or a heteropolymer of lactic acid) and three co-polymer additives. In addition, blends of PLA homo-polymer and elastomeric additives, or blends of heteropolymers of lactic acid and elastomeric additives, may be utilized in such polymeric compositions comprising co-polymer additive(s), as described herein.

In some embodiments, the polymeric composition is a ternary polymeric blend comprising PLA (or a heteropolymer of lactic acid), one elastomeric additive, and one co-polymer additive. In still other embodiments the polymeric composition is a quaternary polymeric blend comprising PLA (or a heteropolymer of lactic acid), two elastomeric additives, and one co-polymer additive. In still other embodiments the polymeric composition is a quaternary polymeric blend comprising PLA (or a heteropolymer of lactic acid), one elastomeric additive, and two co-polymer additives.

In certain embodiments, the polymeric composition comprises at least 80 percent by weight (wt. %) PLA, at least 85 wt. % PLA, or at least 90 wt. % PLA. In certain embodiments, at least 90 wt. % of the polymeric composition (including any additives) is degradable at a rate that is at least as fast as (e.g., that is faster than) the degradation rate of the PLA homo-polymer used in the composition. In preferred embodiments, at least 95 wt. % of the polymeric composition (including any additives) is degradable at a rate that is at least as fast as the degradation rate of the PLA homo-polymer used in the composition. For example, blends of PLA, Hytrel, and polyethylene oxide, and blends of PLA, Hytrel, and an adipate-based polymer (such as an adipate-based polymer available from SONGWON Industrial), generally degrade at a rate that is faster than the degradation rate of the PLA homo-polymer used in the blends. In further embodiments, the polymeric composition may comprise one or more elastomeric additives, wherein each elastomeric additive is present in an amount up to 1 wt. %, up to 3 wt. %, up to 5 wt. %, up to 10 wt. %, or up to 15 wt. %. In additional embodiments, the polymeric composition may comprise one or more co-polymer additives, wherein each co-polymer additive is present in an amount up to 1 wt. %, up to 3 wt. %, up to 5 wt. %, up to 10 wt. %, or up to 15 wt. %. In any of the foregoing embodiments, the composition may comprise a heteropolymer of lactic acid instead of or in addition to the PLA.

Additives that can be used in any polymer blend described herein include inorganic additives and non-meltable organic additives (such as cellulose, or vulcanized rubbers and vulcanized elastomers). For example, talc, calcium carbonate, silica, and/or glass can be used in the polymer blends described herein. Glass may be in the form of glass fibers having a significant length-to-diameter (L/D) ratio (e.g., greater than 1.1); similarly, the talc used may be high aspect ratio talc. Using inorganic additives and/or non-meltable organic additives, especially such additives that are found in nature (such as talc, calcium carbonate, and silica), can reduce the amount of plastic used to make a product, and can thereby reduce production cost; using such additives can also improve processing of a blend and produce products with improved properties. The amount of any inorganic and/or non-meltable organic additive utilized in any degradable polymeric blend described herein can be, for example, from about 0.5 to about 40 percent by weight (wt. %), such as from about 1 wt. % to about 30 wt. %, from about 2 wt. % to about 25 wt. %, from about 3 wt. % to about 20 wt. %, or from about 4 wt. % to about 18 wt. % of the blend. For glass, L/D ratios can be, for example, greater than about 1.2, greater than about 1.3, greater than about 1.4, or greater than about 1.5 (e.g., at least about 2, at least about 3, at least about 4, or at least about 5). When a non-meltable additive is utilized, such additive may have a plate-type structure, such as the structure of some natural clays, or a ‘snowflake’ like structure, such as the structure of some forms of silica, for example silica of volcanic nature.

Additional suitable additives that can be used in any of the above embodiments are described further below. In addition, in any of the above embodiments, a heteropolymer of lactic acid (such as, e.g., a heteropolymer of lactic acid and glycolic acid, a heteropolymer of lactic acid and methacrylate, a heteropolymer of lactic acid and triethylsilane, etc.) may be used instead of or in addition to PLA.

The PLA (or lactic acid heteropolymer) polymeric blends described herein may be extruded, for example, in the form of an extruded rod or sheet, with orientation (e.g., uniaxial or biaxial orientation) or without orientation; molded, for example, injection molded, injection blow molded, or extrusion blow molded; or blown or cast into a film, for example, in the form of thin sheets. Any of these forms—extruded, molded, or blown or cast—can have multiple layers, for example, 2, 3, 4, 5, 6, or 7 layers, with one or more tie-layers, if desired, for inter-layer adhesion (e.g., to improve adhesion between one or more of the 2, 3, 4, 5, 6, or 7 layers). Single- or multi-layer films may be compression molded or thermoformed into a variety of single-use degradable items, such as clamshell packaging (for example, for bakery products), packing peanuts, and trays (for example, meat trays).

The polymeric blends of PLA (and/or of a heteropolymer of lactic acid) described herein may be spun into fibers or filaments ranging in diameter (if generally circular in cross-section) or having a maximum cross-section dimension of between about 10 nm to about 2.50 mm, about 25 nm to about 1.50 mm, about 50 nm to about 1.00 mm, about 75 nm to about 0.75 mm (about 750 microns), about 100 nm to about 0.50 mm (about 500 microns), about 150 nm (about 0.15 microns) to about 250 microns, or about 1 micron to about 100 microns. In cross-section, each filament can be, for example, circular, star-shaped, or multi-lobal (e.g., tri-lobal or tetra-lobal). As described herein, each filament can include a blend of plastics or can include any number of discrete portions, each portion being a different material (e.g., one or more portions may be a non-degradable material) to form, for example, bi-, tri- or tetra-component filaments or fibers. If desired, combinations of degradable and non-degradable plastics may be utilized. In addition, in some embodiments, combinations of natural and synthetic fibers and filaments can be utilized; in further embodiments, such synthetic fibers and filaments may be degradable plastics and/or non-degradable plastic fibers and filaments. In such embodiments, degradable and non-degradable materials can be blended, for example, by using a bobbin of degradable material, as described herein, and a bobbin of another material, such as a natural fiber, and then twisting them together to form a yarn.

In certain embodiments, the fibers or filaments made of the polymeric blends described herein are used to form woven and/or nonwoven textiles. The polymeric blends can also be used to make knit fabrics. Non-woven fabrics can be utilized to produce an array of single-use consumer products, for example, absorbent consumer products such as baby diapers, baby wipes, food tray diapers (e.g., meat tray diapers). For greater absorbency, the formed non-woven material, such as spun-bond material, can be treated with a super absorbent polymer (e.g., acrylamide, acrylic acid, or polyvinyl alcohol-based super absorbent polymer), with plasma, or with corona.

Examples of woven textiles include but are not limited to buckram fabric, cambric fabric, casement fabric, cheesecloth, chiffon fabric, chintz fabric, corduroy fabric, crepe fabric, denim fabric, drill fabric, flannel fabric, gabardine fabric, georgette fabric, Kashmir silk fabric, khadi fabric, lawn fabric, mulmul fabric, muslin fabric, poplin fabric, sheeting fabric, taffeta fabric, tissue fabric, velvet fabric, mousseline fabric, organdie fabric, organza fabric, leno fabric, aertex fabric, madras net muslin fabric, and aida cloth.

Examples of knit fabrics include but are not limited to jersey, ponte jersey, ribbing fabric, sweatshirt fleece, interlock fabric, spandex knit, double knit, and polar fleece.

Nonwoven textiles, as described herein, can be designed to mimic woven textiles and can be used in a variety of applications including, but not limited to, apparel, upholstery, linens, and other personal and household items. Nonwoven textiles made with the PLA (and/or lactic acid heteropolymer) polymeric compositions described herein may also be used in a variety of agricultural, medical, and other industrial applications.

The PLA (and/or lactic acid heteropolymer) polymeric blends described herein may also be used to create foamed polymers, as described further below.

The polymeric blends of PLA (and/or of a heteropolymer of lactic acid) described herein can be used for a wide range of products including, but not limited to, plastic bags, plastic bottles, personal diapers, food trays (for example, meat trays), food tray diapers and wrappings (for example, the absorbent liner used on meat trays, and wrappings for meat trays), beverage stirrers, straws, envelopes, filters, household and personal wipes, plastic cutlery and utensils, apparel such as sports apparel, clothing, and shoes (e.g., upper and/or lower portions of shoes), landscaping fabrics, house wraps, insulation, tires, and packaging materials (e.g., consumer goods packaging, pill packs, air pillows (such as sealed air), packing peanuts, and blister packs). A desirable application is any product that can benefit from the degradable and renewably-sourced nature of the polymeric blends described herein. For example, in the case of meat trays, using the polymeric compositions described herein to produce meat trays can eliminate the need for expanded polystyrene trays that are commonly used today.

Any of the PLA (or lactic acid heteropolymer) polymeric blends, e.g., intimate melt blends or physical blends, as described herein, or any product, fiber, or fabric described herein, can include from about 35 to about 100 percent modern carbon (pMC), such as from about 40 pMC to about 99 pMC, from about 50 pMC to about 95 pMC, or from about 60 pMC to about 94 pMC. In some instances, the polymeric blends (including any additives described herein that may be used in the blends) can include greater than about 50 pMC, such as greater than about 55 pMC, greater than about 60 pMC, greater than about 65 pMC, greater than about 70 pMC, greater than about 75 pMC, greater than about 80 pMC, or more, e.g., greater than about 90 pMC or greater than about 94 pMC.

The PLA (or lactic acid heteropolymer) polymeric blends, e.g., intimate or physical blends, described herein can comprise any one or more additives described herein, which individually can be described as degradable or non-degradable. In instances where at least one additive that is used in the blend is degradable, both the degradable additive(s) and the PLA (or lactic acid heteropolymer) will degrade (break down). Accordingly, a product made from such a blend will at least partially degrade when exposed to the environment (e.g., warmth and moisture), such that the part of the product that is made from the degradable additive(s) and PLA (or lactic acid heteropolymer) will no longer exist intact (in its original form) after a period of time—for example, after a period of time that is less than 5 years, less than 4 years, less than 3 years, less than 2 years, less than 1 year, or less than 6 months. Any residue of the polymeric blend remaining after degradation (for example, into carbon dioxide and water, or into lactic acid in the case of PLA) of the degradable additive(s) and of the PLA (or the heteropolymer of lactic acid) in the blend, as measured by a stable weight of the residue remaining, can be from about 0 to about 40 percent, such as from about 0.1 to about 35 percent, from about 0.5 to about 30 percent, from about 1 to about 25 percent, or from about 2 to about 20 percent, of the original weight of the polymer blend. The degree to which a polymeric blend breaks down and loses mass over time can be estimated by testing, for example by test method ISO 20200:2015(E) (which is hereby incorporated by reference herein in its entirety), which measures the reduction in mass of a sample under conditions simulating an aerobic composting process.

In some embodiments in which the PLA and/or one or more additives in a PLA polymeric blend is/are produced from lignocellulosic material(s), such as corn cob or corn stover, the blend may have a Global Warming Potential (GWP) reduction of 25% or more, when compared to the GWP of the same blend composition made with PLA produced from non-lignocellulosic feedstocks, such as corn grain, sugarcane sugars, or sugar beet sugars. In specific embodiments, the GWP reduction can be greater than about 40%, such as greater than about 45%, greater than about 50%, greater than about 55%, or greater than about 60% or more, such as, for example, greater than about 70% or greater than about 80%, when compared to the same blend composition but where the PLA was produced from non-lignocellulosic feedstocks.

In addition, when using PLA made from lignocellulosic material(s), such as corn cob or corn stover, the resulting blend may have a Blue Water Consumption (BWC) reduction of 25% or more, when compared to the BWC of the same blend composition made with PLA produced from non-lignocellulosic feedstocks (such as corn grain, sugarcane sugars, or sugar beet sugars). In certain embodiments, the BWC reduction can be greater than about 40%, such as greater than about 45%, greater than about 50%, greater than about 55%, or greater than about 60% or more, such as, for example, greater than about 70% or greater than about 80%, when compared to the same blend composition but where the PLA in the blend was produced from non-lignocellulosic feedstocks.

Any of the PLA or lactic acid heteropolymer polymeric blends (intimate melt blend or physical blend) that contains any one or more of the additives described herein, can be processed utilizing standard plastic processing equipment, including, for example, extruders, injection molding machines, filament lines, including multicomponent filament lines, fiber lines, extrusion blow molding machines, injection blow molding machines, blown film machines, sheet and film machines, and thermoforming machines.

Any of the PLA or lactic acid heteropolymer polymeric blends described herein can include lubricants, dispersing agents, or other processing aids (e.g., coupling agents such as silane coupling agents). Such lubricants, dispersing agents, and other processing aids may be used to enhance the processing characteristics of the blends, or to disperse inorganic additives (if used) within the polymer matrix, for example. Lubricants include, for example, polyethylene waxes, oxidized polyethylene waxes, paraffin, fatty acids, amides, esters, and metallic soaps such as zinc soaps. Dispersing agents include, for example, unsaturated organic acids, acid functionalized polymers, and waxes. In certain embodiments, processing aids are utilized in the polymeric composition at a level of less than about 5 percent by weight (wt. %), such as less than about 4 wt. %, less than about 3 wt. %, less than about 2 wt. %, less than about 1 wt. %, or less than about 0.5 wt. %.

### BRIEF DESCRIPTION OF THE DRAWINGS

FIG. 1 is a graph depicting the change in weight average molecular weight (M_{w}) over time of Polymer Blend A (90 wt. % Ingeo™ Biopolymer 3052D, 10 wt. % PEBAX® 2533 SA 01) when incubated at 95% relative humidity (RH) and at a temperature of 95° F. (308.15° K), 120° F. (322.04° K), or 140° F. (333.15° K).

FIG. 2 is a graph depicting the change in weight average molecular weight (M_{w}) over time of Polymer Blend B (90 wt. % Ingeo™ Biopolymer 3052D, 10 wt. % Hytrel® 3078) when incubated at 95% relative humidity (RH) and at a temperature of 95° F. (308.15° K), 120° F. (322.04° K), or 140° F. (333.15° K).

FIG. 3 is a graph depicting the change in weight average molecular weight (M_{w}) over time of the following polymeric compositions, when incubated at 95% relative humidity (RH) and a temperature of 120° F. (322.04° K): Polymer Blend A (90 wt. % Ingeo™ Biopolymer 3052D, 10 wt. % PEBAX® 2533 SA 01), Polymer Blend B (90 wt. % Ingeo™ Biopolymer 3052D, 10 wt. % Hytrel® 3078), Polymer Blend C (90 wt. % Ingeo™ Biopolymer 3052D, 10 wt. % ecoflex® F Blend C1200), and Polymer Blend D (control composition: 100 wt. % Ingeo™ Biopolymer 3052D), all in tensile bar form; Polymer Blend A and Polymer Blend B were also incubated in film form.

FIG. 4 is a graph depicting the results of the strain to failure (elongation at break) test according to ASTM D638-14 on tensile bars for each Polymer Blend Example in Table 1A (Polymer Blends E-N), as described in the Examples.

FIG. 5 is a graph depicting the results of the modulus of elasticity test according to ASTM D638-14 on tensile bars for each Polymer Blend Example in Table 1A (Polymer Blends E-N), as described in the Examples.

FIG. 6 is a graph depicting the results of the maximum tensile stress test according to ASTM D638-14 on tensile bars for each Polymer Blend Example in Table 1A (Polymer Blends E-N), as described in the Examples.

FIG. 7 depicts an example of an extrusion blow mold device and a process for forming a bottle comprising the polymeric blends described herein.

FIG. 8 depicts an example of an extrusion blow mold device wherein the die is connected to three extruders, and each extruder conveys a supply of molten plastic. Each extruder may supply a different molten plastic, such that a three layer parison can be produced.

FIGS. 9A-E depict embodiments of different numbers of layers that may be produced through an extrusion blow mold process.

FIG. 10 is a graph showing strain to failure (elongation at break), measured by ASTM D2256-10, of yarns made from Polymer Blend Yarn 19 (100% PLA 3052D) over time.

FIG. 11 shows yarn composed of 95.3% PLA 3052D+4.7% Hytrel 3078 after 35 days at 120° F./95% RH and then 14 days at 140° F./95% RH.

FIG. 12 shows yarn composed of 95.0% PLA 3052D+5.0% PBS FZ71 after 35 days at 120° F./95% RH and then 14 days at 140° F./95% RH.

FIG. 13 shows a knitted fabric composed of Polymer Blend Yarn 6 (95.3% PLA 3052D/4.7% Hytrel 3078), which yielded no runs (broken fibers) in the fabric following a knitting process using a Lawson-Hemphill Circular Sock Knitter (Model FAK, 220 Head, 54 Gauge) to create sock-like knitted fabric.

FIG. 14 shows a knitted fabric composed of Polymer Blend Yarn 16 (85% PLA 3052D/15.0% PBS FZ71), which yielded only one run in the fabric following a knitting process using a Lawson-Hemphill Circular Sock Knitter (Model FAK, 220 Head, 54 Gauge) to create sock-like knitted fabric; the broken yarn may have resulted from an equipment malfunction.

FIG. 15 shows a knitted fabric composed of Polymer Blend Yarn 30 (86.8% PLA 3052D/8.25% PBS FD92/4.95% Hytrel 3078), which yielded multiple runs in the fabric following a knitting process using Lawson-Hemphill Circular Sock Knitter (Model FAK, 220 Head, 54 Gauge) to create sock-like knitted fabric.

FIGS. 16A-C depict embodiments of a food tray that can be manufactured using the polymeric blends described herein.

FIGS. 17A-C are graphs showing strain to failure, modulus of elasticity, and maximum tensile stress (all measured according to ASTM D638-14) of tensile bars made from a polymer blend of 90% PLA 3052D/10% Hytrel 3078. Measurements were taken at various time points after manufacture of the tensile bars.

FIGS. 18A-C are photographs of embodiments of single-use packaging made with PLA polymeric blends and exhibiting varying degrees of light transmission (or haze).

### DETAILED DESCRIPTION OF THE INVENTION

The present invention is generally directed to polymeric compositions, including binary, ternary, and quaternary polymeric compositions, that combine polylactic acid (PLA) with one or more additives (organic or inorganic), such as, e.g., elastomeric additives and/or co-polymer additives. The addition of such additives can improve the mechanical properties and/or degradation rate of the polymeric composition compared to PLA homo-polymer. The relative amounts of PLA, elastomeric additive(s), co-polymer additive(s), and/or any other organic or inorganic additive described herein, can vary and are selected to achieve specific mechanical properties and/or degradation rates, at an acceptable cost structure for the product being produced. In some embodiments, the polymeric compositions comprise a heteropolymer of lactic acid combined with additives, such as elastomeric additives and/or co-polymer additives, as described herein.

Any suitable PLA, and any suitable heteropolymer of lactic acid, can be used in the present invention. For example, a suitable PLA that may be used in the present invention is Ingeo™ Biopolymer 3052D (“PLA 3052D”), which is commercially available from NatureWorks LLC. In addition, PLA produced by Total Corbion is suitable; such PLA includes, for example: PDS Luminy L105; PDS Luminy L130; PDS Luminy L175; PDS Luminy LX530; PDS Luminy LX575; PDS Luminy LX930; PDS Luminy LX975; PDS Luminy D070; and PDS Luminy D120. Other suitable PLAs are described in U.S. Pat. No. 10,174,160, the contents of which are hereby incorporated by reference in their entirety herein. Also included is PLA in any stereoisomeric purity—from PLA having mostly D-lactic acid to PLA having mostly L-lactic acid—as determined by chiral HPLC or equivalent methodology. Accordingly, in any particular embodiment of a PLA polymeric blend described herein, the PLA in the blend may be, for example, PLA having about 90% or more D-lactic acid, or PLA having about 90% or more L-lactic acid. In certain embodiments, a polymeric blend as described herein is made with poly(L-lactic acid).

In certain embodiments, the PLA is produced from lignocellulosic or cellulosic biomass, such as an agricultural waste product, as described, for example, in U.S. Pat. Nos. 9,789,461; 9,644,244; 9,677,039; 9,816,231; and 9,708,761, the contents of each of which are hereby incorporated by reference in their entirety herein. In some embodiments, when the PLA is produced from lignocellulosic biomass, only the glucose is converted to lactic acid, which is then polymerized, leaving the xylose to be sold as a co-product. By producing xylose as a co-product, this process effectively subsidizes the PLA produced and allows it to be produced at a lower cost than PLA produced from corn grain, cassava, or sugarcane; such processing is also associated with a lower carbon footprint, and less water consumption, than producing PLA from corn grain, for example.

The molecular weight of PLA can vary and can affect certain properties of PLA. For example, generally, as the molecular weight of PLA decreases, it becomes more brittle and degrades faster; such degradation naturally occurs when PLA is exposed to heat and moisture and undergoes hydrolysis. The selection of PLA of a particular molecular weight for the polymeric compositions of the present invention may be based on the specific mechanical and degradation properties of PLA of such molecular weight, and on how such properties may be modified upon blending the PLA with one or more organic or inorganic additives, as described herein.

In certain embodiments, the PLA or heteropolymers of lactic acid used in the present invention to make intimate or physical blends may have a weight average molecular weight M_{w} (in daltons) ranging from about 10,000 to about 500,000; in other embodiments, from about 75,000 to about 150,000; and in still other embodiments, from about 80,000 to about 125,000. In certain embodiments, the PLA or heteropolymers of lactic acid used in the blends can have, for example, a number average molecular weight M_{w} (in daltons) from about 6,500 to about 300,000, from about 7,500 to about 200,000, or from about 25,000 to about 175,000. In some instances, the polydispersity M_{w}/Mₙ of the PLA or the heteropolymers of lactic acid is from about 1.1 to about 2.0, such as from about 1.2 to about 1.9 or from about 1.2 to about 1.5. The molecular weights for PLA or for heteropolymers of lactic acid may be measured by using refractive index in combination with light scattering in 2,2,2-trifluoroethanol with sodium trifluoroacetate and so can be absolute. In addition, the PLA or heteropolymer of lactic acid may be cross-linked, or highly branched, for example, by utilizing polymers derived from lactic acid and multifunctional alcohols, such as triols or alcohols including four or more hydroxy groups. Using cross-linked or highly branched PLA or heteropolymers of lactic acid may be desired to increase abrasion resistance, for example.

Copolymers or heteropolymers of lactic acid that may be used in the polymeric compositions, e.g., intimate or physical blends described herein, include, for example, heteropolymers of lactic acid with glycolic acid, heteropolymers of lactic acid with methacrylate, and heteropolymers of lactic acid with triethylsilane. Other heteropolymers of lactic acid are described in U.S. Pat. No. 10,174,160, the contents of which are hereby incorporated by reference in their entirety herein.

Suitable elastomeric additives include, but are not limited to: polyester elastomers (e.g., co-polyester elastomers, for example polyether polyester block copolymers, such as those having a random or regular arrangement of soft and hard blocks); polyamide elastomers (e.g., copolyamide elastomers, for example polyether polyamide block copolymer elastomers, such as those having a random or regular arrangement of soft and hard blocks); thermoplastic polyurethane elastomers (e.g., polyether polyurethane block copolymers, such as those having a random or regular arrangement of soft and hard blocks); polyolefin elastomers (POE) (e.g., polyethylene copolymers of ethylene and another alpha olefin (such as butene, hexene, octene, or another longer chain olefin having, for example, 9-16 carbon atoms) or a blend of olefins), including styrene-butadiene-styrene (SBS) block copolymers having a random or regular arrangement of soft and hard blocks, styrene-isoprene-styrene (SIS) copolymers having a random or regular arrangement of soft and hard blocks, styrene-ethylene-butylene-styrene (SEBS) copolymers having a random or regular arrangement of soft and hard blocks, and styrene-isoprene-butadiene-styrene (SIBS) copolymers having a random or regular arrangement of soft and hard blocks; blends of vulcanized rubber and POEs; and blends of POEs and rubber-based elastomers. Thermoplastic elastomers that may be used in the blends are described in Robert Shanks and Ing Kong, “Thermoplastic Elastomers,” Thermoplastic Elastomers, Ed. Adel Z. El-Sonbati, Croatia: InTech, which is hereby incorporated by reference herein in its entirety.

Any elastomer described in the above paragraph or elsewhere herein can be utilized to produce physical or intimate melt blends with PLA (or a lactic acid heteropolymer) to provide polymeric compositions that can be used to form degradable plastics having desired characteristics. In addition, any elastomer described in the above paragraph or elsewhere herein can be functionalized, for example, oxidized, to make blends more compatible with substances they may encounter in their applications (e.g., food in the case of food packaging). For example, any POE described herein, such as SEBS, can be maleated, for example by utilizing maleic anhydride during the polymerization of the polyolefin elastomer.

Any of the elastomers described herein may include a plasticizer (e.g., by melt blending an elastomer and a plasticizer), or may be used with a plasticizer when blended with PLA and/or with a heteropolymer of lactic acid. A plasticizer can modify the blending characteristics of an elastomer, and/or can decrease the hardness of an elastomer relative to the hardness of the PLA or lactic acid heteropolymer used in the blend. Using a plasticizer may also lower production cost, for example by lowering the melting point, acting as a filler, and/or increasing processing throughput. For example, any POE can include an oil, which in some embodiments may be a food grade oil such as a mineral oil. The POE, which could be SBS or SEBS, for example, can include a plasticizer in an amount ranging from about 1 to about 35 percent by weight, from about 2 to about 30 percent by weight, or from about 5 to about 25 percent by weight. Further, in some embodiments, soft or sticky elastomeric additives can be dusted, for example with talc or calcium carbonate, to make them easier to handle, for example when making physical blends.

In some embodiments, an elastomer as described herein can have a Shore D hardness (ISO 868, at room temperature) that is from about 10 Shore D to about 70 Shore D, for example, from about 20 Shore D to about 60 Shore D, from about 25 Shore D to about 50 Shore D, from about 28 Shore D to about 48 Shore D, or about 28 Shore D to about 40 Shore D. In certain embodiments, the elastomer used in making the physical blends or intimate melt blends described herein has a Shore D hardness of less than about 60 Shore D, such as less than about 50 Shore D, less than about 45 Shore D, less than about 43 Shore D, less than about 42 Shore D, less than about 41 Shore D, less than about 40 Shore D, or less than about 39 Shore D. In some embodiments, the elastomer has a Shore A hardness (ISO 868, at room temperature) of between about 9 Shore A and about 90 Shore A, such as between about 13 Shore A and about 85 Shore A, between about 20 Shore A and about 80 Shore A, or between about 30 Shore A and about 70 Shore A. In specific embodiments, the elastomer utilized to make any degradable polymeric blend described herein has a Shore A hardness of less than 90 Shore A, e.g., less than about 85 Shore A, less than about 80 Shore A, less than about 75 Shore A, less than about 70 Shore A, less than about 65 Shore A, or less than about 50 Shore A.

In particular embodiments, any of the elastomeric additives described herein can have any one or more of the following properties, alone or in combination with one or more other properties. An elastomeric additive can have, for example, a specific melt flow rate (MFR), which can be measured at, for example, 210° C./2.16 kg, and is expressed in units of grams/10 minutes. In instances where a generally low melt flow rate is desired, the MFR (in grams/10 minutes) can be from about 1 to about 16, such as from about 2 to about 13, from about 3 to about 12, or from about 4 to about 11. In instances where a generally high melt flow rate is desired, the MFR (in grams/10 minutes) can be from about 5 to about 100, such as from about 10 to about 75, from about 12 to about 65, or from about 15 to about 50. In certain embodiments, in order to match the viscosity of the PLA or lactic acid heteropolymer, the melt flow rate of the elastomeric additive is within about 7 melt flow points of the melt flow rate of the PLA or lactic acid heteropolymer utilized to make the polymeric blend; for example, the elastomeric additive may have a melt flow rate that is within about 6 melt flow points, within about 5 melt flow points, within about 4 melt flow points, within about 3 melt flow points, within about 2 melt flow points, or within about 1 melt flow point of the melt flow rate of the PLA or lactic acid heteropolymer. In addition, any elastomeric additive disclosed herein can have a tensile modulus (in Psi) that is from about 1,450 to about 145,000, such as from about 2,175 to about 108,780, from about 2,900 to about 72,520, from about 3,625 to about 25,380, or from about 4,350 to about 14,500. Any elastomeric additive disclosed herein can have a tensile strength (in Psi) that is from about 725 to about 10,900, from about 1,450 to about 10,150, from about 2,175 to about 9,430, or from about 2,900 to about 8,000. Further, any elastomeric additive disclosed herein can have a strain at break (% at room temperature) that is from about 25 to about 1,000, from about 32 to about 750, from about 35 to about 650, from about 50 to about 600, or from about 75 to about 550. In many embodiments, it may be desirable that the elastomeric additive has a no break Charpy impact value (e.g., notched at 23° C., in units of kJ/m²; or notched at 73° F., in units of ft·lb/in²). In addition, any elastomeric additive described herein can have a minimum continuous service temperature of less than about −10° C., such as less than about −15° C., less than about −20° C., less than about −25° C., less than about −30° C., less than about −40° C., less than about −50° C., or less than about −60° C. An elastomeric additive that has a relatively low minimum continuous service temperature generally will impart this property upon the degradable polymeric blend in which it is used. Having relatively low minimum continuous service temperatures expands the usefulness of the degradable polymeric blends, allowing them to be utilized in a broad array of single-use plastic objects; for example, this property can render the polymeric blends suitable for the low temperature uses of polyolefins, or can render the blends useful for the high temperature uses of, for example, a glass-filled nylon. In general, the elastomeric additives described herein have a high tear resistance and impart this property of high tear resistance to the degradable polymeric blends of which they form a part. In certain embodiments, the tear strength (or tear resistance) of any elastomeric additive described herein, measured using ASTM 624 at room temperature (Die C) in units of kN/m, is from about 20 to about 165, such as from about 25 to about 115, from about 28 to about 100, or from about 30 to about 88. In certain embodiments, the tear resistance (measured using ASTM 624 at room temperature (Die C) in units of kN/m) is greater than about 40, e.g., greater than about 45, greater than about 46, greater than about 47, greater than about 48, greater than about 50, greater than about 55, greater than about 60, or greater than about 75.

With respect to embodiments where one or more elastomeric additive is a co-polyester elastomer, in certain such embodiments the additive may be a polyether polyester block copolymer having a plurality of soft and hard blocks. In some preferred such embodiments, these polyether polyester block copolymers are produced by reacting a 1,4-butanediol, polytetramethylene glycol (polyTHF) (e.g., a polyTHF having a Mₙ of from about 600 to about 2,000 daltons) and dimethylterephthalate, together with a catalyst, as described in U.S. Pat. Nos. RE28,982; 3,651,014; 3,763,109; 3,766,146; 3,801,547; and 3,963,800, the contents of each of which are hereby incorporated by reference herein in their entirety. Without wishing to be bound by any theory, the polyTHF in such polyether polyester block copolymers appears to act as a compatibilizer in blends made with PLA or lactic acid heteropolymer, and thereby maximizes the property enhancements imparted to the resulting degradable polymeric blends by the polyether polyester block copolymer additive. Many other polymeric glycols, monomeric glycols, and esters may be used to produce polyether polyester block copolymers, as described in the patents referenced in this paragraph. For specific preferred embodiments, the polyether polyester block copolymer includes polyTHF as the polyether of the polyether polyester block copolymer. In such embodiments, the weight percentage of the polyTHF in the polyether polyester block copolymer can be from about 10 percent by weight to about 60 percent by weight, e.g., from about 15 percent by weight to about 55 percent by weight, or from about 18 percent by weight to about 44 percent by weight. Other embodiments of polyether polyester block copolymer additives are those embodiments in which the polyester portion of the polyether polyester block copolymer includes butylene terephthalate units. Such butylene terephthalate units may be formed during the reaction of 1,4-butanediol with any isomer of terephthalic acid (o-, m- or p-) or any ester equivalent thereof (for example, methyl or ethyl terephthalate); in certain embodiments, the butylene terephthalate units are formed by the reaction of 1,4-butanediol with p-terephthalic acid or with methyl terephthalate. Without wishing to be bound by any theory, it is believed that the resulting butylene terephthalate units provide complementary ester linkages to the PLA ester groups and thereby aid in compatibilizing PLA with the elastomer. In some embodiments, the weight percentage of such butylene terephthalate units in the polyether polyester block copolymer can be, for example, from about 10 to about 75 percent by weight, such as from about 10 to about 65 percent by weight, from about 15 to about 60 percent by weight, or from about 20 to about 55 percent by weight.

With respect to embodiments where one or more elastomeric additive is a thermoplastic polyurethane elastomer (also called elastomeric thermoplastic urethane, E-TPU), in certain such embodiments the additive may be a polyether polyurethane block copolymer, such as a polyether polyurethane block copolymer having a random or regular arrangement of soft and hard blocks. Thermoplastic polyurethane elastomers are described, for example, in U.S. Pat. Nos. 4,980,445 and 5,122,548, the contents of each of which are hereby incorporated by reference herein in their entirety. Pellethane® 2363-90AE, which is manufactured by Lubrizol Life Sciences, can also be used as a thermoplastic polyurethane elastomer for the blends described herein. Additional thermoplastic polyurethane elastomers that may be used in the polymeric blends are described in W. F. Diller, Industrial Hygiene of PU Raw Materials, Polyurethane Handbook, Ed. Gunter Oertel, 120-127 (1993), which is hereby incorporated by reference herein in its entirety.

A preferred embodiment of a ternary blend that exhibits desirable degradation properties as well as good elongation properties (e.g., an elongation at break that is in the range of about 14% to about 65%, about 15% to about 50%, or about 18% to about 45%) and good impact strength (also called impact resistance) (e.g., a Charpy Notched Impact Strength (73° F.; in units of ft·lb/in²) that is in the range of about 0.3 to about 2.3, about 0.5 to about 2.0, or about 0.55 to about 1.7), is a blend of PLA, a polyether polyester block copolymer, and a POE (e.g., SEBS, SIS, or SBS polyolefin elastomer).

Other elastomeric additives that can be used in the polymeric compositions of the present invention include, for example, thermoplastic polyester elastomers such as Hytrel® 3078 from DuPont™, thermoplastic polyether/polyamides such as PEBAX® 2533 SA 01 from Arkema Specialty Polyamides, aliphatic-aromatic copolyesters such as ecoflex® F Blend C1200 from BASF and including thermoplastic aliphatic-aromatic copolyesters, and other thermoplastic copolyesters such as Arnitel® TPE and Arnitel® Eco by DSM Engineering Plastics. DuPont™ Hytrel® polymers that may be used in the polymeric blends of the present invention include, for example: Hytrel® 3078, Hytrel® 4053, Hytrel® 4056, Hytrel® 4068, Hytrel® 4069, Hytrel® 4556, Hytrel® 5526, Hytrel® 5556, Hytrel® 5555HS, Hytrel® 6356, Hytrel® 7246, Hytrel® 8238, Hytrel® G3548, Hytrel® G4074, Hytrel® G4078, Hytrel® G4078LS, Hytrel® G4774, Hytrel® 3078FG, Hytrel® 4068FG, and Hytrel® G5544. Arnitel® polymers that could be used in the polymeric blends of the present invention include, for example: Arnitel® HM7118, Arnitel® L-X08695, Arnitel® L-X08723(3107), Arnitel® ID 2060-HT, Arnitel® EB463, Arnitel® PL420-H, Arnitel® UM551, Arnitel® VT3104, Arnitel® EB464, Arnitel® XG5857, Arnitel® PB420-B, Arnitel® VT3108, Arnitel® EM400, Arnitel® PM581, Arnitel® XG5855, Arnitel® EM631-HB, Arnitel® PL381-H, Arnitel® EM630, Arnitel® PB582-H, Arnitel® EM630-H, Arnitel® PB500-H, Arnitel® EE7676, Arnitel® PM381, Arnitel® CM550-S, Arnitel® CM551, Arnitel® CM600-V, Arnitel® CM600-V XL, Arnitel® CM620-S, Arnitel® CM622, Arnitel® DRL 4122-02, Arnitel® EB464-01, Arnitel® EB501, Arnitel® EE7805 (L-X07805), Arnitel® EL150, Arnitel® EL250, Arnitel® EL250-08, Arnitel® EL250/U, Arnitel EL430, Arnitel® EL550, Arnitel® EL550-08, Arnitel® EL630, Arnitel® EL630-08, Arnitel® EL740, Arnitel® EL740-08, Arnitel® EM400-08, Arnitel® EM400-B, Arnitel® EM400/U, Arnitel® EM460, Arnitel® EM460-08, Arnitel® EM460/U, Arnitel® EM550\99.99.99, Arnitel® EM631, Arnitel® EM740, Arnitel® EM740-H, Arnitel® FM8226(L-X08226), Arnitel® HT7719, Arnitel® HT8027, Arnitel® ID 2045, Arnitel® JD7515, Arnitel® L-X07344, Arnitel® L-X08566, Arnitel® L-X08588, Arnitel® L-X08719 (PM650), Arnitel® PL380, Arnitel® PL381, Arnitel® PL460-S, Arnitel® PL461, Arnitel® PL581, Arnitel® PL650, Arnitel® PM460, Arnitel® PM460-H, Arnitel® PM471, Arnitel® UM551-V, Arnitel® UM552, Arnitel® VT3118, Arnitel® VT7812, Arnitel® XG01IM, Arnitel® XG01IS, Arnitel® XG01JK, Arnitel® XG6029, Arnitel® XG8625 (L-X08625), Arnitel® Eco L400, Arnitel® Eco L460, Arnitel® Eco L550, Arnitel® Eco L700, and Arnitel® Eco M700. Elastomeric additives that can be used in the polymeric compositions of the present invention are also described in the following references, each of which is hereby incorporated by reference herein in its entirety: Richard J. Cella, Morphology of Segmented Polyester Thermoplastic Elastomers, J. Polymer. Sci., No. 42, 727-740 (1973); G. K. Hoeschele, Segmented Polyether Ester Copolymers-A New Generation of High Performance Thermoplastic Elastomers, Polymer Eng'g. and Sci., 12(14) (December 1974); Morton Brown, Thermoplastic Copolyester Elastomers: New Polymers for Specific End-Use Applications, Rubber Indus., 102-106 (June 1975); and J. R. Wolfe, Jr., Elastomeric Polyether-Ester Block Copolymers I. Structure-Property Relationships of Tetramethylene Terephthalate/Polyether Terephthalate Copolymers, Rub. Chem. & Tech., 4(50) 689 (1977).

The molecular weight of an elastomeric additive can vary and is selectively chosen to achieve specific mechanical properties and/or degradation rates for the polymeric compositions to which it is added. In certain embodiments, an elastomeric additive used in the polymeric compositions described herein may have a weight average molecular weight ranging (in daltons) from about 1,200 to about 300,000; in other embodiments from about 2,500 to about 200,000; and in still other embodiments from about 5,000 to about 150,000.

In a preferred embodiment, the elastomeric additive includes a plurality of ester or amide linkages. Such linkages may assist the extent to which the additive disperses within the PLA or lactic acid heteropolymer.

Suitable co-polymer additives that may be used in the polymeric compositions described herein include, but are not limited to, polyols (e.g., polyethylene glycol (PEG), polyvinyl alcohol (PVA), polypropylene glycol (PPG)), polybutylene succinate (PBS) additives (e.g., BioPBS™, such as PBS FZ71, PBS FZ91, and PBS FD92), polyethers, polyethylene oxide (PEO), PEO/PPO block co-polymers (e.g., Pluronic family), adipate-based polymers or oligomers, diacids (e.g., lactic acid, adipic acid, sebacic acid, succinic acid, fatty acids, terephthalic acid (e.g., o-, m-, and p-terephthalic acid)), Kraton™ D polymers, Kraton™ G polymers, Kraton™ FG polymers, chemical foaming agents (e.g. TRACEL®, such as Tracel IM 3170 MS and Tracel IMC 4200; Hydrocerol CT 3168; and Luvobatch PE BA 9537), and nylon polymers (e.g., Zytel® nylon resins, such as Zytel® PA6, Zytel® PA66, Zytel® PA610, Zytel® PA612, and Zytel® HTN polymers (e.g., Zytel® HTN510EFT NC010, Zytel® HTN51G15HSL BK083, Zytel® HTN51G15HSL NC010, Zytel® HTN51G35EF BK083, Zytel® HTN51G35HSL BK083, Zytel® HTN51G35HSL NC010, Zytel® HTN51G35HSLR BK420, Zytel® HTN51G35HSLR BK420J, Zytel® HTN51G45HSL BK083, Zytel® HTN51G45HSL NC010, Zytel® HTN52G35HSL BK083, Zytel® HTN52G45HSL BK083, Zytel® HTN53G50HSLR BK083, Zytel® HTN53G50HSLR NC010, Zytel® HTN53G60LRHF BK083, Zytel® HTN54G15HSLR BK031, Zytel® HTN54G15HSLR NC010, Zytel® HTN54G35EF BK420, Zytel® HTN54G35HSLR BK031, Zytel® HTN54G35HSLR NC010, Zytel® HTN55G55TLW BK117, Zytel® HTN55G55TLW BK773, Zytel® HTN92G35DH2 BK083, Zytel® HTNFE350064 BK544, Zytel® HTNFE8200 BK431, Zytel® HTNFE8200 NC010, Zytel® HTNFE8200 NC010, Zytel® HTNFR42G30NH BK337, Zytel® HTNFR42G30NH NC010, Zytel® HTNFR52G30BL BK337, Zytel® HTNFR52G30BL NC010, Zytel® HTNFR52G30NH BK337, Zytel® HTNFR52G30NH NC010, Zytel® HTNFR52G45BL BK337, Zytel® HTNFR52G45NHF BK337, Zytel® HTNFR52G45NHF NC010, Zytel® HTNFR55G50NHLW BK046, Zytel® HTNFR55G50NHLW NC010, and Zytel® HTNLTFR52G30NH BL662)). Adipate-based polymers include, for example: poly(1,4-butylene adipate); poly(ethylene adipate); poly(diethylene glycol adipate); poly(propylene glycol adipate); poly(diethylene glycol ethylene glycol adipate isophthalate); poly(2-methyl-1,3-propanediol adipate); poly(1,4-butylene ethylene adipate); poly(ethylene glycol diethylene glycol adipate); poly(neopentylene adipate); poly(diethylene glycol adipate isophthalate); poly(1,6-hexanediol adipate); and poly(3-methyl-1,5-pantanediol adipate). Adipate-based polymers are available from SONGWON under the tradename SONGSTAR™. Kraton™ D polymers include, for example: Kraton™ D0243, Kraton™ D0246, Kraton™ D1101, Kraton™ D1102, Kraton™ D1116, Kraton™ D1118, Kraton™ D1152, Kraton™ D1155, Kraton™ D1157, Kraton™ D1184, Kraton™ D1189, Kraton™ D1191, Kraton™ D1192, Kraton™ D4150, Kraton™ D4153, Kraton™ D4270, Kraton™ D4271, Kraton™ DX1000. Kraton™ G polymers include, for example: Kraton™ G1750 and Kraton™ G1765. Kraton™ FG polymers include, for example: Kraton™ 1901FG and Kraton™ 1924FG.

Additional co-polymer additives include, e.g., poly(acrylic acid) (P(AA)); P(AA) sodium salt; silica PEG; poly(2-hydroxyethyl methacrylate) (P(HEMA)); poly(vinyl imidazole) (P(VIM)); poly(methyl methacrylate) (PMMA); poly(2-methyl-2-oxazoline) (P(MeOx)); poly(2-ethyl-2-oxazoline) (P(EtOx)); poly(N-isopropylacrylamide) (P(NIPAM)); and poly(dimethylaminoethyl methacrylate) (P(DMAEMA)). Co-polymer additives that can be used in the polymer compositions of the present invention also include the following polymers produced by Sigma-Aldrich: PEG 1,500; PEG 12,000; PEG 35,000; Poly(methyl vinyl ether-alt-maleic acid) 1,980,000; Poly(methyl vinyl ether-alt-maleic acid) 216,000; Poly(methyl vinyl ether-alt-maleic anhydride) 1,080,000; Poly(methyl vinyl ether-alt-maleic anhydride) 216,000; Mowiol® 40-88; Poly(ethylene-alt-maleic anhydride) 100,000-500,000; Poly(acrylic acid) 1,250,000; Polyox™ WSR N12K; Polyox™ WSR N750; and PVA 146,000-186,000, 99+% hydrolyzed.

Rigid thermoplastic polyurethanes may also be utilized as co-polymer additives in the polymeric blends of the present invention. Rigid thermoplastic polyurethanes (R-TPUs) can add impact resistance and optical clarity to the polymeric compositions described herein. Rigid thermoplastic polyurethanes include, for example, the thermoplastic polyurethanes available under the tradename Isoplast® (sold by Lubrizol); currently available grades include Isoplast® 300E ETP, Isoplast® 101 ETP, Isoplast® 101 LGF40 ETP, Isoplast® 101 LGF60 ETP, Isoplast® 202 LG40 ETP, Isoplast® 202EZ ETP, Isoplast® 301 ETP, and Isoplast® 302EZ ETP. Rigid thermoplastic polyurethanes are also described in U.S. Pat. No. 4,822,827, the contents of which are hereby incorporated by reference herein in their entirety. Additional rigid thermoplastic polyurethanes are described in W. F. Diller, Industrial Hygiene of PU Raw Materials, Polyurethane Handbook, Ed. Gunter Oertel, 120-127 (1993), referenced above.

Suitable co-polymer additives that may be used in the polymeric compositions described herein also include cellulosic plastics, such as cellulose acetate and cellulose acetate propionate. Cellulosic plastics that can be used in the degradable blends include those that are available from Eastman Chemical Company under the tradename Tenite™ (e.g., Tenite™ acetate, Tenite™ propionate, and Tenite™ butyrate). Because cellulosic polymers are made from trees, using them in the compositions of the present invention can increase the percentage of modern carbon in the compositions.

The molecular weight of a co-polymer additive can vary and is selectively chosen to achieve specific mechanical properties and degradation rates for the polymeric compositions to which it is added. In certain embodiments, the co-polymer additive used in the present invention may have a weight average molecular weight (in daltons) ranging from about 1,000 to about 500,000; in other embodiments from about 2,000 to about 250,000; and in still other embodiments from about 8,000 to about 80,000.

If materials being blended have different viscosities, the different viscosities, under some circumstances, can provide inadequately mixed blends. In some embodiments, the melt viscosities of the PLA homo-polymer and the co-polymer additive(s), or of the lactic acid heteropolymer and the co-polymer additive(s), do not differ by more than about 350 percent, e.g., do not differ by more than about 200 percent, by more than about 100 percent, or by more than about 50 percent. In some embodiments, the melt viscosity of the PLA homo-polymer or lactic acid heteropolymer does not differ from the melt viscosity of the co-polymer additive(s) by more than about 10 percent or about 25 percent.

In certain embodiments of polymeric blends comprising one or more additives as described herein, the polymeric composition comprises at least about 80 wt. % PLA, at least about 85 wt. % PLA, or at least about 90 wt. % PLA. In other embodiments, the polymeric composition comprises at least about 80 wt. % lactic acid heteropolymer, at least about 85 wt. % lactic acid heteropolymer, or at least about 90 wt. % lactic acid heteropolymer.

In further embodiments, the polymeric composition may comprise one or more elastomeric additives, wherein each elastomeric additive is present in an amount up to 1 wt. %, up to 3 wt. %, up to 5 wt. %, up to 10 wt. %, or up to 15 wt. %. In certain embodiments, the elastomeric additive is Hytrel® 3078, PEBAX® 2533 SA 01, or ecoflex® F Blend C1200. Embodiments where two or more elastomeric additives are blended with PLA include, for example, polymeric compositions comprising Hytrel® 3078 and either PEBAX® 2533 SA 01 or ecoflex® F Blend C1200—any combination of these elastomeric additives or others may be used. In addition, when using two or more elastomeric additives, the relative amounts of each additive may differ; e.g., in the example mentioned above, Hytrel® 3078 may be present in an amount of 4 wt. % and the other additive (e.g., PEBAX® 2533 SA 01 or ecoflex® F Blend C1200) may be present in a lesser amount (e.g., 2 wt. %) or in a greater amount (e.g., 7 wt. %).

Accordingly, in some embodiments, the polymeric composition is a binary blend comprising PLA and one elastomeric additive. In other embodiments the polymeric composition is a ternary blend comprising PLA and two elastomeric additives. In still other embodiments, the polymeric composition is a quaternary blend comprising PLA and three elastomeric additives.

In certain embodiments, the polymeric composition may comprise one or more co-polymer additives, wherein each co-polymer additive is present in an amount up to 1 wt. %, up to 3 wt. %, up to 5 wt. %, up to 10 wt. %, or up to 15 wt. %. In certain embodiments, the co-polymer additive is polyethylene glycol (PEG). The molecular weight of PEG can vary, and both the amount of PEG added, and the molecular weight of the PEG that is added, can influence the properties of the polymeric composition. For example, a polymeric blend of PLA and PEG 12,000 (added at 5 wt. %) was shown to have a faster degradation rate compared to a polymeric blend of PLA and PEG 35,000 (added at 5 wt. %) (see, e.g., the Examples, Polymer Blends J and K). Additionally, when using two or more co-polymer additives, the relative amount of each additive may differ from the relative amount(s) of the other(s). In certain embodiments, for example, PEG of two or more different molecular weights (e.g., PEG 12,000 and PEG 35,000) are added to PLA; the PEG of two or more different molecular weights may be added in the same relative amount (e.g., PEG 12,000 and PEG 35,000, both added at 2 wt. %), or may be added in different relative amounts (e.g., PEG 12,000 added at 4 wt. %, and PEG 35,000 added at 2 wt. %).

Accordingly, in some embodiments the polymeric composition is a binary blend comprising PLA and a co-polymer additive. In other embodiments the polymeric composition is a ternary blend comprising PLA and two co-polymer additives. In still other embodiments, the polymeric composition is a quaternary blend comprising PLA and three co-polymer additives.

In some embodiments of the present invention, the polymeric composition is a ternary blend comprising PLA, one elastomeric additive, and one co-polymer additive. In other embodiments, the polymeric composition is a quaternary blend comprising PLA, two elastomeric additives, and one co-polymer additive. In further embodiments, the polymeric composition is a quaternary blend comprising PLA, one elastomeric additive, and two co-polymer additives.

In addition to the additives already discussed herein, other additives that can be used in a PLA polymeric composition include, but are not limited to, soybean oil, epoxidized soybean oil, steric acid and esters, phthalates, azelates, sabacates, trimellitates, octyl alcohol ester (e.g., dioctyl phthalate (DOP)), oxidized polyethylene, phosphonates, vinyl acetate homo and copolymers such as ethylene vinyl acetate, polyvinylacetate, partially hydrolyzed polyvinylacetate, and fully hydrolyzed polyvinyl acetate (PVA). In certain embodiments, the vinyl acetate copolymers may have from 1% to 50% ethylene by weight.

In any of the aforementioned embodiments, and in any of the embodiments described further below, the polymeric composition may comprise a heteropolymer of lactic acid in place of or in addition to PLA.

The polymeric blends described herein may be extruded, for example, in the form of an extruded rod or sheet, with orientation (e.g., uni-axial or biaxial orientation) or without orientation; molded, for example, injection molded, injection blow molded, or extrusion blow molded; or blown or cast into a film, for example, in the form of thin sheets, which can then be used to make degradable plastic bags. Any of these forms—extruded, molded, blown or cast—can have multiple layers, for example, 2, 3, 4, 5, 6, 7, or more layers. In further embodiments, one or more tie-layers can be included between any of the layers, to improve adhesion between layers. In certain embodiments, the polymeric blends of PLA may be extruded into a sheet or film having a thickness of from about 0.001 to about 1.0 inches, from about 0.005 to about 0.75 inches, from about 0.01 to about 0.50 inches, from about 0.015 to about 0.25 inches, or from about 0.025 to about 0.100 inches.

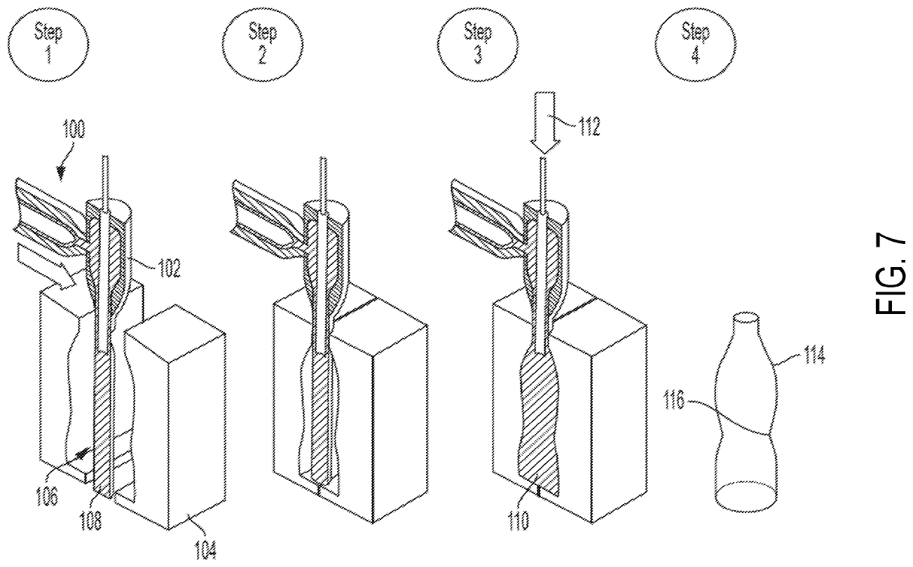

The products produced by the extrusion blow mold process are not limited and may include any hollow plastic parts, such as a bottle, receptacle, container, etc. For example, as depicted in FIG. 7, the extrusion blow mold process may be used to produce a bottle comprising the polymeric blends described herein. As shown in step 1, an extrusion blow molded bottle is produced by conveying molten plastic through an extruder (100) and die (102) into an open cavity (106) defined in a mold (104) to form a hollow cylinder extrusion of molten plastic (a parison (108)). As the mold (104) closes, the parison (108) is pinched shut to close off the distal end of the parison, as shown in step 2. Once closed, air (112) is blown into the parison from the proximal end and its pressure expands the parison (110) until the cavity is filled, as shown in step 3. As the molten plastic cools, a bottle is formed and then de-molded, as shown in step 4. Using the extrusion process, bottles can be formed rapidly and in high numbers. As shown in step 4 of FIG. 7, the bottle has an outer portion (114) that generally contacts a user or the environment, and an inner portion (116) that generally contacts the contents inside the bottle, which may be liquid or solid. The inner portion (116) comprises a “skin,” which is the surface of the inner portion that comes into physical contact with the contents inside the bottle. In other embodiments, the bottle, or any other hollow plastic part, may comprise additional middle layers or portions. The molten plastic used to create the bottle or other hollow plastic part may comprise a PLA (or lactic acid heteropolymer) polymeric blend as described herein.

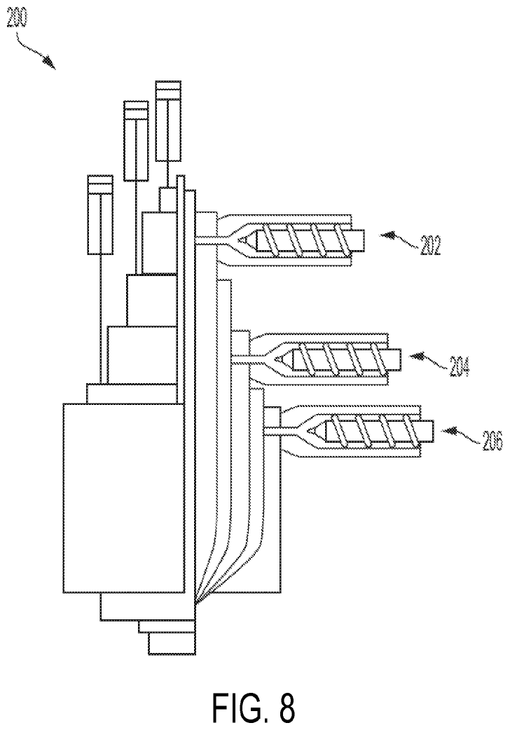

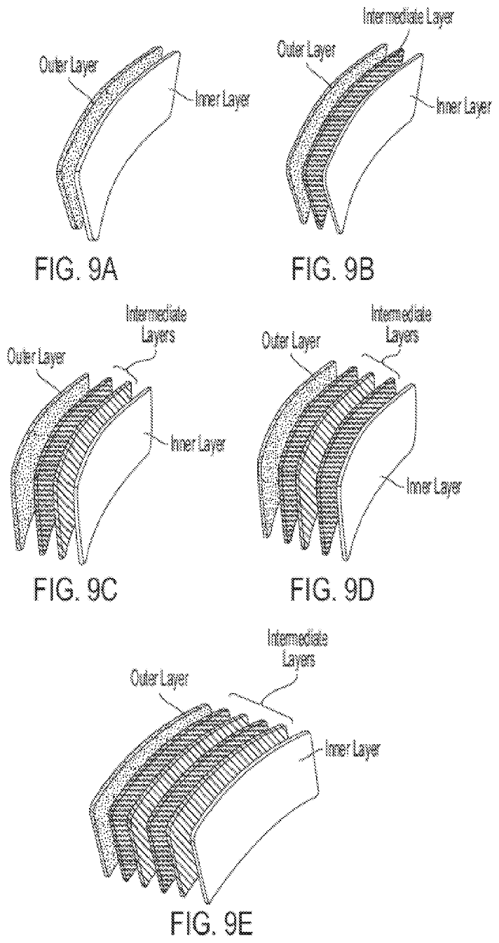

The die in an extrusion blow mold process may be connected, for example, to one, two, three, four, five, or more (e.g., six) supplies of molten plastic to circumferentially define the parison in various longitudinal layers. For example, the die may be connected to three extruders (as shown in FIG. 8), where each extruder conveys a supply of molten plastic to produce a three-layer parison. A first extruder (202) and a first supply of molten plastic form a first parison layer, or inner portion of the bottle; a second extruder (204) and second supply of molten plastic form a second parison layer, for example a tie-layer; and a third extruder (206) and third supply of molten plastic form a third parison layer, or outer portion of the bottle. FIGS. 9A-9E depict examples of the different numbers of layers that may be produced through an extrusion blow mold process. FIG. 9A depicts double layers with an inner portion, comprising a “skin” that contacts the contents of the container (which could be a liquid), and an outer portion that contacts a user or the environment; FIG. 9B depicts triple layers with an inner portion, one intermediate portion, and an outer portion; FIG. 9C depicts quadruple layers with an inner portion, two intermediate portions, and an outer portion; FIG. 9D depicts quintuple layers with an inner portion, three intermediate portions, and an outer portion; and FIG. 9E depicts sextuple layers with an inner portion, four intermediate portions, and an outer portion. One or more of the layers or portions may comprise PLA (or lactic acid heteropolymer) polymeric blends as described herein. Many different parison layers can be produced, for example, to improve the oxygen barrier properties of the materials, as generally shown in FIGS. 9A-9E.

In some embodiments, one or more tie-layers may be included between any of the parison layers. For example, in situations where one portion is not compatible with and will not bond to an adjacent portion, it may be desirable to include a tie layer that is compatible with both portions—e.g., if the outer portion comprises PLA and the inner portion comprises a polyolefin (e.g., polyethylene), a three-layer structure may be produced, wherein a tie layer bonds the inner and outer portions together.

When it is desirable to have a bottle formed mostly of degradable material, it is advantageous to have the inner portion of the bottle, which may be formed of a non-degradable material that is inert to the substance inside the bottle, make up a smaller percentage by weight of the bottle relative to the outer portion and any intermediate portion(s), any or all of which can be made from materials that are at least partially degradable (such as the PLA polymeric blends described herein). For example, if the substance in the bottle is water, and a degradable PLA polymeric blend (as described herein) is used as the outer portion, polyethylene terephthalate (PET) or a nylon may be utilized as the material for the inner portion, and the inner portion may be a comparatively small fraction of the bottle's weight. In some embodiments, the bottle includes more than 50 percent by weight degradable material. For example, in some embodiments, the bottle's composition is at least about 55 percent by weight degradable material, at least about 60 percent by weight degradable material, at least about 65 percent by weight degradable material, at least about 70 percent by weight degradable material, at least about 80 percent by weight degradable material, or at least about 90 percent by weight degradable material. In specific embodiments, the percent weight of degradable material in a bottle is at least 91 percent, at least 92 percent, at least 93 percent, at least 94 percent, at least 95 percent, or at least 96 percent, such as greater than 98 percent by weight degradable material. For example, a shelf-stable bottle that is biodegradable may be produced wherein the outer portion comprises PLA (biodegradable) and Hytrel® 3078 (non-biodegradable), and the inner portion comprises only Hytrel® 3078 (non-biodegradable).

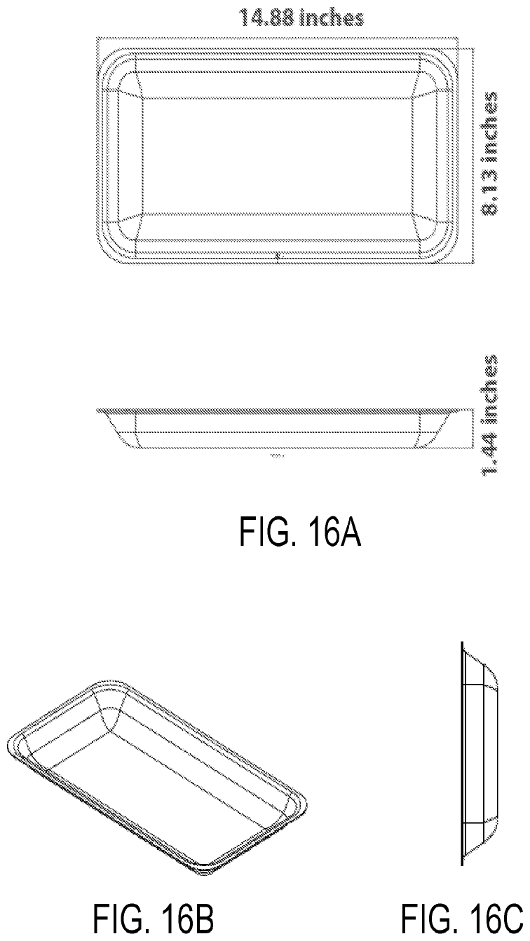

The PLA (or lactic acid heteropolymer) polymeric blends described herein may be used to create foamed polymers, including open cell or closed cell foams. Foamed polymers can be created by adding chemical foaming agents (e.g., Clariant Hydrocerol 3205A chemical foaming agent), or by injecting CO₂ into the polymeric blend using specialized equipment, for example a PLA Foam Sheet Extrusion Line by Macro Advanced Extrusion Systems. Foamed polymeric blends as described herein may be used, for example, to produce food trays (for example, meat trays), insulating material and insulation (for example, paper- or foil-backed insulation), packing material such as packing peanuts, and other foam material. FIGS. 16A-C depict embodiments of a food tray, for example for meat, that may be manufactured using the polymeric blends described herein.

The foamed polymers made from the PLA (or lactic acid heteropolymer) polymeric compositions described herein can have a bulk density of about 0.5 to about 12 lb/ft³, such as about 0.7 to about 10 lb/ft³, about 0.8 to about 9 lb/ft³, or about 0.9 to about 5 lb/ft³. For example, the bulk density of packing peanuts can be from about 0.10 to about 0.7 lb/ft³, such as from about 0.15 to about 0.5 lb/ft³, or from about 0.18 to about 0.7 lb/ft³.

The identity (including molecular weight), particular combination, and relative amounts of additives, such as elastomeric additives and/or co-polymer additives, are selectively chosen to achieve specific mechanical properties and/or degradation rates for the polymeric compositions. The mechanical properties and degradation rate of each polymeric composition reflect the cumulative and counter-balancing effects of the PLA (or of the lactic acid heteropolymer) and of each additive on those properties, and these effects can be fine-tuned by altering the relative amount of PLA (or of lactic acid heteropolymer) and the identity and relative amount of each additive. Thus, a particular balance of PLA (or of lactic acid heteropolymer), elastomeric additive(s), and co-polymeric additive(s), can provide polymeric compositions having mechanical properties and degradation rates that render the polymeric compositions suitable for a variety of applications, including, for example, waste disposal bags and food packaging containers, to name a few.

For example, one characteristic of the polymeric compositions described herein is moisture uptake. In some embodiments, water uptake is determined by a thermal gravimetric analyzer with a controlled humidity chamber, as described by Thijs et. al, Journal of Materials Chemistry 17: 4864-4871 (2007), which is hereby incorporated by reference herein in its entirety. In some embodiments, water uptake, as determined by percent weight gain of the polymeric composition under conditions such as 90% RH and 30° C., is greater than 10 percent, e.g., greater than 15%, greater than 20%, greater than 30%, greater than 35%, greater than 45%, greater than 50%, or greater than 65%. In other embodiments, water uptake is less than 100 percent, e.g., less than 90 percent or less than 85 percent. or less than 85 percent. In certain embodiments, water uptake of a PLA or lactic acid heteropolymer polymeric blend as described herein (as determined by, e.g., percent weight gain over a specified time, under specific temperature and relative humidity condition(s)) is greater than about 5%, greater than about 10%, greater than about 15%, greater than about 20%, or greater than about 25% of the water uptake of the PLA homo-polymer or lactic acid heteropolymer, when measured under the same conditions.

With respect to degradation rate, embodiments of the present invention provide polymeric compositions that provide faster degradation rates compared to the degradation rate of a PLA homo-polymer or a lactic acid heteropolymer, when degradation is tested under the same conditions. For example, in certain embodiments, a polymeric composition comprising a PLA homo-polymer and one or more additives as described herein has a degradation rate that is at least about 2% faster than, at least about 5% faster than, at least about 10% faster than, at least about 15% faster than, or at least about 20% faster than, the degradation rate of the PLA homo-polymer when degradation of the polymeric composition and the PLA homo-polymer are tested under the same conditions.

As used herein, degradation generally refers to the process by which a polymeric composition, subjected to the physiological environment, is broken down into smaller fragments. For example, the hydrolysis that occurs when some polymers are exposed to water is a type of degradation. The breaking of bonds by enzyme-catalyzed reactions is another form of degradation. As used herein, the terms degradable and non-degradable are used to distinguish different time-scales of degradation; for example, a degradable composition is a composition that partially, substantially, or completely degrades on a time-scale having the same order of magnitude as its application (typically, months up to 5-10 or so years), whereas a non-degradable composition may persist in the environment with little or no degradation for hundreds of years or longer.

As described herein, the present invention also provides polymeric compositions with improved mechanical properties (such as modulus of elasticity, maximum tensile strength, impact resistance, cold temperature performance, and/or strain to failure) compared to PLA homo-polymer or a lactic acid heteropolymer. For example, products (e.g., tensile bars, yarns, etc.) made with the different polymeric blends described herein may have different strain to failure properties. Strain to failure (also called tensile strain at break, ductility, or elongation at break) is the percent increase in length of the product (e.g., tensile bar, yarn) before it breaks under tension. In certain embodiments, products made with the polymeric blends of the present invention may have an elongation at break of greater than 10%, e.g., greater than 15%, greater than 20%, greater than 25%, greater than 30%, greater than 50%, or greater than 100%; e.g., greater than 150%, or greater than 250%. In certain embodiments, such polymeric blends comprise PLA or a lactic acid heteropolymer. In addition, in certain embodiments, the maximum strain to failure (maximum percent elongation before breakage) measured in a strain to failure test of a product made from a PLA homo-polymer is about 50% or less, about 40% or less, about 35% or less, about 30% or less, about 25% or less, about 20% or less, about 15% or less, about 10% or less, about 5% or less, or about 1% or less, of the maximum strain to failure measured for the same product made with a PLA polymeric blend as described herein comprising that PLA homo-polymer, when strain to failure is tested under the same conditions.

In particular embodiments, any intimate melt blend of any PLA homo-polymer and/or heteropolymer of lactic acid with one or more additives described herein can have, for example, any one or more of the following properties alone or in combination with one or more other properties. An intimate melt blend can have, for example, a particular melt flow rate (MFR), which can be measured at 210° C./2.16 kg, for example, and is expressed in units of grams/10 minutes. In embodiments where a generally low melt flow rate is desired, such as for injection molding, the MIR of the blend can be from about 1 to about 16, such as from about 2 to about 13, from about 3 to about 12, or from about 4 to about 11 (all values in units of grams/10 minutes). In embodiments where a generally high melt flow rate is desired, such as for fiber spinning or when using a blend in a valve-gated injection mold hot runner system, the MFR of the blend can be from about 5 to about 100, such as from about 10 to about 75, from about 12 to about 65, or from about 15 to about 50 (all values in units of grams/10 minutes). In addition, any intimate melt blend can have a tensile modulus (in Psi) of about 188,550 to about 1,450,400, such as from about 261,100 to about 1,087,800, from about 290,000 to about 942,750, or from about 319,000 to about 841,200. Any intimate melt blend can have a tensile strength (in Psi) that is from about 2,175 to about 18,100, such as from about 2,900 to about 14,500, from about 3,600 to about 10,900, or from about 4,350 to about 10,150. Further, any intimate melt blend disclosed herein comprising any additive described herein can have, for example, a strain at break (% at room temperature) that is from about 4 to about 350, such as from about 5 to about 200, from about 8 to about 100, from about 10 to about 75, or from about 15 to about 60. In addition, any intimate melt blend can have, for example, a heat deflection temperature (HDT; condition B, 65 Psi, flatwise) of about 40° C. to about 140° C., such as from about 45° C. to about 130° C., from about 50° C. to about 120° C., from about 55° C. to about 120° C., or from about 60° C. to about 100° C. When a particular HDT is desired, it typically can be obtained by utilizing an inorganic additive (e.g., calcium carbonate or talc, for example, a talc with a L/D greater than 1) in combination with, for example, a higher heat deflection temperature additive such as a rigid nylon or a rigid polyester. A high heat deflection temperature (e.g. above 150° F. or above about 65° C.) may be desired, for example, for any single-use product that is likely to be exposed to higher temperatures, such as a single-serve coffee insert (a ‘k’ cup). Any intimate degradable blend can have a Charpy impact value (notched at 23° C., in units of kJ/m²), that is from about 2 to about 35, such as from about 3 to about 30, from about 4 to about 28, or from about 5 to about 25. In addition, any intimate melt blend described herein can have a minimum continuous service temperature of less than about 0° C., such as less than about −5° C., less than about −10° C., less than about −15° C., less than about −20° C., less than about −25° C., less than about −30° C., or less than about −40° C. A relatively high HDT (e.g. a heat deflection temperature that is greater than about 65° C. (or greater than about 150° F.), greater than about 70° C. (or greater than about 160° F.), greater than about 75° C. (or greater than about 170° F.), greater than about 80° C. (or greater than about 180° F.), greater than about 85° C. (or greater than about 185° F.), or greater than about 90° C. (or greater than about 200° F.)), combined with a relatively low minimum continuous service temperature (e.g. a minimum continuous service temperature that is less than about 32° F. (or less than about 0° C.), such as less than about 25° F. (or less than about −3° C.), less than about 15° F. (or less than about −9° C.), less than about 5° F. (or less than about −15° C.), less than about 0° F. (or less than about −17° C.), less than about −10° F. (or less than about −23° C.), less than about −15° F. (or less than about −26° C.), less than about −20° F. (or less than about −28° C.), less than about −30° F. (or less than about −34° C.), or less than about −40° F. (−40° C.)), can expand the usefulness of the degradable blends described herein, allowing them to be utilized in a broad array of single-use plastic objects, for example, by providing the low temperature use of polyolefins, while also providing the high temperature use of, for example, a glass-filled nylon. All of the properties of this paragraph and others in the disclosure also pertain to any physical blend described herein, including, for example, a physical blend of plastic pellets of PLA, pellets of an elastomer, and pellets of an inorganic filler (e.g., in a base material), after the physical blend is converted by melt compounding the pellets or melt processing the blend (‘salt and pepper blend’) into a finished good, such as a sheet material, film material, or a thermoformed object such as a food tray (for example, for meat).

In some embodiments, the maximum stress measured in a modulus of elasticity test of a polymeric composition comprising a PLA homo-polymer and one or more additives as described herein, is greater than (e.g., about 5% greater than, about 10% greater than, about 15% greater than, etc.) the maximum stress measured for the PLA homo-polymer, when tested under the same conditions. In certain embodiments, the maximum stress measured in a maximum tensile stress test of a polymeric composition comprising a PLA homo-polymer and one or more additives as described herein, is greater than (e.g., about 5% greater than, about 10% greater than, about 15% greater than, etc.) the maximum stress measured for the PLA homo-polymer, when tensile stress is tested under the same conditions.

As discussed herein, any intimate or physical degradable polymeric blend described herein can be formed into film, e.g., blown film or extruded film, either of which can be oriented (such as uniaxially or biaxially), or formed into sheet, e.g., cast sheet. Such film or sheet can be thermoformed into any packaging material, including single-use packaging material, such as food packaging (e.g., a meat tray). The packaging can be either opaque with minimal light transmission or clear with maximum light transmission (minimum haze).

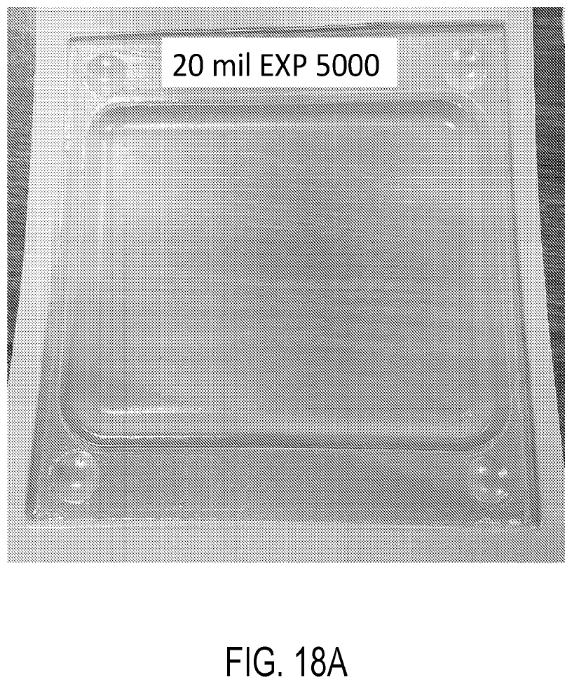

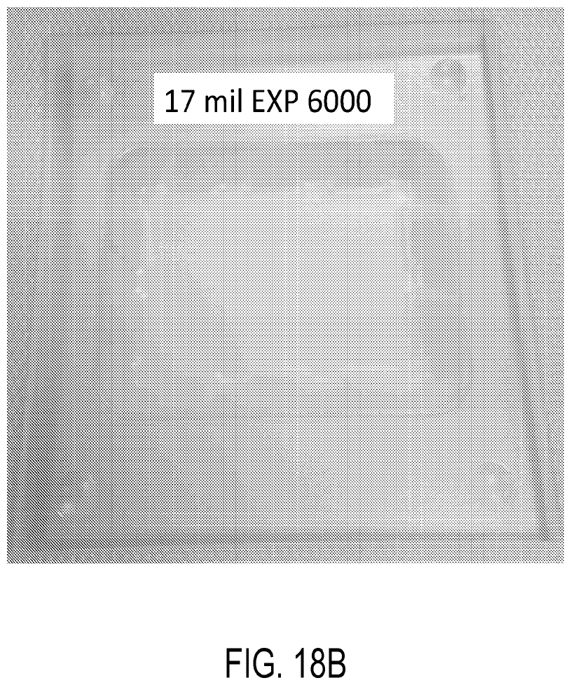

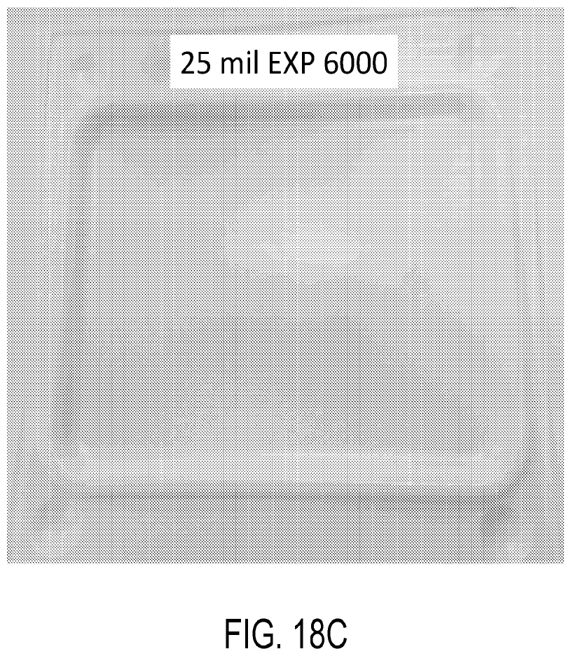

For example, any intimate or physical polymeric blend described herein when formed can have a haze, as measured by ASTM D1003, of less than about 85 percent, e.g., a percent haze that is about 80% or less, about 75% or less, about 70% or less, about 65% or less, about 55% or less, or about 50% or less. In some embodiments, the percent haze of the blend, as measured by ASTM D1003, is about 45% or less, about 35% or less, about 30% or less, about 25% or less, about 20% or less, or about 15% or less (such as 13%, 12%, 11%, 10%, 9%, 8%, 7%, 6%, 5%, 4%, 3%, 2%, or 1% or less). For clear packaging applications, in certain embodiments, the intimate or physical blends when formed have a haze that is in the range of about 1% to about 25%, e.g., about 1.5% to about 20%, or about 2% to about 15% haze. In addition, any intimate or physical polymeric blend described herein when formed can have a percent light transmission, as measured by ASTM D1003, of greater than about 10 percent, e.g., a percent light transmission that is about 15% or more, about 20% or more, about 25% or more, about 30% or more, about 40% or more, about 50% or more, about 60% or more, or about 70% or more. For example, in some embodiments, the percent light transmission of the blend, as measured by ASTM D1003, is about 75% or more, about 80% or more, or about 85% or more, such as at least 86%, at least 87%, at least 88%, or at least 90%; in certain embodiments, the percent light transmission of the blend, as measured by ASTM D1003, is greater than about 90%. For clear packaging applications, in certain embodiments, the intimate or physical blends when formed have a light transmission that is in the range of about 30% to about 90%, e.g., about 35% to about 85%, about 40% to about 80%, or about 45% to about 75%. FIGS. 18A-C show embodiments of particular blends used to make packaging of varying thicknesses with different degrees of light transmission or haze. FIG. 18A is a photograph of packaging made of a blend of 90% PLA 3052D and 10% Kraton™ 1924FG, and having a thickness of 20 mils (0.02 inches); FIG. 18B is a photograph of packaging made of a blend of 90% PLA 3052D and 10% Hytrel® 4068FG, and having a thickness of 17 mils (0.017 inches); FIG. 18C is a photograph of packaging made of a blend of 90% PLA 3052D and 10% Hytrel® 4068FG, and having a thickness of 25 mils (0.025 inches).

Certain preferable clear food packaging blends include PLA and a polyolefin elastomer, such as any POE described herein, including, e.g., a Kraton-type material. In such embodiments, the weight percentage of the POE in the degradable physical blend or intimate melt blend is from about 1 percent by weight of the blend to about 30 percent by weight of the blend, e.g., from about 2 wt. % to about 25 wt. %, from about 3 wt. % to about 24 wt. %, from about 4 wt. % to about 20 wt. %, or from about 4.5 wt. % to about 18 wt. % of the blend.

Any intimate or physical blend described herein may include a nucleating agent or a clarifying agent. For example, a blend as described herein may include sorbitol. When present in the blend, such nucleating agent or clarifying agent may be present in an amount that is from about 0.25 percent by weight of the blend to about 5 percent by weight of the blend, such as from about 0.35 wt. % to about 4 wt. %, or from about 0.5 wt. % to about 3 wt. % of the blend.

The polymeric blends of PLA (or of a heteropolymer of lactic acid) described herein may be spun into fibers or filaments ranging in diameter (if generally circular in cross-section) or having a maximum cross-section dimension of about 10 nm to about 2.50 mm, about 25 nm to about 1.50 mm, about 50 nm to about 1.00 mm, about 75 nm to about 0.75 mm (750 microns), about 100 nm to about 0.50 mm (500 microns), about 150 nm (0.15 micron) to about 250 microns, or about 1 micron to about 100 microns. Fibers and filaments having a cross-section dimension in the nanometer range are generally referred to as nanofibers, and fibers and filaments having a cross-section dimension in the micron range are generally referred to as microfibers. In cross-section, each fiber or filament can be, for example, circular, star-shaped, or multi-lobal (e.g., tri-lobal or tetra-lobal). Each fiber or filament can include a blend of plastics or can include any number of discrete portions, each portion being a different material or component to form, for example, bi-, tri- or tetra-component filaments or fibers. In certain embodiments, the polymeric compositions described herein are used with degradable and/or non-degradable plastics to make fibers or filaments. In some embodiments, the polymeric compositions described herein are used with natural and/or synthetic fibers and filaments.

In certain embodiments, the fibers or filaments made of the polymeric blends described herein are used to form woven, knit, and/or nonwoven textiles. Such textiles made with polymeric compositions as described herein can exhibit degradation rates that are faster than the degradation rates of textiles made primarily from materials such as polyester, nylon, or other material generally deemed to be non-degradable. In addition, polymeric compositions made into woven and/or nonwoven textiles generally will have higher surface areas compared to compositions used for certain other applications and therefore generally will have faster degradation rates. For example, for a fabric comprising a PLA polymeric composition and made of filaments having cross-section dimensions that are about 10-15 microns, the PLA polymeric composition will have a high surface area for water to penetrate and cause the material to degrade.

Woven textiles, e.g., woven fabrics, are generally made by using two or more sets of yarns interlaced at right angles to each other. Many varieties of woven fabrics are produced by weaving. Woven textile fabric types include, for example, buckram fabric, cambric fabric, casement fabric, cheesecloth, chiffon fabric, chintz fabric, corduroy fabric, crepe fabric, denim fabric, drill fabric, flannel fabric, gabardine fabric, georgette fabric, Kashmir silk fabric, khadi fabric, lawn fabric, mulmul fabric, muslin fabric, poplin fabric, sheeting fabric, taffeta fabric, tissue fabric, velvet fabric, mousseline fabric, organdie fabric, organza fabric, leno fabric, aertex fabric, madras net muslin fabric, and aida cloth. Any one or more of these woven fabrics can be made with the PLA polymeric blends described herein and can be used for a variety of applications, including but not limited to clothing and accessories (e.g., socks, hats, gloves, scarves, etc.), shoes (including shoe soles), bags, bedding and other linens, and fabrics used for toys, pillows, rugs, mats, upholstery, drapery, etc.

There are many different types of fabric weaves that may be used to create a woven textile. Examples of fabric weaves include, but are not limited to, plain weave, rib weave, basket weave, twill weave, herringbone weave, satin weave, sateen weave, leno weave, oxford weave, bedford cord weave, waffle weave, pile weave, jacquard weave, dobby weave, crepe weave, lappet weave, tapestry weave, striped weaves, checkered weave, and double cloth weave.

In certain embodiments, the fibers or filaments made of the PLA or lactic acid heteropolymer polymeric blends described herein are used to form knit fabrics. A knit fabric may be made from a single yarn or from multiple yarns. Examples of knit fabrics include jersey, ponte jersey, ribbing fabric, sweatshirt fleece, interlock fabric, spandex knit, double knit and polar fleece. Knit fabrics are generally suitable for any article, especially when stretch is desired, such as knit shirts, socks, sports apparel, uppers for shoes, shoe soles, gloves, sweaters, hats, tablecloths, and scarves.

Nonwoven textiles, e.g., nonwoven fabrics, generally are not made by weaving or knitting and do not require conversion of fibers to yarn. Nonwoven textiles are generally sheet or web structures bonded together by entangling fibers or filaments (or by perforating films) mechanically, thermally, or chemically. Nonwoven textiles are often flat, porous sheets that are made from separate fibers or from molten plastic or plastic film. The most common non-woven fabrics include spun bond (sometimes called spun laid) fabrics and melt-blown fabrics, and some fabrics may be made of layers of spun bond and melt-blown fabrics. A comprehensive overview of spun bond technology, processes, markets, and producers is provided in Hosun Lim, A Review of Spun Bond Process, J. of Textile and Apparel, Technology and Management, 6(3) 1-13 (Spring 2010), which is hereby incorporated by reference herein in its entirety.

Nonwoven textiles can range from a limited-life, single-use fabric to a durable fabric designed for long-term use, and they can be designed to mimic the appearance, texture, and strength of a woven fabric. Nonwoven fabrics also can provide specific properties, attributes, or functions, such as durability, sterility, softness, cushioning, washability, flame retardancy, absorbency, liquid repellency, resilience, strength, stretch, insulation, and filtering. Nonwoven fabrics can also serve as a microorganism barrier (e.g., a bacterial barrier). One or more of these properties or functions may be combined to create fabrics suited for specific uses.

Accordingly, nonwoven textiles can be used in a wide range of industries, including but not limited to agriculture and landscaping (e.g., agricultural coverings, agricultural seed strips, landscape fabrics), apparel and accessories (e.g., sports apparel, apparel linings, shoe components such as shoe soles, luggage, wallets), automotive (e.g., automotive upholstery and carpeting), civil engineering (e.g., geotextiles, insulation), medical (e.g., masks, surgical attire, sterile medical-use products), and household and personal care (e.g., disposable diapers and other personal care products with absorbent components, household and personal wipes, hygiene products, envelopes, filters).

In certain embodiments of the present invention, the PLA or lactic acid heteropolymer polymeric blends described herein are used to make such non-woven fabrics. The polymeric blends can also be used to make hybrid fabrics that include both woven and non-woven fabrics.

PLA synthesized from lactic acid or lactide is made from renewable raw material (e.g., biomass). Thus, the PLA polymeric blends, and any product (e.g., textile, packaging material, etc.) made from the PLA polymeric blends, are made at least in part from renewable raw material such as biomass, and therefore are made at least in part of modern carbon. The carbon found in and obtained from biomass has a different radiocarbon (Carbon-14 or C14) signature compared to carbon found in and obtained from fossil fuels. Atmospheric carbon contains a small but measurable fraction of Carbon-14, which is processed by green plants to make organic molecules during photosynthesis. Thus, the fraction of Carbon-14 in organic molecules in biomass reflects the fraction of Carbon-14 currently in the atmosphere. In contrast, the organic molecules in fossil fuels contain no Carbon-14. The percentage of carbon from biomass in a sample can be determined by Carbon-14 analysis, and a standardized methodology for Carbon-14 analysis is described in ASTM D6866, for example.

The percent modern carbon (pMC) describes the ratio of the amount of radiocarbon (Carbon-14) in a sample to the amount of radiocarbon in a modern reference standard. A modern reference standard commonly used is a National Institute of Standards and Technology standard (SRM 4990C) with a radiocarbon content approximately equivalent to the fraction of atmospheric radiocarbon in the year 1950 AD. The amount of radiocarbon in the modern reference standard represents 100 pMC. Because fossil fuels do not contain Carbon-14, a sample having carbon that is only petroleum-based carbon, for example, would have approximately 0 or 0 pMC. Further, because the fraction of Carbon-14 in the atmosphere today is higher than it was in 1950 AD, the pMC of materials made from recent biomass (e.g., biomass from sources living in the past 2-5 years) may be higher than 100 pMC. A number of certified testing labs are available to do this testing, including Beta Analytic Inc., 4985 SW 74th Court, Miami, Fla. 33155.

In certain embodiments, the polymeric blends of the present invention may be described in terms of percent modern carbon. For example, in some embodiments, a PLA polymeric blend comprising about 80% PLA can be described as a polymeric blend having about 80% pMC, a PLA polymeric blend comprising about 90% PLA can be described as a polymeric blend having about 90% pMC, and so on. In such embodiments, the pMC of the blend corresponds to the percentage of PLA in the blend.

In some embodiments, one or more additives in the PLA polymeric blend are also made from renewable raw material such as biomass. For example, in embodiments where a PLA polymeric blend comprises ethylene vinyl acetate, the vinyl acetate and/or the ethylene may be produced from biomass. See, e.g., U.S. Pat. Nos. 9,644,244, 9,677,039, 9,708,761, and 9,816,231 (the contents of each of which are hereby incorporated by reference in their entirety herein), which describe systems and methods for using biomass to produce bio-based ethanol, which can then be used to produce bio-based ethylene. In such embodiments, the pMC of the blend will be greater than the percentage of PLA in the blend and could reach 100 pMC, for example.

In certain embodiments, products (e.g., bottles, packaging materials, apparel including clothing and shoes, etc.) made at least in part with a polymeric blend of the present invention may be described in terms of pMC. For example, a bottle with an inner portion made of Hytrel® 3078 and an outer portion made of 90% PLA/10% Hytrel® 3078, where the outer portion accounts for 90% by weight of the bottle, would have a pMC of about 81.

Using a PLA polymeric blend of the present invention can reduce the consumption of fossil fuels, as PLA is made from biomass and does not rely on fossil fuels as a source material. Using a PLA or lactic acid heteropolymer polymeric blend of the present invention, instead of a polymeric material made largely from fossil fuel sources, can also reduce the net increase of carbon in the atmosphere and oceans.

### EXAMPLES

The following examples serve only to illustrate the invention and practice thereof.

The examples are not to be construed as limitations on the scope or spirit of the invention.

### Tensile Bar Tests

Polymeric compositions comprising PLA and PEBAX® 2533 SA 01, Hytrel® 3078, Hytrel® 4068FG, ecoflex® F Blend C1200, PEG, PVA, corn cob dust, and/or Kraton™ 1924FG: Commercial grade PLA resin pellets (Ingeo™ Biopolymer 3052D) were dried for 24 hours in a Dri-Air desiccant dryer (HDP-2) and tested to ensure a moisture content of less than 0.025 wt. %. The dried pellets were then loaded into a ThermoQC extrusion machine (PolyLab QC) fitted with a 2 mm die. After the machine was purged with straight PLA resin, the feed rate was calibrated to 100 g/min. The selected additive(s) (i.e., PEBAX® 2533 SA 01, Hytrel® 3078, Hytrel® 4068FG, ecoflex® F Blend C1200, PEG, PVA, corn cob dust, and/or Kraton™ 1924FG) was then dispensed into the feed throat via a vibratory conveyor that was calibrated to an addition rate corresponding to the wt. % of the elastomeric additive or co-polymer additive to be added to the PLA. The resulting molten polymeric filament was then fed through a cooling trough equipped with a pelletizing device. Once the newly compounded polymeric resin was in pellet form, it was again desiccant dried to a moisture level of less than 0.02%.

The dried resin in pellet form was then placed into the feed throat of a Toshiba EC 55 SXII injection molding machine to form the Polymer Blend test specimens into the form of ASTM D638-14 type IV tensile bars (unless otherwise indicated, all Polymer Blend Examples in Table 1A and Table 1B are in the form of tensile bars). The Polymer Blend test specimens were aged for at least one week and then subjected to degradation and mechanical properties testing.

Polymer Blends A and B were also extruded into a film using a Battenfeld extruder and blown though a Gloucester Engineering die. The film was blown at a 2 psi differential and was elongated 3 times. The film was captured by hand and was not slit.

### Tensile Bar Tests—Degradation

PLA degrades by hydrolysis of the ester bond along its main chain, and the rate and degree of degradation can be determined by the rate and degree by which its molecular weight decreases over time. The loss of molecular weight of PLA can be tracked using gel permeation chromatography (GPC) or size exclusion chromatography (SEC). PLA may degrade into its monomeric unit, lactic acid.

Degradation rates were determined using a temperature humidity chamber in accordance with ASTM D7475, which is hereby incorporated by reference herein in its entirety. The polymeric compositions comprising PLA were exposed to 95% RH and temperatures of 95° F. (308.15° K), 120° F. (322.04° K), and/or 140° F. (333.15° K), and the weight average molecular weight was determined periodically by gel permeation chromatography (GPC). A temperature of 140° F. is the maximum temperature allowed in a compost pile by ASTM D7475, and the typical temperature of a compost pile is 120° F.

### Degradation Test 1

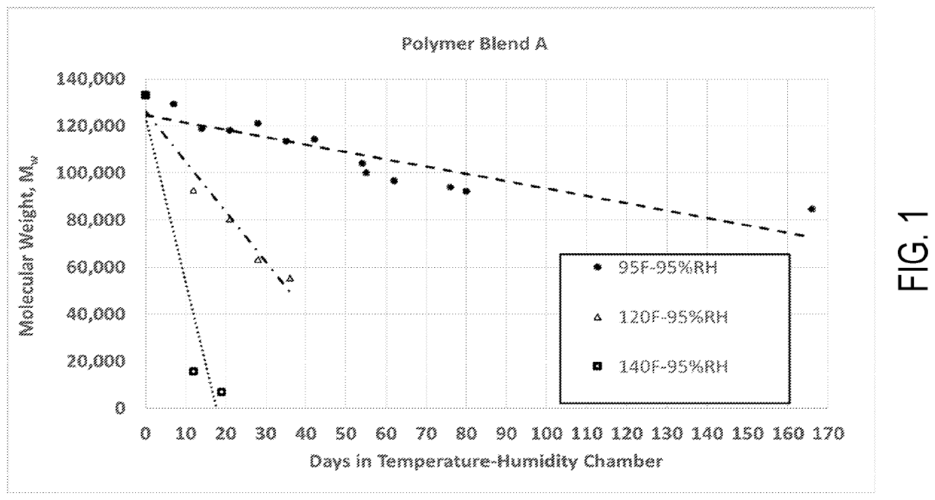

The results for Polymer Blend A (90 wt. % Ingeo™ Biopolymer 3052D, 10 wt. % PEBAX® 2533 SA 01) incubated at 95% relative humidity (RH), at three different temperatures (95° F. (308.15° K), 120° F. (322.04° K), and 140° F. (333.15° K)), are shown in FIG. 1. The lines represent the least squares fit of the data. FIG. 1 illustrates how the degradation rate increases rapidly when the temperature is increased from 95° F., with the polymeric composition degrading substantially in less than 3 weeks at 140° F.

### Degradation Test 2

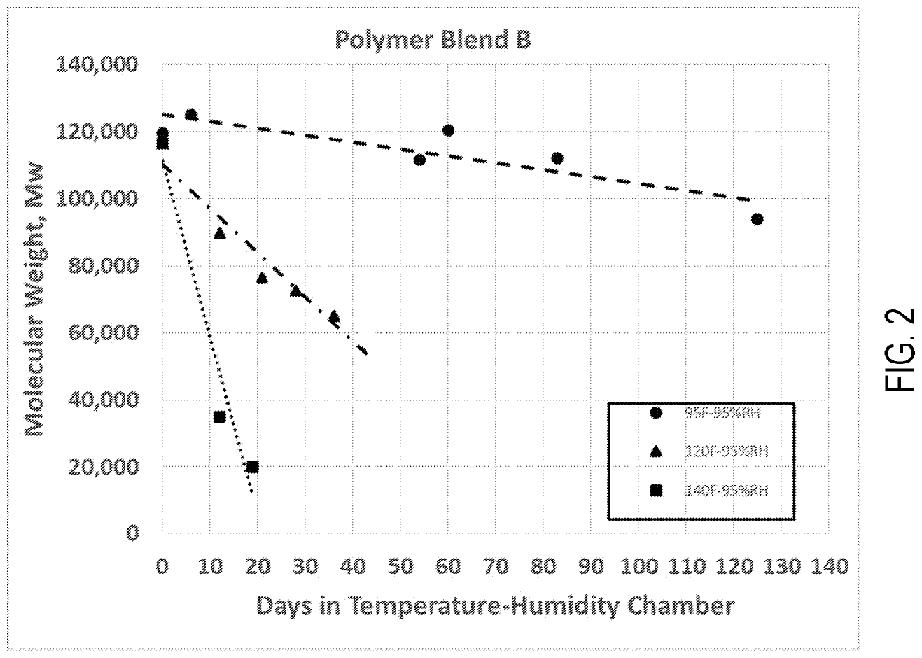

The results for Polymer Blend B (90 wt. % Ingeo™ Biopolymer 3052D, 10 wt. % Hytrel® 3078), incubated at 95% RH, at three different temperatures (95° F. (308.15° K), 120° F. (322.04° K), and 140° F. (333.15° K)), showed a trend similar to the trend observed for Polymer Blend A. These results are shown in FIG. 2.

### Degradation Test 3

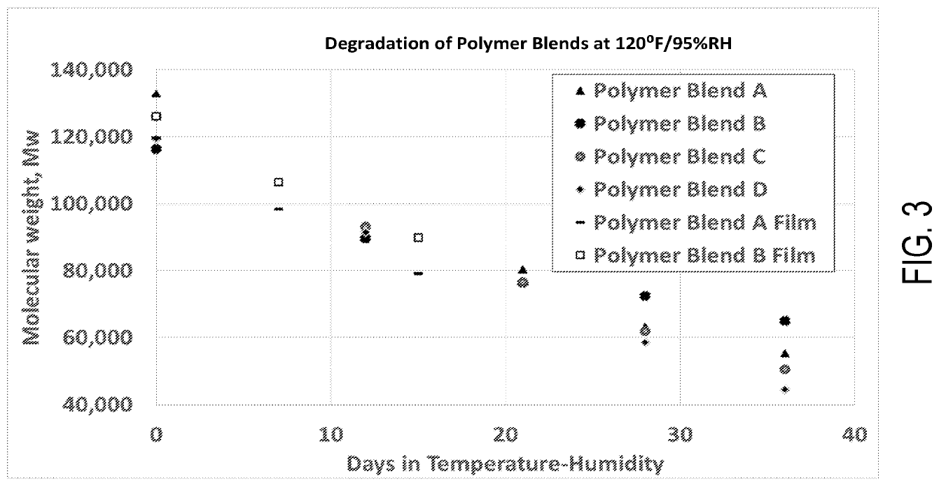

The degradation rates of Polymer Blend A (90 wt. % Ingeo™ Biopolymer 3052D, 10 wt. % PEBAX® 2533 SA 01), Polymer Blend B (90 wt. % Ingeo™ Biopolymer 3052D, 10 wt. % Hytrel® 3078), Polymer Blend C (90 wt. % Ingeo™ Biopolymer 3052D, 10 wt. % ecoflex® F Blend C1200), Polymer Blend D (control: 100 wt. % Ingeo™ Biopolymer 3052D), Polymer Blend A in film form, and Polymer Blend B in film form, were assessed at 95% RH and at 120° F. (322.04° K). The results are shown in FIG. 3.

All of the Polymer Blends exhibited similar degradation rates. The addition of each of the elastomeric additives to PLA did not appear to substantially alter the degradation rate of the polymeric composition as compared to Polymer Blend D (control blend, 100 wt. % Ingeo™ Biopolymer 3052D). These data suggest that while PEBAX® 2533 SA 01, Hytrel® 3078, and ecoflex® F Blend C1200, can significantly improve the mechanical properties of the Polymer Blend composition (see below), they do not materially affect the Polymer Blend composition's degradation rate.

Polymer Blend A and Polymer Blend B were also used to manufacture a clear (transparent) film. Degradation of the film form of Polymer Blend A and B has been tested for up to 15 days; results indicate that the degradation rate of the film form is faster than the degradation rate of the tensile bar form for each of the Polymer Blends (FIG. 3).

### Tensile Bar Tests—Mechanical Properties

The following Table 1A provides examples of binary polymeric compositions comprising PLA combined with PEBAX® 2533 SA 01, Hytrel® 3078, ecoflex® F Blend C1200, PEG 35,000, PEG 12,000, PVA 150,000, or 0.2 mm corn cob dust.

TABLE 1A

| | | | Tensile Properties ASTM D638-14 | | | |
|---|---|---|---|---|---|---|
| | | | (Type IV Specimen) | | | D256 |
| | | | | Maximum | | (IZOD) |
| Polymer | | | Modulus of | tensile | Strain to | Impact |
| Blend | Polymeric | | elasticity | stress | Failure | Strength |
| Example | Composition | | (psi) | (psi) | (%) | (ft · lb/in²) |
| E | 100% PLA | Average | 513,357 | 8,859 | 3.39 | 0.48 |
| | 3052D | One SD | 28,241 | 92 | 0.26 | 0.03 |
| F | 90% PLA | Average | 455,629 | 7,343 | 34.51 | 0.61 |
| | 3052D/5% | One SD | 19,620 | 71 | 16.2 | 0.10 |
| | PEBAX | | | | | |
| | 2533 | | | | | |
| G | 90% PLA | Average | 438,580 | 6,465 | 58.8 | 0.81 |
| | 3052D/ | One SD | 22,212 | 362 | 16.92 | 0.05 |
| | 10% PEBAX | | | | | |
| | 2533 | | | | | |
| H | 90% PLA | Average | 431,045 | 7,184 | 43.75 | 0.68 |
| | 3052D/ | One SD | 11,687 | 298 | 10.19 | 0.12 |
| | 10% Hytrel | | | | | |
| | 3078 | | | | | |
| I | 90% PLA | Average | 426,681 | 7,704 | 54.58 | 0.61 |
| | 3052D/ | One SD | 6,961 | 35 | 11.92 | 0.06 |
| | 10% Ecoflex | | | | | |
| J | 95% PLA | Average | 429,031 | 7,412 | 2.77 | 0.54 |
| | 3052D/ | One SD | 48,910 | 825 | 0.26 | 0.05 |
| | 5% PEG | | | | | |
| | 35,000 | | | | | |
| K | 95% PLA | Average | 324,543 | 5,157 | 15.64 | 0.60 |
| | 3052D/ | One SD | 19,910 | 67 | 4.9 | 0.05 |
| | 5% PEG | | | | | |
| | 12,000 | | | | | |
| L | 100% PLA | Average | 513,357 | 8,859 | 3.39 | 0.48 |
| | 3052D | One SD | 28,241 | 92 | 0.26 | 0.03 |
| M | 95% PLA | Average | 533,138 | 9,116 | 2.43 | 0.44 |
| | 3052D/ | One SD | 4,517 | 152 | 0.16 | 0.02 |
| | 5% PVA | | | | | |
| | 150,000 | | | | | |
| N | 95% PLA | Average | 514,972 | 8,525 | 3.1 | N/A |
| | 3052D/ | One SD | 18,581 | 56 | 0.52 | N/A |
| | 5% 0.2 mm | | | | | |
| | corn cobb | | | | | |
| | dust | | | | | |

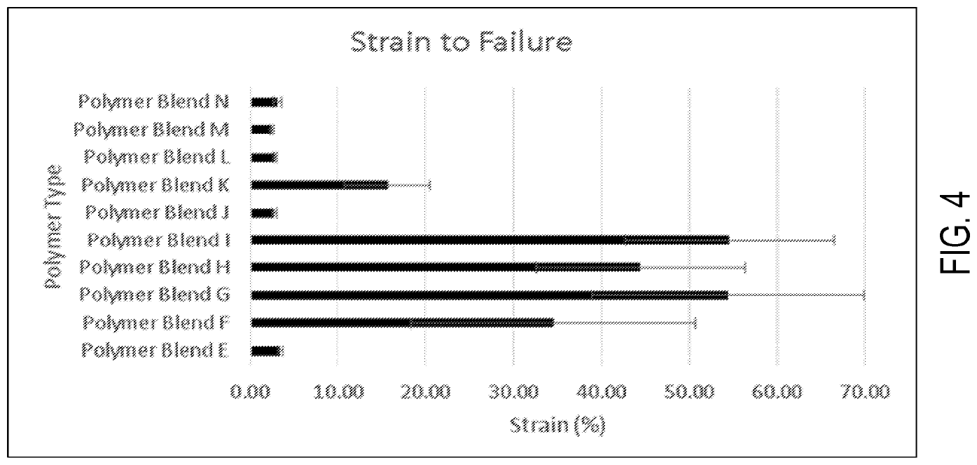

FIGS. 4-6 summarize the data in Table 1A.

FIG. 4 depicts the strain to failure results for each Polymer Blend composition in Table 1A. The strain to failure (also known as elongation at break or ductility) test provides a measure of the ductility of the material. The strain to failure data in FIG. 4 were obtained using Instron 5967 in accordance with ASTM D638-14, which is hereby incorporated by reference herein in its entirety. Six tests were performed per sample in order to determine the Average and Standard Deviation (“SD”).

Polymer Blends F-I and K demonstrated higher strain to failure percentages than PLA homo-polymer (Polymer Blends E and L, which are control blends), indicating that the addition of PEBAX® 2533 SA 01, Hytrel® 3078, ecoflex® F Blend C1200, or PEG 12,000 to PLA increases the ductility of the resulting polymeric composition as compared to PLA homo-polymer. Polymer Blends J, M, and N, which are polymeric compositions comprising PLA combined with the co-polymer additives PEG 35,000, PVA 150,000, and 0.2 mm corn cob dust, respectively, exhibit similar strain to failure percentages as the PLA homo-polymer (Polymer Blends E and L).

Polymer Blends F-I and K demonstrated higher impact strength than PLA homo-polymer (Polymer Blends E and L, which are controls), indicating that the addition of PEBAX® 2533 SA 01, Hytrel® 3078, ecoflex® F Blend C1200, or PEG 12,000 to PLA increases the impact strength of the resulting polymeric composition as compared to PLA homo-polymer. Polymer Blends J and M, which are polymeric compositions comprising PLA combined with the co-polymer additives PEG 35,000 and PVA 150,000, respectively, exhibit similar impact strength as the PLA homo-polymer (Polymer Blends E and L).

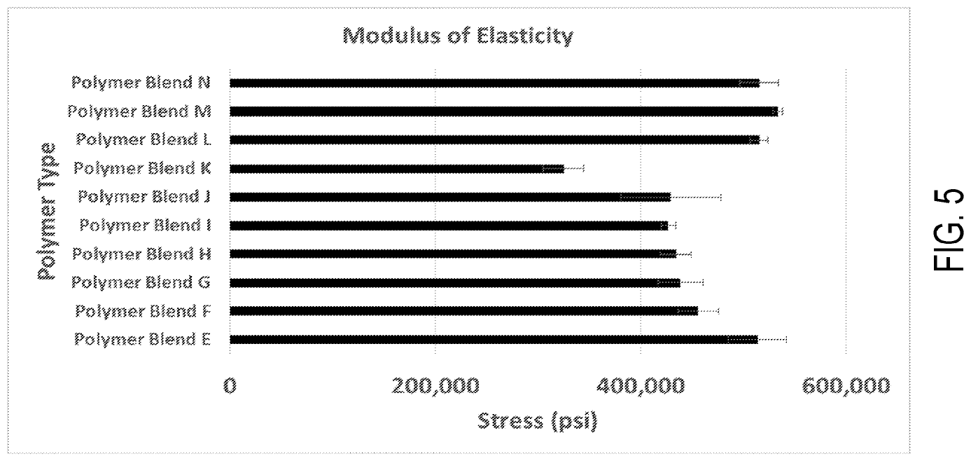

FIG. 5 depicts the modulus of elasticity results for each composition in Table 1A. The modulus of elasticity (elastic modulus) is a measure of the stiffness of the material. The modulus of elasticity was measured using Instron 5967 in accordance with ASTM D638-14, which is hereby incorporated by reference herein in its entirety. Six tests were performed per sample in order to determine the Average and Standard Deviation.

Polymer Blends F-K demonstrated lower modulus of elasticity than PLA homo-polymer (Polymer Blends E and L, which are controls), indicating that the addition of PEBAX® 2533 SA 01, Hytrel® 3078, ecoflex® F Blend C1200, PEG 35,000, or PEG 12,000 to PLA decreases the stiffness of the resulting polymeric composition as compared to PLA homo-polymer. Polymer Blends M and N, which are polymeric compositions comprising PLA combined with the co-polymer additives PVA 150,000 and 0.2 mm corn cob dust, respectively, exhibited similar modulus of elasticity as the PLA homo-polymer (Polymer Blends E and L).

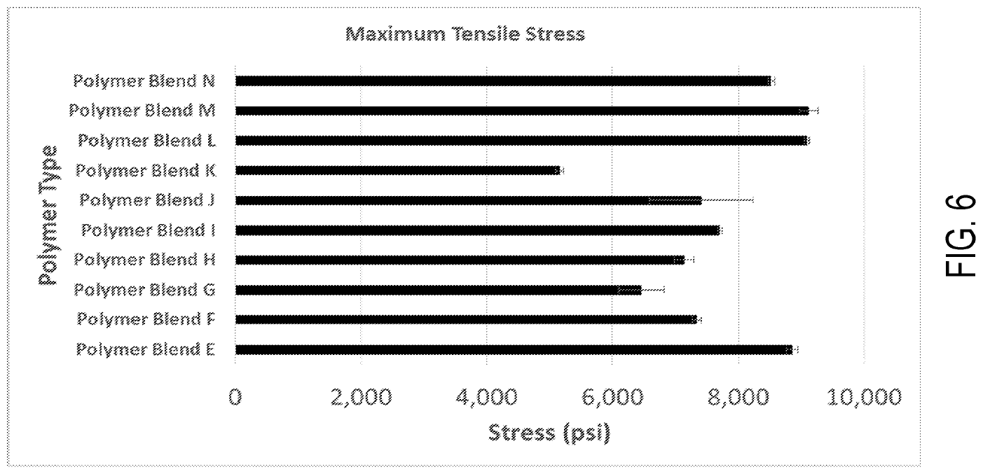

FIG. 6 depicts the maximum tensile stress (also called maximum tensile strength, or tensile stress at maximum load) results for each composition in Table 1A. The maximum tensile strength is a measure of the strength of the material under tension. The maximum tensile strength data were obtained using an Instron tensile testing machine and Instron impact test in accordance with ASTM D638-14 (tensile test) and ASTM D256 (IZOD impact), each of which is hereby incorporated by reference herein in its entirety. Six tests were performed per sample in order to determine the Average and Standard Deviation.

Polymer Blends F-K demonstrated lower maximum tensile strength than PLA homo-polymer (Polymer Blends E and L, which are controls), indicating that the addition of PEBAX® 2533 SA 01, Hytrel® 3078, ecoflex® F Blend C1200, PEG 35,000, or PEG 12,000 to PLA decreases the strength of the resulting polymeric composition as compared to PLA homo-polymer. Polymer Blends M and N, polymeric compositions comprising PLA combined with the co-polymer additives PVA 150,000 and 0.2 mm corn cob dust, respectively, exhibited similar maximum tensile strength as the PLA homo-polymer (Polymer Blends E and L).

Further, Polymer Blends J and K were severely degraded after one week, with Polymer Blend K being more degraded than Polymer Blend J. This observation indicates that the molecular weight of the PEG can influence the degradation rate of a PLA polymeric blend, with lower molecular weight PEG leading to degradation at a higher rate, compared to higher molecular weight PEG.

The degradation rate and mechanical properties testing of Polymer Blends A-N demonstrated that both degradation rate and mechanical properties can be altered by the identity, amount, and molecular weight of additives, such as elastomeric additives and/or co-polymer additives.

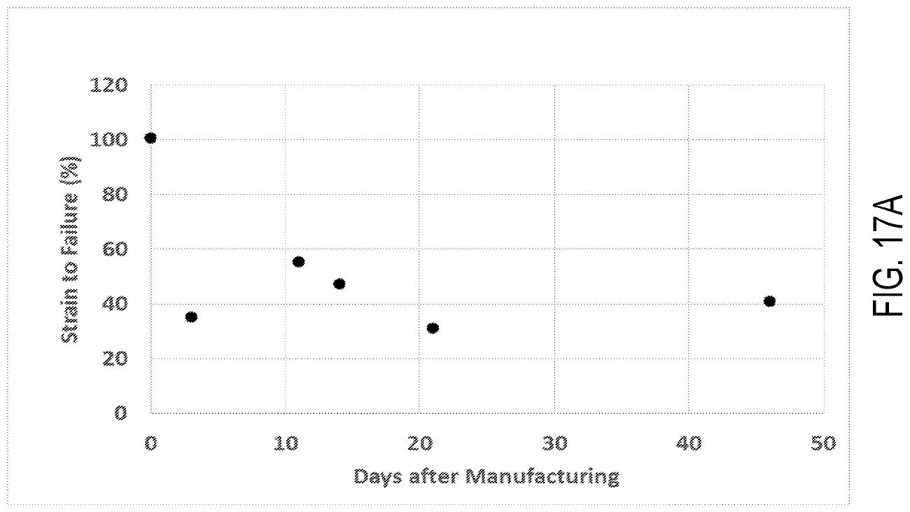

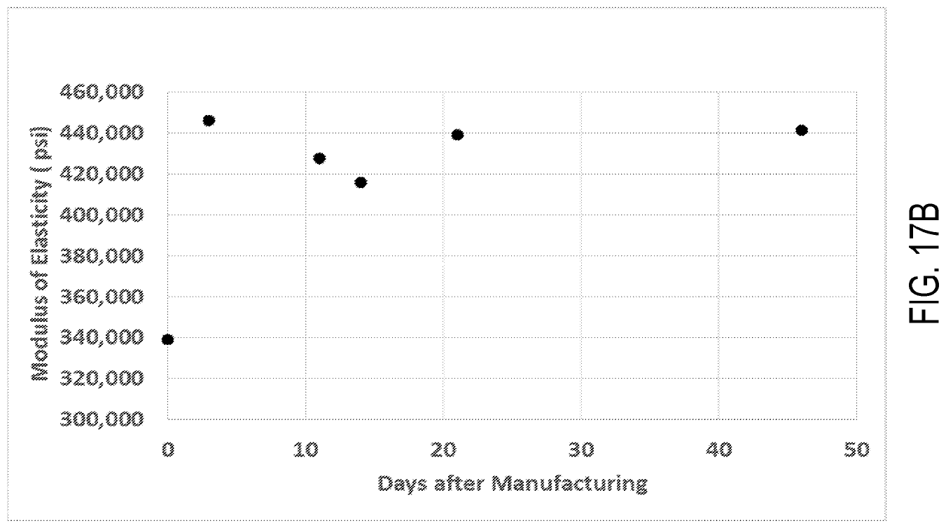

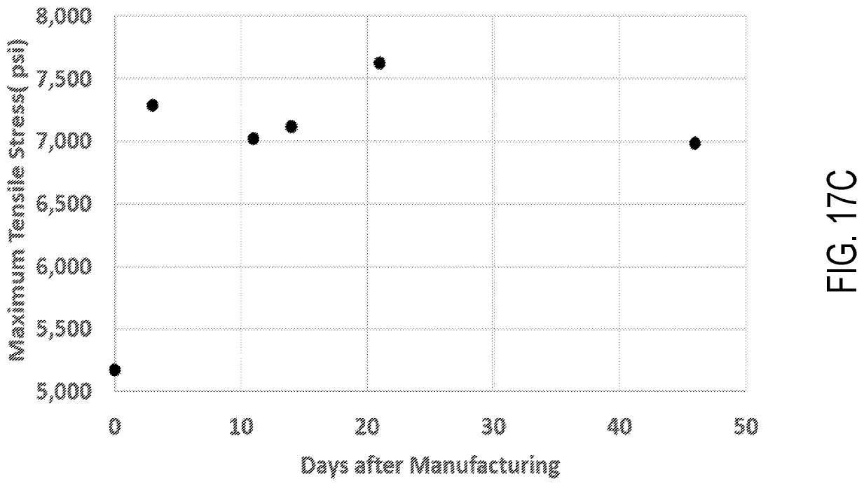

The modulus of elasticity, maximum tensile stress, and strain to failure results over time for tensile bars made from a polymer blend of 90% PLA 3052D/10% Hytel® 3078 are depicted in FIGS. 17A-C. FIG. 17A demonstrates that strain to failure decreases rapidly after manufacturing of the tensile bar and then stabilizes by approximately day 7. FIGS. 17B and 17C demonstrate, respectively, that the modulus of elasticity and maximum tensile stress rapidly increase after manufacturing of the tensile bar and then stabilize by approximately day 7.

The following Table 1B provides examples of binary polymeric compositions of PLA combined with Hytrel® 3078, Hytrel® 4068FG, or Kraton™ 1924FG, and a ternary polymeric composition comprising PLA combined with Hytrel® 3078 and Kraton™ 1924FG.

TABLE 1B

| | | | Tensile Properties ASTM D638-14 | | | ASTM |
|---|---|---|---|---|---|---|
| | | | (Type IV Specimen) | | | D256 |
| | | | | Maximum | | (IZOD) |
| Polymer | | | Modulus of | Tensile | Strain to | Impact |
| Blend | Polymeric | | Elasticity | Stress | Failure | Strength |
| Example | Composition | | (psi) | (psi) | (%) | (ft · lb/in²) |
| O | 90% PLA 3052D/ | Average | 431,045 | 7,184 | 43.75 | 0.66 |
| | 10% Hytrel 3078 | One SD | 11,687 | 298 | 20 | 0.11 |
| P | 90% PLA 3052D/ | Average | 435,307 | 7,827 | 81.60 | 0.69 |
| | 10% Hytrel | One SD | 3,546 | 32 | 35.63 | 0.08 |
| | 4068FG | | | | | |
| Q | 90% PLA 3052D/ | Average | 416,760 | 6,745 | 16.08 | 1.21 |
| | 10% Kraton | One SD | 14,166 | 94 | 5.19 | 0.09 |
| | 1924FG | | | | | |
| R | 80% PLA 3052D/ | Average | 352,525 | 5,294 | 23.23 | 1.97 |
| | 10% Hytrel 3078/ | One SD | 20,521 | 193 | 11.85 | 0.31 |
| | 10% Kraton | | | | | |
| | 1924FG | | | | | |

The modulus of elasticity (elastic modulus), maximum tensile stress, and strain to failure data in Table 1B were obtained using Instron 5967 in accordance with ASTM D638-14, which is hereby incorporated by reference herein in its entirety. Tensile bars made from each of the polymeric blends in Table 1B (Polymer Blend Examples O-R) were tested on day 7 after their manufacture; tensile bars from Polymer Blends O and P were also tested on at least one other subsequent day (later than day 7) following manufacture. For each test day for each blend, the test was performed on six tensile bars (six replicates), and the results from those six replicates were averaged. The results from all of the tests for each blend were then averaged, and those averages are provided in Table 1B.

Tensile bars made with Polymer Blends O-R demonstrated higher strain to failure percentages than tensile bars made with PLA homo-polymer (Polymer Blends E and L from Table 1A, which are control blends), indicating that the addition of Hytrel® 3078, Hytrel® 4068FG, or Kraton™ 1924FG to PLA increases the ductility of the resulting polymeric composition as compared to the ductility of the PLA homo-polymer.

Tensile bars made with Polymer Blends O-R demonstrated higher impact strength than tensile bars made with PLA homo-polymer (Polymer Blends E and L from Table 1A, which are controls), indicating that the addition of Hytrel® 3078, Hytrel® 4068FG, or Kraton™ 1924FG to PLA increases the impact strength of the resulting polymeric composition as compared to the impact strength of the PLA homo-polymer.

Tensile bars made with Polymer Blends O-R demonstrated lower modulus of elasticity (elastic modulus) than tensile bars made with PLA homo-polymer (Polymer Blends E and L from Table 1A, which are controls), indicating that the addition of Hytrel® 3078, Hytrel® 4068FG, or Kraton™ 1924FG to PLA decreases the stiffness of the resulting polymeric composition as compared to the stiffness of the PLA homo-polymer.

Tensile bars made with Polymer Blends O-R demonstrated lower maximum tensile stress than tensile bars made with PLA homo-polymer (Polymer Blends E and L from Table 1A), indicating that the addition of Hytrel® 3078, Hytrel® 4068FG, or Kraton™ 1924FG to PLA decreases the mechanical strength but increases the ductility of the resulting polymeric composition as compared to the mechanical strength and ductility of the PLA homo-polymer.

### Yarn Tests

Polymeric compositions comprising PLA and PEBAX® 2533 SA 01, Hytrel® 3078, PBS FZ71, or PBS FD92: Commercial grade PLA resin pellets (Ingeo™ Biopolymer 3052D) were dried for 24 hours in a Dri-Air desiccant dryer (HDP-2) and tested to ensure a moisture content of less than 0.025 wt. %. The dried pellets were then loaded into a ThermoQC extrusion machine (PolyLab QC) fitted with a 2 mm die. After the machine was purged with straight PLA resin, the feed rate was calibrated to 100 g/min. The selected additive (i.e., PEBAX® 2533 SA 01, Hytrel® 3078, PBS FZ71, PBS FD92) was then dispensed into the feed throat via a vibratory conveyor that was calibrated to an addition rate corresponding to the wt. % of the additive to be added to the PLA. The resulting molten polymeric filament was then fed through a cooling trough equipped with a pelletizing device. Once the newly compounded polymeric resin was in pellet form, it was again desiccant dried to a moisture level of less than 0.025%.

The dried resin in pellet form was spun into yarns by using a 1″ extruder operating at 400° F., and at a spinning rate of between 400 and 1200 m/min. The spin pack included 72 circular orifices having a diameter of 0.35 mm, and the individual filaments were air quenched using 50° F. air. Un-oriented yarns (UOY) were captured on doffs without drawing, while oriented yarns were drawn between heated rolls operating at 175° F. and then captured on doffs. Both the UOY and the oriented drawn yarn were tested for flexibility and strength within 1 hour of spinning.

Tables 2 and 4-5 provide elongation at break (flexibility) and tenacity (strength) at different time points for binary and ternary polymeric compositions comprising PLA combined with PEBAX® 2533 SA 01, Hytrel® 3078, PBS FZ71, and/or PBS FD92. Each composition was made into a Polymer Blend Yarn of 72 strands. For each Polymer Blend Yarn, Tables 2 and 4-5 provide the number of draws (for Polymer Blend Yarn that is oriented yarn) and denier (weight). Table 2 (Run 1) provides the elongation at break and tenacity of each Polymer Blend Yarn on the day it was drawn; Table 4 (Run 2) provides the elongation at break and tenacity of each Polymer Blend Yarn about 40 days after it was drawn; Table 5 (Run 3) provides the elongation at break and tenacity of each Polymer Blend Yarn about 60 days after it was drawn. Table 6 provides the elongation at break and tenacity of each Polymer Blend Yarn at 0 days (Run 1), at about 40 days (Run 2), and at about 60 days (Run 3) after it was drawn. Each Polymer Blend Yarn was tested once for Run 1 (Table 2), and each Polymer Blend Yarn was tested multiple times for Run 2 (Table 4) and Run 3 (Table 5). The average results for Run 2 (Table 4) and Run 3 (Table 5) are reported in Table 6.

TABLE 2

| Polymer | | | | | | |
|---|---|---|---|---|---|---|
| Blend | | Draw | Denier | Number of | Elongation | Tenacity |
| Yarn | Material | Down | (g/9000 m) | Strands | at Break % | (g/denier) |
| 1 | 95.3% PLA | UOY | 658 | 72 | 228.0 | 1.21 |
| | 3052D/ | | | | | |
| | 4.7% Pebax 2533 | | | | | |
| 2 | 95.3% PLA | 3.00 | 225 | 72 | 21.3 | 2.80 |
| | 3052D/ | | | | | |
| | 4.7% Pebax 2533 | | | | | |
| 3 | 90.3% PLA | UOY | 644 | 72 | 167.0 | 1.13 |
| | 3052D/9.7% | | | | | |
| | Pebax 2533 | | | | | |
| 4 | 90.3% PLA | 2.00 | 216 | 72 | 17.0 | 2.30 |
| | 3052D/9.7% | | | | | |
| | Pebax 2533 | | | | | |
| 5 | 95.3% PLA | UOY | 676 | 72 | 196.0 | 1.25 |
| | 3052D/4.7% | | | | | |
| | Hytrel 3078 | | | | | |
| 6 | 95.3% PLA | 3.00 | 223 | 72 | 20.0 | 2.80 |
| | 3052D/4.7% | | | | | |
| | Hytrel 3078 | | | | | |
| 7 | 95.3% PLA | 3.42 | 225 | 72 | 18.0 | 2.93 |
| | 3052D/4.7% | | | | | |
| | Hytrel 3078 | | | | | |
| 8 | 90.4% PLA | UOY | 649 | 72 | 185.0 | 1.25 |
| | 3052D/9.6% | | | | | |
| | Hytrel 3078 | | | | | |
| 9 | 90.4% PLA | 2.80 | 220 | 72 | 14.0 | 2.18 |
| | 3052D/9.6% | | | | | |
| | Hytrel 3078 | | | | | |
| 10 | 90.4% PLA | 2.00 | 222 | 72 | 24.0 | 2.47 |
| | 3052D/9.6% | | | | | |
| | Hytrel 3078 | | | | | |
| 11 | 95% PLA 3052D/ | UOY | 663 | 72 | 206.0 | 1.35 |
| | 5.0% PBS FZ71 | | | | | |
| 12 | 95% PLA 3052D/ | 3.00 | 226 | 72 | 15.0 | 2.60 |
| | 5.0% PBS FZ71 | | | | | |
| 13 | 95% PLA 3052D/ | 3.25 | 225 | 72 | 16.3 | 2.80 |
| | 5.0% PBS FZ71 | | | | | |
| 14 | 85% PLA 3052D/ | UOY | 661 | 72 | 231.0 | 1.23 |
| | 15.0% PBS FZ71 | | | | | |
| 15 | 85% PLA 3052D/ | 2.80 | 226 | 72 | 18.2 | 2.74 |
| | 15.0% PBS FZ71 | | | | | |
| 16 | 85% PLA 3052D/ | 2.50 | 226 | 72 | 17.9 | 2.56 |
| | 15.0% PBS FZ71 | | | | | |
| 17 | 95.3% PLA | UOY | 659 | 72 | 169.0 | 1.24 |
| | 3052D/4.7% PBS | | | | | |
| | FD92 | | | | | |
| 18 | 95.3% PLA | 2.80 | 222 | 72 | 16.9 | 2.92 |
| | 3052D/4.7% PBS | | | | | |
| | FD92 | | | | | |
| 19 | 100% PLA 3052D | UOY | 632 | 72 | 249.0 | 1.18 |
| 20 | 100% PLA 3052D | 3.00 | 230 | 72 | 26.8 | 3.21 |
| 21 | 100% PLA 3052D | 3.87 | 230 | 72 | 20.0 | 3.04 |
| 22 | 85% PLA 3052D/ | UOY | 663 | 72 | 118.0 | 1.34 |
| | 15.0% PBS FD92 | | | | | |
| 23 | 85% PLA 3052D/ | 1.90 | 228 | 72 | 18.5 | 3.37 |
| | 15.0% PBS FD92 | | | | | |
| 24 | 95.3% PLA | UOY | 676 | 72 | 212.0 | 1.36 |
| | 3052D/4.7% PBS | | | | | |
| | FZ91 | | | | | |
| 25 | 95.3% PLA | 3.00 | 230 | 72 | 17.0 | 2.96 |
| | 3052D/4.7% PBS | | | | | |
| | FZ91 | | | | | |
| 26 | 95.3% PLA | 3.25 | 230 | 72 | 16.0 | 3.00 |
| | 3052D/4.7% PBS | | | | | |
| | FZ91 | | | | | |
| 27 | 85% PLA 3052D/ | UOY | 682 | 72 | 125.0 | 1.39 |
| | 15.0% PBS FZ91 | | | | | |
| 28 | 85% PLA 3052D/ | 2.00 | 227 | 72 | 22.0 | 3.04 |
| | 15.0% PBS FZ91 | | | | | |
| 29 | 86.8% PLA | UOY | 660 | 72 | 149 | 1.13 |
| | 3052D/ | | | | | |
| | 8.25% PBS FD92/ | | | | | |
| | 4.95% Hytrel 3078 | | | | | |
| 30 | 86.8% PLA | 2.50 | 224 | 72 | 13.3 | 2.32 |
| | 3052D/8.25% | | | | | |
| | PBS FD92/4.95% | | | | | |
| | Hytrel 3078 | | | | | |
| 31 | 86.8% PLA | 2.50 | 226 | 72 | 16.6 | 2.65 |
| | 3052D/8.25% | | | | | |
| | PBS FD92/4.95% | | | | | |
| | Hytrel 3078 | | | | | |
| 32 | 86.8% PLA | UOY | 640 | 72 | 200.0 | 1.10 |
| | 3052D/8.25% | | | | | |
| | PBS FD92/4.95% | | | | | |
| | Hytrel 3078 | | | | | |
| 33 | 86.8% PLA | 2.00 | 226 | 72 | 20.0 | 3.14 |
| | 3052D/8.25% | | | | | |
| | PBS FD92/4.95% | | | | | |
| | PEBAX 2533 | | | | | |

As shown in Table 2, oriented yarn that was drawn generally became thinner (leading to a decrease in denier), less flexible (leading to a decrease in elongation at break), and stronger (leading to an increase in tenacity), when compared to the un-oriented yarn (UOY).

To make spun bond nonwoven textiles, a polymer blend composition may be subjected to high-speed spinning of at least about 2200 m/min. Four polymer blend compositions were subjected to simulated spun bond conditions: spinning at a rate exceeding 2200 m/min and then aspiration of the spun yarn. All four blends tested passed this simulation (see Table 3).

TABLE 3

| Polymer Blend | | Can be spun |
|---|---|---|
| Yarn | Material | at >2200 m/min? |
| 34 | 95.3% PLA 3052D/ | Yes |
| | 4.7% PBS FZ91 | |
| 35 | 85% PLA 3052D/ | Yes |
| | 15.0% PBS FZ91 | |
| 36 | 86.8% PLA 3052D/8.25% PBS | Yes |
| | FD92/4.95% Hytrel 3078 | |
| 37 | 86.8% PLA 3052D/8.25% PBS | Yes |
| | FD92/4.95% PEBAX 2533 | |

Spun bond nonwoven textiles were successfully produced using the following PLA polymeric blends: 95% PLA 3052D with 5% Hytrel® 3078; 90% PLA 3052D with 10% Hytrel® 3078; and 85% PLA 3052D with 15% Hytrel® 3078. The spun bond nonwoven textiles produced from PLA 3052D and Hytrel® 3078 had a weight of about 125 to about 200 grams per square meter. In order to manufacture these spun bond nonwoven textiles, a polyolefin scrim layer was utilized as a carrier backing. Alternatively, a degradable scrim, such as one fabricated from PLA or PBS, could be utilized. For these spun bond nonwoven textiles, the polyolefin scrim layer and degradable PLA 3052D/Hytrel® 3078 blend layer were not compatible with each other and did not bond together. Thus, the polyolefin scrim did not become continuous with the degradable PLA 3052D/Hytrel® 3078 blend fabric and the two layers were easily separated from each other. However, compatible scrims may be utilized so that composite spun bond fabrics are produced that may have improved strength, especially in a direction perpendicular to the production axis of the fabric.

The testing of Polymer Blend Yarns 1-37 demonstrated that both flexibility and strength of the yarn can be altered by the identity and amount of the elastomeric additives and/or co-polymer additives that are combined with PLA.

As discussed above, elongation at break and tenacity of each Polymer Blend Yarn were tested at different times after drawing. Table 4 (Run 2) provides results for tests conducted about 40 days after drawing; Table 5 (Run 3) provides results for tests conducted about 60 days after drawing. Table 6 reports the average results for Run 2 (Table 4) and Run 3 (Table 5).

TABLE 4

| Polymer | | | | | | |
|---|---|---|---|---|---|---|
| Blend | | Draw | Denier | Number of | Elongation | Tenacity |
| Yarn | Material | Down | (g/9000 m) | Strands | at Break % | (g/denier) |
| 1 | 95.3% PLA | UOY | 658 | 72 | 214.17 | 1.10 |
| | 3052D/ | | | | | |
| | 4.7% Pebax 2533 | | | | | |
| 1 | 95.3% PLA | UOY | 658 | 72 | 217.26 | 1.13 |
| | 3052D/ | | | | | |
| | 4.7% Pebax 2533 | | | | | |
| 1 | 95.3% PLA | UOY | 658 | 72 | 210.32 | 1.10 |
| | 3052D/ | | | | | |
| | 4.7% Pebax 2533 | | | | | |
| 1 | Average | UOY | 658 | 72 | 213.92 | 1.11 |
| 2 | 95.3% PLA | 3.00 | 225 | 72 | 26.74 | 2.40 |
| | 3052D/ | | | | | |
| | 4.7% Pebax 2533 | | | | | |
| 2 | 95.3% PLA | 3.00 | 225 | 72 | 25.60 | 2.78 |
| | 3052D/ | | | | | |
| | 4.7% Pebax 2533 | | | | | |
| 2 | Average | 3.00 | 225 | 72 | 26.17 | 2.59 |
| 3 | 90.3% PLA | UOY | 644 | 72 | 155.22 | 0.81 |
| | 3052D/9.7% | | | | | |
| | Pebax 2533 | | | | | |
| 3 | 90.3% PLA | UOY | 644 | 72 | 166.05 | 0.80 |
| | 3052D/9.7% | | | | | |
| | Pebax 2533 | | | | | |
| 3 | Average | UOY | 644 | 72 | 160.64 | 0.81 |
| 4 | 90.3% PLA | 2.00 | 216 | 72 | 26.12 | 2.11 |
| | 3052D/9.7% | | | | | |
| | Pebax 2533 | | | | | |
| 4 | 90.3% PLA | 2.00 | 216 | 72 | 21.46 | 2.31 |
| | 3052D/9.7% | | | | | |
| | Pebax 2533 | | | | | |
| 4 | Average | 2.00 | 216 | 72 | 23.79 | 2.21 |
| 5 | 95.3% PLA | UOY | 676 | 72 | 189.64 | 1.11 |
| | 3052D/4.7% | | | | | |
| | Hytrel 3078 | | | | | |
| 5 | 95.3% PLA | UOY | 676 | 72 | 189.05 | 1.09 |
| | 3052D/4.7% | | | | | |
| | Hytrel 3078 | | | | | |
| 5 | Average | UOY | 676 | 72 | 189.35 | 1.10 |
| 6 | 95.3% PLA | 3.00 | 223 | 72 | 23.48 | 2.35 |
| | 3052D/4.7% | | | | | |
| | Hytrel 3078 | | | | | |
| 6 | 95.3% PLA | 3.00 | 223 | 72 | 23.01 | 2.27 |
| | 3052D/4.7% | | | | | |
| | Hytrel 3078 | | | | | |
| 6 | Average | 3.00 | 223 | 72 | 23.25 | 2.31 |
| 7 | 95.3% PLA | 3.42 | 225 | 72 | 20.65 | 2.45 |
| | 3052D/4.7% | | | | | |
| | Hytrel 3078 | | | | | |
| 7 | 95.3% PLA | 3.42 | 225 | 72 | 21.79 | 2.21 |
| | 3052D/4.7% | | | | | |
| | Hytrel 3078 | | | | | |
| 7 | Average | 3.42 | 225 | 72 | 21.22 | 2.33 |
| 8 | 90.4% PLA | UOY | 649 | 72 | 151.15 | 0.89 |
| | 3052D/9.6% | | | | | |
| | Hytrel 3078 | | | | | |
| 8 | 90.4% PLA | UOY | 649 | 72 | 151.17 | 0.78 |
| | 3052D/9.6% | | | | | |
| | Hytrel 3078 | | | | | |
| 8 | Average | UOY | 649 | 72 | 151.16 | 0.84 |
| 9 | 90.4% PLA | 2.8 | 220 | 72 | 24.43 | 2.44 |
| | 3052D/9.6% | | | | | |
| | Hytrel 3078 | | | | | |
| 9 | 90.4% PLA | 2.8 | 220 | 72 | 25.42 | 2.38 |
| | 3052D/9.6% | | | | | |
| | Hytrel 3078 | | | | | |
| 9 | Average | 2.8 | 220 | 72 | 24.93 | 2.41 |
| 10 | 90.4% PLA | 2.00 | 222 | 72 | 25.23 | 2.61 |
| | 3052D/9.6% | | | | | |
| | Hytrel 3078 | | | | | |
| 10 | 90.4% PLA | 2.00 | 222 | 72 | 30.89 | 2.47 |
| | 3052D/9.6% | | | | | |
| | Hytrel 3078 | | | | | |
| 10 | Average | 2.00 | 222 | 72 | 28.06 | 2.54 |
| 11 | 95% PLA 3052D/ | UOY | 663 | 72 | 187.58 | 1.22 |
| | 5.0% PBS FZ71 | | | | | |
| 11 | 95% PLA 3052D/ | UOY | 663 | 72 | 183.35 | 1.16 |
| | 5.0% PBS FZ71 | | | | | |
| 11 | Average | UOY | 663 | 72 | 185.47 | 1.19 |
| 12 | 95% PLA 3052D/ | 3.00 | 226 | 72 | 21.99 | 2.34 |
| | 5.0% PBS FZ71 | | | | | |
| 12 | 95% PLA 3052D/ | 3.00 | 226 | 72 | 20.66 | 2.35 |
| | 5.0% PBS FZ71 | | | | | |
| 12 | Average | 3.00 | 226 | 72 | 21.33 | 2.35 |
| 13 | 95% PLA 3052D/ | 3.25 | 225 | 72 | 21.51 | 2.02 |
| | 5.0% PBS FZ71 | | | | | |
| 13 | 95% PLA 3052D/ | 3.25 | 225 | 72 | 20.16 | 2.09 |
| | 5.0% PBS FZ71 | | | | | |
| 13 | Average | 3.25 | 225 | 72 | 20.84 | 2.06 |
| 14 | 85% PLA 3052D/ | UOY | 661 | 72 | 157.57 | 0.87 |
| | 15.0% PBS FZ71 | | | | | |
| 14 | 85% PLA 3052D/ | UOY | 661 | 72 | 168.19 | 0.99 |
| | 15.0% PBS FZ71 | | | | | |
| 14 | Average | UOY | 661 | 72 | 162.88 | 0.93 |
| 15 | 85% PLA 3052D/ | 2.80 | 226 | 72 | 23.91 | 2.41 |
| | 15.0% PBS FZ71 | | | | | |
| 15 | 85% PLA 3052D/ | 2.80 | 226 | 72 | 24.19 | 2.23 |
| | 15.0% PBS FZ71 | | | | | |
| 15 | Average | 2.80 | 226 | 72 | 24.05 | 2.32 |
| 16 | 85% PLA 3052D/ | 2.50 | 226 | 72 | 22.01 | 2.45 |
| | 15.0% PBS FZ71 | | | | | |
| 16 | 85% PLA 3052D/ | 2.50 | 226 | 72 | 25.57 | 2.52 |
| | 15.0% PBS FZ71 | | | | | |
| 16 | Average | 2.50 | 226 | 72 | 23.79 | 2.49 |
| 17 | 95.3% PLA | UOY | 659 | 72 | 154.93 | 1.21 |
| | 3052D/4.7% PBS | | | | | |
| | FD92 | | | | | |
| 17 | 95.3% PLA | UOY | 659 | 72 | 167.27 | 1.25 |
| | 3052D/4.7% PBS | | | | | |
| | FD92 | | | | | |
| 17 | Average | UOY | 659 | 72 | 161.10 | 1.23 |
| 18 | 95.3% PLA | 2.80 | 222 | 72 | 19.76 | 2.39 |
| | 3052D/4.7% PBS | | | | | |
| | FD92 | | | | | |
| 18 | 95.3% PLA | 2.80 | 222 | 72 | 19.78 | 2.23 |
| | 3052D/4.7% PBS | | | | | |
| | FD92 | | | | | |
| 18 | Average | 2.80 | 222 | 72 | 19.77 | 2.31 |
| 19 | 100% PLA 3052D | UOY | 632 | 72 | 207.30 | 0.87 |
| 19 | 100% PLA 3052D | UOY | 632 | 72 | 229.15 | 1.12 |
| 19 | 100% PLA 3052D | UOY | 632 | 72 | 223.55 | 1.06 |
| 19 | 100% PLA 3052D | UOY | 632 | 72 | 4.77 | 0.83 |
| 19 | 100% PLA 3052D | UOY | 632 | 72 | 2.68 | 0.67 |
| 19 | 100% PLA 3052D | UOY | 632 | 72 | 3.37 | 0.76 |
| 19 | Average | UOY | 632 | 72 | 111.80 | 0.89 |
| 20 | 100% PLA 3052D | 3.00 | 230 | 72 | 29.84 | 3.12 |
| 20 | 100% PLA 3052D | 3.00 | 230 | 72 | 28.97 | 3.05 |
| 20 | 100% PLA 3052D | 3.00 | 230 | 72 | 28.97 | 3.01 |
| 20 | 100% PLA 3052D | 3.00 | 230 | 72 | 28.75 | 2.99 |
| 20 | Average | 3.00 | 230 | 72 | 29.13 | 3.04 |
| 21 | 100% PLA 3052D | 3.87 | 230 | 72 | 20.26 | 2.49 |
| 21 | 100% PLA 3052D | 3.87 | 230 | 72 | 22.58 | 2.43 |
| 21 | 100% PLA 3052D | 3.87 | 230 | 72 | 19.13 | 2.62 |
| 21 | 100% PLA 3052D | 3.87 | 230 | 72 | 22.52 | 2.67 |
| 21 | Average | 3.87 | 230 | 72 | 21.12 | 2.55 |
| 22 | 85% PLA 3052D/ | UOY | 663 | 72 | 119.16 | 1.18 |
| | 15.0% PBS FD92 | | | | | |
| 22 | 85% PLA 3052D/ | UOY | 663 | 72 | 113.01 | 1.18 |
| | 15.0% PBS FD92 | | | | | |
| 22 | Average | UOY | 663 | 72 | 116.09 | 1.18 |
| 23 | 85% PLA 3052D/ | 1.90 | 228 | 72 | 21.05 | 2.93 |
| | 15.0% PBS FD92 | | | | | |
| 23 | 85% PLA 3052D/ | 1.90 | 228 | 72 | 18.50 | 3.05 |
| | 15.0% PBS FD92 | | | | | |
| 23 | Average | 1.90 | 228 | 72 | 19.78 | 2.99 |
| 24 | 95.3% PLA | UOY | 676 | 72 | 186.17 | 1.14 |
| | 3052D/4.7% PBS | | | | | |
| | FZ91 | | | | | |
| 24 | 95.3% PLA | UOY | 676 | 72 | 179.93 | 1.15 |
| | 3052D/4.7% PBS | | | | | |
| | FZ91 | | | | | |
| 24 | Average | UOY | 676 | 72 | 183.05 | 1.15 |
| 25 | 95.3% PLA | 3.00 | 230 | 72 | 21.11 | 2.42 |
| | 3052D/4.7% PBS | | | | | |
| | FZ91 | | | | | |
| 25 | 95.3% PLA | 3.00 | 230 | 72 | 14.67 | 2.36 |
| | 3052D/4.7% PBS | | | | | |
| | FZ91 | | | | | |
| 25 | 95.3% PLA | 3.00 | 230 | 72 | 20.13 | 2.38 |
| | 3052D/4.7% PBS | | | | | |
| | FZ91 | | | | | |
| 25 | Average | 3.00 | 230 | 72 | 18.64 | 2.39 |
| 26 | 95.3% PLA | 3.25 | 230 | 72 | 16.98 | 2.14 |
| | 3052D/4.7% PBS | | | | | |
| | FZ91 | | | | | |
| 26 | 95.3% PLA | 3.25 | 230 | 72 | 16.19 | 1.80 |
| | 3052D/4.7% PBS | | | | | |
| | FZ91 | | | | | |
| 26 | Average | 3.25 | 230 | 72 | 16.59 | 1.97 |
| 27 | 85% PLA 3052D/ | UOY | 682 | 72 | 122.28 | 1.03 |
| | 15.0% PBS FZ91 | | | | | |
| 27 | 85% PLA 3052D/ | UOY | 682 | 72 | 123.55 | 1.18 |
| | 15.0% PBS FZ91 | | | | | |
| 27 | Average | UOY | 682 | 72 | 122.92 | 1.11 |
| 28 | 85% PLA 3052D/ | 2.00 | 227 | 72 | 21.20 | 3.08 |
| | 15.0% PBS FZ91 | | | | | |
| 28 | 85% PLA 3052D/ | 2.00 | 227 | 72 | 20.20 | 2.87 |
| | 15.0% PBS FZ91 | | | | | |
| 28 | Average | 2.00 | 227 | 72 | 20.70 | 2.98 |
| 29 | 86.8% PLA | UOY | 660 | 72 | 136.04 | 0.99 |
| | 3052D/ | | | | | |
| | 8.25% PBS FD92/ | | | | | |
| | 4.95% Hytrel 3078 | | | | | |
| 29 | 86.8% PLA | UOY | 660 | 72 | 134.62 | 1.04 |
| | 3052D/ | | | | | |
| | 8.25% PBS FD92/ | | | | | |
| | 4.95% Hytrel 3078 | | | | | |
| 29 | Average | UOY | 660 | 72 | 135.33 | 1.02 |
| 30 | 86.8% PLA | 2.50 | 224 | 72 | 16.35 | 2.55 |
| | 3052D/ | | | | | |
| | 8.25% PBS FD92/ | | | | | |
| | 4.95% Hytrel 3078 | | | | | |
| 30 | 86.8% PLA | 2.50 | 224 | 72 | 18.88 | 2.35 |
| | 3052D/ | | | | | |
| | 8.25% PBS FD92/ | | | | | |
| | 4.95% Hytrel 3078 | | | | | |
| 30 | Average | 2.50 | 224 | 72 | 17.62 | 2.45 |
| 31 | 86.8% PLA | 2.50 | 226 | 72 | 20.83 | 2.45 |
| | 3052D/ | | | | | |
| | 8.25% PBS FD92/ | | | | | |
| | 4.95% Hytrel 3078 | | | | | |
| 31 | 86.8% PLA | 2.50 | 226 | 72 | 19.20 | 2.40 |
| | 3052D/ | | | | | |
| | 8.25% PBS FD92/ | | | | | |
| | 4.95% Hytrel 3078 | | | | | |
| 31 | Average | 2.50 | 226 | 72 | 20.02 | 2.43 |
| 32 | 86.8% PLA | UOY | 640 | 72 | 127.51 | 0.85 |
| | 3052D/8.25% | | | | | |
| | PBS FD92/4.95% | | | | | |
| | Hytrel 3078 | | | | | |
| 32 | 86.8% PLA | UOY | 640 | 72 | 123.73 | 1.03 |
| | 3052D/8.25% | | | | | |
| | PBS FD92/4.95% | | | | | |
| | Hytrel 3078 | | | | | |
| 32 | Average | UOY | 640 | 72 | 125.62 | 0.94 |
| 33 | 86.8% PLA | 2.00 | 226 | 72 | 24.27 | 2.96 |
| | 3052D/8.25% | | | | | |
| | PBS FD92/4.95% | | | | | |
| | PEBAX 2533 | | | | | |
| 33 | 86.8% PLA | 2.00 | 226 | 72 | 19.58 | 3.03 |
| | 3052D/8.25% | | | | | |
| | PBS FD92/4.95% | | | | | |
| | PEBAX 2533 | | | | | |
| 33 | Average | 2.00 | 226 | 72 | 21.93 | 3.00 |

TABLE 5

| Polymer | | | | | | |
|---|---|---|---|---|---|---|
| Blend | | Draw | Denier | Number of | Elongation | Tenacity |
| Yarn | Material | Down | (g/9000 m) | Strands | at Break % | (g/denier) |
| 1 | 95.3% PLA | UOY | 658 | 72 | 216.84 | 1.20 |
| | 3052D/ | | | | | |
| | 4.7% Pebax 2533 | | | | | |
| 1 | 95.3% PLA | UOY | 658 | 72 | 204.63 | 1.17 |
| | 3052D/ | | | | | |
| | 4.7% Pebax 2533 | | | | | |
| 1 | Average | UOY | 658 | 72 | 210.74 | 1.19 |
| 2 | 95.3% PLA | 3.00 | 225 | 72 | 26.74 | 1.68 |
| | 3052D/ | | | | | |
| | 4.7% Pebax 2533 | | | | | |
| 2 | 95.3% PLA | 3.00 | 226 | 72 | 26.20 | 2.41 |
| | 3052D/ | | | | | |
| | 4.7% Pebax 2533 | | | | | |
| 2 | 95.3% PLA | 3.00 | 226 | 72 | 26.48 | 2.58 |
| | 3052D/ | | | | | |
| | 4.7% Pebax 2533 | | | | | |
| 2 | 95.3% PLA | 3.00 | 225 | 72 | 25.09 | 2.85 |
| | 3052D/ | | | | | |
| | 4.7% Pebax 2533 | | | | | |
| 2 | Average | 3.00 | 225.5 | 72 | 26.13 | 2.38 |
| 3 | 90.3% PLA | UOY | 644 | 72 | 150.51 | 0.90 |
| | 3052D/9.7% | | | | | |
| | Pebax 2533 | | | | | |
| 3 | 90.3% PLA | UOY | 644 | 72 | 161.03 | 0.88 |
| | 3052D/9.7% | | | | | |
| | Pebax 2533 | | | | | |
| 3 | Average | UOY | 644 | 72 | 155.77 | 0.89 |
| 4 | 90.3% PLA | 2.00 | 216 | 72 | 27.03 | 1.94 |
| | 3052D/9.7% | | | | | |
| | Pebax 2533 | | | | | |
| 4 | 90.3% PLA | 2.00 | 216 | 72 | 20.35 | 2.28 |
| | 3052D/9.7% | | | | | |
| | Pebax 2533 | | | | | |
| 4 | Average | 2.00 | 216 | 72 | 23.69 | 2.11 |
| 5 | 95.3% PLA | UOY | 676 | 72 | 188.04 | 1.09 |
| | 3052D/4.7% | | | | | |
| | Hytrel 3078 | | | | | |
| 5 | 95.3% PLA | UOY | 676 | 72 | 190.93 | 1.10 |
| | 3052D/4.7% | | | | | |
| | Hytrel 3078 | | | | | |
| 5 | Average | UOY | 676 | 72 | 189.49 | 1.10 |
| 6 | 95.3% PLA | 3.00 | 223 | 72 | 23.54 | 2.36 |
| | 3052D/4.7% | | | | | |
| | Hytrel 3078 | | | | | |
| 6 | 95.3% PLA | 3.00 | 223 | 72 | 24.88 | 2.42 |
| | 3052D/4.7% | | | | | |
| | Hytrel 3078 | | | | | |
| 6 | Average | 3.00 | 223 | 72 | 24.21 | 2.39 |
| 7 | 95.3% PLA | 3.42 | 225 | 72 | 21.78 | 2.49 |
| | 3052D/4.7% | | | | | |
| | Hytrel 3078 | | | | | |
| 7 | 95.3% PLA | 3.42 | 225 | 72 | 21.62 | 2.58 |
| | 3052D/4.7% | | | | | |
| | Hytrel 3078 | | | | | |
| 7 | Average | 3.42 | 225 | 72 | 21.70 | 2.54 |
| 8 | 90.4% PLA | UOY | 649 | 72 | 139.87 | 0.87 |
| | 3052D/9.6% | | | | | |
| | Hytrel 3078 | | | | | |
| 8 | 90.4% PLA | UOY | 649 | 72 | 138.35 | 0.88 |
| | 3052D/9.6% | | | | | |
| | Hytrel 3078 | | | | | |
| 8 | Average | UOY | 649 | 72 | 139.11 | 0.88 |
| 9 | 90.4% PLA | 2.8 | 220 | 72 | 23.67 | 2.64 |
| | 3052D/9.6% | | | | | |
| | Hytrel 3078 | | | | | |
| 9 | 90.4% PLA | 2.8 | 220 | 72 | 18.54 | 2.27 |
| | 3052D/9.6% | | | | | |
| | Hytrel 3078 | | | | | |
| 9 | Average | 2.8 | 220 | 72 | 21.11 | 2.46 |
| 10 | 90.4% PLA | 2.00 | 222 | 72 | 25.90 | 2.71 |
| | 3052D/9.6% | | | | | |
| | Hytrel 3078 | | | | | |
| 10 | 90.4% PLA | 2.00 | 222 | 72 | 31.12 | 2.66 |
| | 3052D/9.6% | | | | | |
| | Hytrel 3078 | | | | | |
| 10 | Average | 2.00 | 222 | 72 | 28.51 | 2.69 |
| 11 | 95% PLA 3052D/ | UOY | 663 | 72 | 192.82 | 1.23 |
| | 5.0% PBS FZ71 | | | | | |
| 11 | 95% PLA 3052D/ | UOY | 663 | 72 | 190.06 | 1.23 |
| | 5.0% PBS FZ71 | | | | | |
| 11 | Average | UOY | 663 | 72 | 191.44 | 1.23 |
| 12 | 95% PLA 3052D/ | UOY | 226 | 72 | 24.01 | 2.31 |
| | 5.0% PBS FZ71 | | | | | |
| 12 | 95% PLA 3052D/ | 3.00 | 226 | 72 | 21.10 | 2.45 |
| | 5.0% PBS FZ71 | | | | | |
| 12 | Average | 3.00 | 226 | 72 | 22.56 | 2.38 |
| 13 | 95% PLA 3052D/ | 3.00 | 225 | 72 | 23.79 | 2.88 |
| | 5.0% PBS FZ71 | | | | | |
| 13 | 95% PLA 3052D/ | 3.25 | 225 | 72 | 23.56 | 2.74 |
| | 5.0% PBS FZ71 | | | | | |
| 13 | Average | 3.25 | 225 | 72 | 23.68 | 2.81 |
| 14 | 85% PLA 3052D/ | 3.25 | 661 | 72 | 136.80 | 0.78 |
| | 15.0% PBS FZ71 | | | | | |
| 14 | 85% PLA 3052D/ | UOY | 661 | 72 | 164.45 | 1.12 |
| | 15.0% PBS FZ71 | | | | | |
| 14 | Average | UOY | 661 | 72 | 150.63 | 0.95 |
| 15 | 85% PLA 3052D/ | UOY | 226 | 72 | 23.54 | 2.28 |
| | 15.0% PBS FZ71 | | | | | |
| 15 | 85% PLA 3052D/ | 2.80 | 226 | 72 | 20.80 | 2.05 |
| | 15.0% PBS FZ71 | | | | | |
| 15 | Average | 2.80 | 226 | 72 | 22.17 | 2.17 |
| 16 | 85% PLA 3052D/ | 2.80 | 226 | 72 | 23.83 | 2.54 |
| | 15.0% PBS FZ71 | | | | | |
| 16 | 85% PLA 3052D/ | 2.50 | 226 | 72 | 25.14 | 2.45 |
| | 15.0% PBS FZ71 | | | | | |
| 16 | Average | 2.50 | 226 | 72 | 24.49 | 2.50 |
| 17 | 95.3% PLA | 2.50 | 659 | 72 | 159.41 | 1.19 |
| | 3052D/4.7% PBS | | | | | |
| | FD92 | | | | | |
| 17 | 95.3% PLA | UOY | 659 | 72 | 161.47 | 1.12 |
| | 3052D/4.7% PBS | | | | | |
| | FD92 | | | | | |
| 17 | Average | UOY | 659 | 72 | 160.44 | 1.16 |
| 18 | 95.3% PLA | UOY | 222 | 72 | 19.27 | 2.33 |
| | 3052D/4.7% PBS | | | | | |
| | FD92 | | | | | |
| 18 | 95.3% PLA | 2.80 | 222 | 72 | 20.40 | 2.31 |
| | 3052D/4.7% PBS | | | | | |
| | FD92 | | | | | |
| 18 | Average | 2.80 | 222 | 72 | 19.84 | 2.32 |
| 19 | 100% PLA 3052D | 2.80 | 632 | 72 | 3.57 | 0.78 |
| 19 | 100% PLA 3052D | UOY | 632 | 72 | 3.57 | 0.79 |
| 19 | Average | UOY | 632 | 72 | 3.57 | 0.79 |
| 20 | 100% PLA 3052D | UOY | 230 | 72 | 29.65 | 2.79 |
| 20 | 100% PLA 3052D | 3.00 | 230 | 72 | 28.09 | 2.91 |
| 20 | Average | 3.00 | 230 | 72 | 28.87 | 2.85 |
| 21 | 100% PLA 3052D | 3.00 | 230 | 72 | 22.37 | 2.80 |
| 21 | 100% PLA 3052D | 3.87 | 230 | 72 | 21.39 | 2.63 |
| 21 | Average | 3.87 | 230 | 72 | 21.88 | 2.72 |
| 22 | 85% PLA 3052D/ | 3.87 | 663 | 72 | 117.27 | 1.26 |
| | 15.0% PBS FD92 | | | | | |
| 22 | 85% PLA 3052D/ | UOY | 663 | 72 | 118.18 | 1.27 |
| | 15.0% PBS FD92 | | | | | |
| 22 | Average | UOY | 663 | 72 | 117.73 | 1.27 |
| 23 | 85% PLA 3052D/ | UOY | 228 | 72 | 19.93 | 3.32 |
| | 15.0% PBS FD92 | | | | | |
| 23 | 85% PLA 3052D/ | 1.90 | 228 | 72 | 19.36 | 3.12 |
| | 15.0% PBS FD92 | | | | | |
| 23 | Average | 1.90 | 228 | 72 | 19.65 | 3.22 |
| 24 | 95.3% PLA | 1.90 | 676 | 72 | 180.47 | 1.29 |
| | 3052D/4.7% PBS | | | | | |
| | FZ91 | | | | | |
| 24 | 95.3% PLA | UOY | 676 | 72 | 176.50 | 1.28 |
| | 3052D/4.7% PBS | | | | | |
| | FZ91 | | | | | |
| 24 | Average | UOY | 676 | 72 | 178.49 | 1.29 |
| 25 | 95.3% PLA | UOY | 230 | 72 | 20.71 | 2.78 |
| | 3052D/4.7% PBS | | | | | |
| | FZ91 | | | | | |
| 25 | 95.3% PLA | 3.00 | 230 | 72 | 18.37 | 2.37 |
| | 3052D/4.7% PBS | | | | | |
| | FZ91 | | | | | |
| 25 | Average | 3.00 | 230 | 72 | 19.54 | 2.58 |
| 26 | 95.3% PLA | 3.00 | 230 | 72 | 20.18 | 2.16 |
| | 3052D/4.7% PBS | | | | | |
| | FZ91 | | | | | |
| 26 | 95.3% PLA | 3.25 | 230 | 72 | 18.62 | 2.33 |
| | 3052D/4.7% PBS | | | | | |
| | FZ91 | | | | | |
| 26 | Average | 3.25 | 230 | 72 | 19.40 | 2.25 |
| 27 | 85% PLA 3052D/ | UOY | 682 | 72 | 117.35 | 1.16 |
| | 15.0% PBS FZ91 | | | | | |
| 27 | Average | UOY | 682 | 72 | 117.35 | 1.16 |
| 28 | 85% PLA 3052D/ | 2.00 | 227 | 72 | 20.60 | 3.26 |
| | 15.0% PBS FZ91 | | | | | |
| 28 | 85% PLA 3052D/ | 2.00 | 227 | 72 | 19.64 | 3.00 |
| | 15.0% PBS FZ91 | | | | | |
| 28 | Average | 2.00 | 227 | 72 | 20.12 | 3.13 |
| 29 | 86.8% PLA | UOY | 660 | 72 | 142.80 | 1.08 |
| | 3052D/ | | | | | |
| | 8.25% PBS FD92/ | | | | | |
| | 4.95% Hytrel 3078 | | | | | |
| 29 | 86.8% PLA | UOY | 660 | 72 | 148.17 | 1.10 |
| | 3052D/ | | | | | |
| | 8.25% PBS FD92/ | | | | | |
| | 4.95% Hytrel 3078 | | | | | |
| 29 | Average | UOY | 660 | 72 | 145.49 | 1.09 |
| 30 | 86.8% PLA | 2.50 | 224 | 72 | 24.10 | 3.10 |
| | 3052D/ | | | | | |
| | 8.25% PBS FD92/ | | | | | |
| | 4.95% Hytrel 3078 | | | | | |
| 30 | 86.8% PLA | 2.50 | 224 | 72 | 19.08 | 2.68 |
| | 3052D/ | | | | | |
| | 8.25% PBS FD92/ | | | | | |
| | 4.95% Hytrel 3078 | | | | | |
| 30 | 86.8% PLA | 2.50 | 224 | 72 | 19.27 | 2.63 |
| | 3052D/ | | | | | |
| | 8.25% PBS FD92/ | | | | | |
| | 4.95% Hytrel 3078 | | | | | |
| 30 | Average | 2.50 | 224 | 72 | 20.82 | 2.80 |
| 31 | 86.8% PLA | 2.50 | 226 | 72 | 21.20 | 2.74 |
| | 3052D/ | | | | | |
| | 8.25% PBS FD92/ | | | | | |
| | 4.95% Hytrel 3078 | | | | | |
| 31 | 86.8% PLA | 2.50 | 226 | 72 | 19.97 | 2.65 |
| | 3052D/ | | | | | |
| | 8.25% PBS FD92/ | | | | | |
| | 4.95% Hytrel 3078 | | | | | |
| 31 | 86.8% PLA | 2.50 | 226 | 72 | 21.92 | 2.67 |
| | 3052D/ | | | | | |
| | 8.25% PBS FD92/ | | | | | |
| | 4.95% Hytrel 3078 | | | | | |
| 31 | 86.8% PLA | 2.50 | 226 | 72 | 21.84 | 2.41 |
| | 3052D/ | | | | | |
| | 8.25% PBS FD92/ | | | | | |
| | 4.95% Hytrel 3078 | | | | | |
| 31 | Average | 2.50 | 226 | 72 | 21.23 | 2.62 |
| 32 | 86.8% PLA | UOY | 640 | 72 | 122.12 | 1.09 |
| | 3052D/8.25% | | | | | |
| | PBS FD92/4.95% | | | | | |
| | Hytrel 3078 | | | | | |
| 32 | 86.8% PLA | UOY | 640 | 72 | 134.87 | 1.15 |
| | 3052D/8.25% | | | | | |
| | PBS FD92/4.95% | | | | | |
| | Hytrel 3078 | | | | | |
| 32 | Average | UOY | 640 | 72 | 128.50 | 1.12 |
| 33 | 86.8% PLA | 2.00 | 226 | 72 | 28.29 | 2.96 |
| | 3052D/8.25% | | | | | |
| | PBS FD92/4.95% | | | | | |
| | PEBAX 2533 | | | | | |
| 33 | Average | 2.00 | 226 | 72 | 28.29 | 2.96 |

TABLE 6

| Polymer | | | | | | | |
|---|---|---|---|---|---|---|---|
| Blend | | | Draw | Denier | Number of | Elongation | Tenacity |
| Yarn | Run # | Material | Down | (g/9000 m) | Strands | at Break % | (g/denier) |
| 1 | 1 | 95.3% PLA | UOY | 658 | 72 | 228.0 | 1.21 |
| | | 3052D/ | | | | | |
| | | 4.7% Pebax 2533 | | | | | |
| 1 | 2 | 95.3% PLA | UOY | 658 | 72 | 213.92 | 1.11 |
| | | 3052D/ | | | | | |
| | | 4.7% Pebax 2533 | | | | | |
| 1 | 3 | 95.3% PLA | UOY | 658 | 72 | 210.74 | 1.19 |
| | | 3052D/ | | | | | |
| | | 4.7% Pebax 2533 | | | | | |
| 2 | 1 | 95.3% PLA | 3.00 | 225 | 72 | 21.3 | 2.80 |
| | | 3052D/ | | | | | |
| | | 4.7% Pebax 2533 | | | | | |
| 2 | 2 | 95.3% PLA | 3.00 | 225 | 72 | 26.17 | 2.59 |
| | | 3052D/ | | | | | |
| | | 4.7% Pebax 2533 | | | | | |
| 2 | 3 | 95.3% PLA | 3.00 | 225.5 | 72 | 26.13 | 2.38 |
| | | 3052D/ | | | | | |
| | | 4.7% Pebax 2533 | | | | | |
| 3 | 1 | 90.3% PLA | UOY | 644 | 72 | 167.0 | 1.13 |
| | | 3052D/9.7% | | | | | |
| | | Pebax 2533 | | | | | |
| 3 | 2 | 90.3% PLA | UOY | 644 | 72 | 160.64 | 0.81 |
| | | 3052D/9.7% | | | | | |
| | | Pebax 2533 | | | | | |
| 3 | 3 | 90.3% PLA | UOY | 644 | 72 | 155.77 | 0.89 |
| | | 3052D/9.7% | | | | | |
| | | Pebax 2533 | | | | | |
| 4 | 1 | 90.3% PLA | 2.00 | 216 | 72 | 17.0 | 2.30 |
| | | 3052D/9.7% | | | | | |
| | | Pebax 2533 | | | | | |
| 4 | 2 | 90.3% PLA | 2.00 | 216 | 72 | 23.79 | 2.21 |
| | | 3052D/9.7% | | | | | |
| | | Pebax 2533 | | | | | |
| 4 | 3 | 90.3% PLA | 2.00 | 216 | 72 | 23.69 | 2.11 |
| | | 3052D/9.7% | | | | | |
| | | Pebax 2533 | | | | | |
| 5 | 1 | 95.3% PLA | UOY | 676 | 72 | 196.0 | 1.25 |
| | | 3052D/4.7% | | | | | |
| | | Hytrel 3078 | | | | | |
| 5 | 2 | 95.3% PLA | UOY | 676 | 72 | 189.35 | 1.10 |
| | | 3052D/4.7% | | | | | |
| | | Hytrel 3078 | | | | | |
| 5 | 3 | 95.3% PLA | UOY | 676 | 72 | 189.49 | 1.10 |
| | | 3052D/4.7% | | | | | |
| | | Hytrel 3078 | | | | | |
| 6 | 1 | 95.3% PLA | 3.00 | 223 | 72 | 20.0 | 2.80 |
| | | 3052D/4.7% | | | | | |
| | | Hytrel 3078 | | | | | |
| 6 | 2 | 95.3% PLA | 3.00 | 223 | 72 | 23.25 | 2.31 |
| | | 3052D/4.7% | | | | | |
| | | Hytrel 3078 | | | | | |
| 6 | 3 | 95.3% PLA | 3.00 | 223 | 72 | 24.21 | 2.39 |
| | | 3052D/4.7% | | | | | |
| | | Hytrel 3078 | | | | | |
| 7 | 1 | 95.3% PLA | 3.42 | 225 | 72 | 18.0 | 2.93 |
| | | 3052D/4.7% | | | | | |
| | | Hytrel 3078 | | | | | |
| 7 | 2 | 95.3% PLA | 3.42 | 225 | 72 | 21.22 | 2.33 |
| | | 3052D/4.7% | | | | | |
| | | Hytrel 3078 | | | | | |
| 7 | 3 | 95.3% PLA | 3.42 | 225 | 72 | 21.70 | 2.54 |
| | | 3052D/4.7% | | | | | |
| | | Hytrel 3078 | | | | | |
| 8 | 1 | 90.4% PLA | UOY | 649 | 72 | 185.0 | 1.25 |
| | | 3052D/9.6% | | | | | |
| | | Hytrel 3078 | | | | | |
| 8 | 2 | 90.4% PLA | UOY | 649 | 72 | 151.16 | 0.84 |
| | | 3052D/9.6% | | | | | |
| | | Hytrel 3078 | | | | | |
| 8 | 3 | 90.4% PLA | UOY | 649 | 72 | 139.11 | 0.88 |
| | | 3052D/9.6% | | | | | |
| | | Hytrel 3078 | | | | | |
| 9 | 1 | 90.4% PLA | 2.8 | 220 | 72 | 14.0 | 2.18 |
| | | 3052D/9.6% | | | | | |
| | | Hytrel 3078 | | | | | |
| 9 | 2 | 90.4% PLA | 2.8 | 220 | 72 | 24.93 | 2.41 |
| | | 3052D/9.6% | | | | | |
| | | Hytrel 3078 | | | | | |
| 9 | 3 | 90.4% PLA | 2.8 | 220 | 72 | 21.11 | 2.46 |
| | | 3052D/9.6% | | | | | |
| | | Hytrel 3078 | | | | | |
| 10 | 1 | 90.4% PLA | 2.00 | 222 | 72 | 24.0 | 2.47 |
| | | 3052D/9.6% | | | | | |
| | | Hytrel 3078 | | | | | |
| 10 | 2 | 90.4% PLA | 2.00 | 222 | 72 | 28.06 | 2.54 |
| | | 3052D/9.6% | | | | | |
| | | Hytrel 3078 | | | | | |
| 10 | 3 | 90.4% PLA | 2.00 | 222 | 72 | 28.51 | 2.69 |
| | | 3052D/9.6% | | | | | |
| | | Hytrel 3078 | | | | | |
| 11 | 1 | 95% PLA | UOY | 663 | 72 | 206.0 | 1.35 |
| | | 3052D/ | | | | | |
| | | 5.0% PBS FZ71 | | | | | |
| 11 | 2 | 95% PLA | UOY | 663 | 72 | 185.47 | 1.19 |
| | | 3052D/ | | | | | |
| | | 5.0% PBS FZ71 | | | | | |
| 11 | 3 | 95% PLA | UOY | 663 | 72 | 191.44 | 1.23 |
| | | 3052D/ | | | | | |
| | | 5.0% PBS FZ71 | | | | | |
| 12 | 1 | 95% PLA | 3.00 | 226 | 72 | 15.0 | 2.60 |
| | | 3052D/ | | | | | |
| | | 5.0% PBS FZ71 | | | | | |
| 12 | 2 | 95% PLA | 3.00 | 226 | 72 | 21.33 | 2.35 |
| | | 3052D/ | | | | | |
| | | 5.0% PBS FZ71 | | | | | |
| 12 | 3 | 95% PLA | 3.00 | 226 | 72 | 22.56 | 2.38 |
| | | 3052D/ | | | | | |
| | | 5.0% PBS FZ71 | | | | | |
| 13 | 1 | 95% PLA | 3.25 | 225 | 72 | 16.3 | 2.80 |
| | | 3052D/ | | | | | |
| | | 5.0% PBS FZ71 | | | | | |
| 13 | 2 | 95% PLA | 3.25 | 225 | 72 | 20.84 | 2.06 |
| | | 3052D/ | | | | | |
| | | 5.0% PBS FZ71 | | | | | |
| 13 | 3 | 95% PLA | 3.25 | 225 | 72 | 23.68 | 2.81 |
| | | 3052D/ | | | | | |
| | | 5.0% PBS FZ71 | | | | | |
| 14 | 1 | 85% PLA | UOY | 661 | 72 | 231.0 | 1.23 |
| | | 3052D/15.0% | | | | | |
| | | PBS FZ71 | | | | | |
| 14 | 2 | 85% PLA | UOY | 661 | 72 | 162.88 | 0.93 |
| | | 3052D/15.0% | | | | | |
| | | PBS FZ71 | | | | | |
| 14 | 3 | 85% PLA | UOY | 661 | 72 | 150.63 | 0.95 |
| | | 3052D/15.0% | | | | | |
| | | PBS FZ71 | | | | | |
| 15 | 1 | 85% PLA | 2.80 | 226 | 72 | 18.2 | 2.74 |
| | | 3052D/15.0% | | | | | |
| | | PBS FZ71 | | | | | |
| 15 | 2 | 85% PLA | 2.80 | 226 | 72 | 24.05 | 2.32 |
| | | 3052D/15.0% | | | | | |
| | | PBS FZ71 | | | | | |
| 15 | 3 | 85% PLA | 2.80 | 226 | 72 | 22.17 | 2.17 |
| | | 3052D/15.0% | | | | | |
| | | PBS FZ71 | | | | | |
| 16 | 1 | 85% PLA | 2.50 | 226 | 72 | 17.9 | 2.56 |
| | | 3052D/15.0% | | | | | |
| | | PBS FZ71 | | | | | |
| 16 | 2 | 85% PLA | 2.50 | 226 | 72 | 23.79 | 2.49 |
| | | 3052D/15.0% | | | | | |
| | | PBS FZ71 | | | | | |
| 16 | 3 | 85% PLA | 2.50 | 226 | 72 | 24.49 | 2.50 |
| | | 3052D/15.0% | | | | | |
| | | PBS FZ71 | | | | | |
| 17 | 1 | 95.3% PLA | UOY | 659 | 72 | 169.0 | 1.24 |
| | | 3052D/4.7% | | | | | |
| | | PBS FD92 | | | | | |
| 17 | 2 | 95.3% PLA | UOY | 659 | 72 | 161.10 | 1.23 |
| | | 3052D/4.7% | | | | | |
| | | PBS FD92 | | | | | |
| 17 | 3 | 95.3% PLA | UOY | 659 | 72 | 160.44 | 1.16 |
| | | 3052D/4.7% | | | | | |
| | | PBS FD92 | | | | | |
| 18 | 1 | 95.3% PLA | 2.80 | 222 | 72 | 16.9 | 2.92 |
| | | 3052D/4.7% | | | | | |
| | | PBS FD92 | | | | | |
| 18 | 2 | 95.3% PLA | 2.80 | 222 | 72 | 19.77 | 2.31 |
| | | 3052D/4.7% | | | | | |
| | | PBS FD92 | | | | | |
| 18 | 3 | 95.3% PLA | 2.80 | 222 | 72 | 19.84 | 2.32 |
| | | 3052D/4.7% | | | | | |
| | | PBS FD92 | | | | | |
| 19 | 1 | 100% PLA | UOY | 632 | 72 | 249.0 | 1.18 |
| | | 3052D | | | | | |
| 19 | 2 | 100% PLA | UOY | 632 | 72 | 111.80 | 0.89 |
| | | 3052D | | | | | |
| 19 | 3 | 100% PLA | UOY | 632 | 72 | 3.57 | 0.79 |
| | | 3052D | | | | | |
| 20 | 1 | 100% PLA | 3.00 | 230 | 72 | 26.8 | 3.21 |
| | | 3052D | | | | | |
| 20 | 2 | 100% PLA | 3.00 | 230 | 72 | 29.13 | 3.04 |
| | | 3052D | | | | | |
| 20 | 3 | 100% PLA | 3.00 | 230 | 72 | 28.87 | 2.85 |
| | | 3052D | | | | | |
| 21 | 1 | 100% PLA | 3.87 | 230 | 72 | 20.0 | 3.04 |
| | | 3052D | | | | | |
| 21 | 2 | 100% PLA | 3.87 | 230 | 72 | 21.12 | 2.55 |
| | | 3052D | | | | | |
| 21 | 3 | 100% PLA | 3.87 | 230 | 72 | 21.88 | 2.72 |
| | | 3052D | | | | | |
| 22 | 1 | 85% PLA | UOY | 663 | 72 | 118.0 | 1.34 |
| | | 3052D/15.0% | | | | | |
| | | PBS FD92 | | | | | |
| 22 | 2 | 85% PLA | UOY | 663 | 72 | 116.09 | 1.18 |
| | | 3052D/15.0% | | | | | |
| | | PBS FD92 | | | | | |
| 22 | 3 | 85% PLA | UOY | 663 | 72 | 117.73 | 1.27 |
| | | 3052D/15.0% | | | | | |
| | | PBS FD92 | | | | | |
| 23 | 1 | 85% PLA | 1.90 | 228 | 72 | 18.5 | 3.37 |
| | | 3052D/15.0% | | | | | |
| | | PBS FD92 | | | | | |
| 23 | 2 | 85% PLA | 1.90 | 228 | 72 | 19.78 | 2.99 |
| | | 3052D/15.0% | | | | | |
| | | PBS FD92 | | | | | |
| 23 | 3 | 85% PLA | 1.90 | 228 | 72 | 19.65 | 3.22 |
| | | 3052D/15.0% | | | | | |
| | | PBS FD92 | | | | | |
| 24 | 1 | 95.3% PLA | UOY | 676 | 72 | 212.0 | 1.36 |
| | | 3052D/4.7% | | | | | |
| | | PBS FZ91 | | | | | |
| 24 | 2 | 95.3% PLA | UOY | 676 | 72 | 183.05 | 1.15 |
| | | 3052D/4.7% | | | | | |
| | | PBS FZ91 | | | | | |
| 24 | 3 | 95.3% PLA | UOY | 676 | 72 | 178.49 | 1.29 |
| | | 3052D/4.7% | | | | | |
| | | PBS FZ91 | | | | | |
| 25 | 1 | 95.3% PLA | 3.00 | 230 | 72 | 17.0 | 2.96 |
| | | 3052D/4.7% | | | | | |
| | | PBS FZ91 | | | | | |
| 25 | 2 | 95.3% PLA | 3.00 | 230 | 72 | 18.64 | 2.39 |
| | | 3052D/4.7% | | | | | |
| | | PBS FZ91 | | | | | |
| 25 | 3 | 95.3% PLA | 3.00 | 230 | 72 | 19.54 | 2.58 |
| | | 3052D/4.7% | | | | | |
| | | PBS FZ91 | | | | | |
| 26 | 1 | 95.3% PLA | 3.25 | 230 | 72 | 16.0 | 3.00 |
| | | 3052D/4.7% | | | | | |
| | | PBS FZ91 | | | | | |
| 26 | 2 | 95.3% PLA | 3.25 | 230 | 72 | 16.59 | 1.97 |
| | | 3052D/4.7% | | | | | |
| | | PBS FZ91 | | | | | |
| 26 | 3 | 95.3% PLA | 3.25 | 230 | 72 | 19.40 | 2.25 |
| | | 3052D/4.7% | | | | | |
| | | PBS FZ91 | | | | | |
| 27 | 1 | 85% PLA | UOY | 682 | 72 | 125.0 | 1.39 |
| | | 3052D/15.0% | | | | | |
| | | PBS FZ91 | | | | | |
| 27 | 2 | 85% PLA | UOY | 682 | 72 | 122.92 | 1.11 |
| | | 3052D/15.0% | | | | | |
| | | PBS FZ91 | | | | | |
| 27 | 3 | 85% PLA | UOY | 682 | 72 | 117.35 | 1.16 |
| | | 3052D/15.0% | | | | | |
| | | PBS FZ91 | | | | | |
| 28 | 1 | 85% PLA | 2.00 | 227 | 72 | 22.0 | 3.04 |
| | | 3052D/15.0% | | | | | |
| | | PBS FZ91 | | | | | |
| 28 | 2 | 85% PLA | 2.00 | 227 | 72 | 20.70 | 2.98 |
| | | 3052D/15.0% | | | | | |
| | | PBS FZ91 | | | | | |
| 28 | 3 | 85% PLA | 2.00 | 227 | 72 | 20.12 | 3.13 |
| | | 3052D/15.0% | | | | | |
| | | PBS FZ91 | | | | | |
| 29 | 1 | 86.8% PLA | UOY | 660 | 72 | 149 | 1.13 |
| | | 3052D/ | | | | | |
| | | 8.25% PBS | | | | | |
| | | FD92/4.95% | | | | | |
| | | Hytrel 3078 | | | | | |
| 29 | 2 | 86.8% PLA | UOY | 660 | 72 | 135.33 | 1.02 |
| | | 3052D/ | | | | | |
| | | 8.25% PBS | | | | | |
| | | FD92/4.95% | | | | | |
| | | Hytrel 3078 | | | | | |
| 29 | 3 | 86.8% PLA | UOY | 660 | 72 | 145.49 | 1.09 |
| | | 3052D/ | | | | | |
| | | 8.25% PBS | | | | | |
| | | FD92/4.95% | | | | | |
| | | Hytrel 3078 | | | | | |
| 30 | 1 | 86.8% PLA | 2.50 | 224 | 72 | 13.3 | 2.32 |
| | | 3052D/ | | | | | |
| | | 8.25% PBS | | | | | |
| | | FD92/4.95% | | | | | |
| | | Hytrel 3078 | | | | | |
| 30 | 2 | 86.8% PLA | 2.50 | 224 | 72 | 17.62 | 2.45 |
| | | 3052D/ | | | | | |
| | | 8.25% PBS | | | | | |
| | | FD92/4.95% | | | | | |
| | | Hytrel 3078 | | | | | |
| 30 | 3 | 86.8% PLA | 2.50 | 224 | 72 | 20.82 | 2.80 |
| | | 3052D/ | | | | | |
| | | 8.25% PBS | | | | | |
| | | FD92/4.95% | | | | | |
| | | Hytrel 3078 | | | | | |
| 31 | 1 | 86.8% PLA | 2.50 | 226 | 72 | 16.6 | 2.65 |
| | | 3052D/ | | | | | |
| | | 8.25% PBS | | | | | |
| | | FD92/4.95% | | | | | |
| | | Hytrel 3078 | | | | | |
| 31 | 2 | 86.8% PLA | 2.50 | 226 | 72 | 20.02 | 2.43 |
| | | 3052D/ | | | | | |
| | | 8.25% PBS | | | | | |
| | | FD92/4.95% | | | | | |
| | | Hytrel 3078 | | | | | |
| 31 | 3 | 86.8% PLA | 2.50 | 226 | 72 | 21.23 | 2.62 |
| | | 3052D/ | | | | | |
| | | 8.25% PBS | | | | | |
| | | FD92/4.95% | | | | | |
| | | Hytrel 3078 | | | | | |
| 32 | 1 | 86.8% PLA | UOY | 640 | 72 | 200.0 | 1.10 |
| | | 3052D/8.25% | | | | | |
| | | PBS FD92/ | | | | | |
| | | 4.95% Hytrel | | | | | |
| | | 3078 | | | | | |
| 32 | 2 | 86.8% PLA | UOY | 640 | 72 | 125.62 | 0.94 |
| | | 3052D/8.25% | | | | | |
| | | PBS FD92/ | | | | | |
| | | 4.95% Hytrel | | | | | |
| | | 3078 | | | | | |
| 32 | 3 | 86.8% PLA | UOY | 640 | 72 | 128.50 | 1.12 |
| | | 3052D/8.25% | | | | | |
| | | PBS FD92/ | | | | | |
| | | 4.95% Hytrel | | | | | |
| | | 3078 | | | | | |
| 33 | 1 | 86.8% PLA | 2.00 | 226 | 72 | 20.0 | 3.14 |
| | | 3052D/8.25% | | | | | |
| | | PBS FD92/ | | | | | |
| | | 4.95% PEBAX | | | | | |
| | | 2533 | | | | | |
| 33 | 2 | 86.8% PLA | 2.00 | 226 | 72 | 21.93 | 3.00 |
| | | 3052D/8.25% | | | | | |
| | | PBS FD92/ | | | | | |
| | | 4.95% PEBAX | | | | | |
| | | 2533 | | | | | |
| 33 | 3 | 86.8% PLA | 2.00 | 226 | 72 | 28.29 | 2.96 |
| | | 3052D/8.25% | | | | | |
| | | PBS FD92/ | | | | | |
| | | 4.95% PEBAX | | | | | |
| | | 2533 | | | | | |

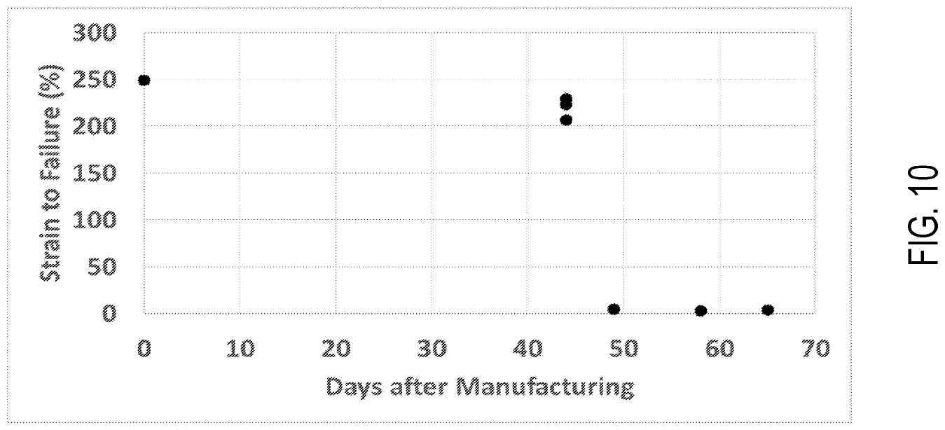

As shown in Table 6, the PLA polymeric blends generally exhibited small decreases in flexibility and strength over time, as demonstrated by elongation at break and tenacity, respectively. However, Polymer Blend Yarn 19, which is 100% un-oriented PLA, demonstrated a severe decrease in both flexibility and strength over time. The elongation at break decreased from 249.0 (Run 1) to 111.80 (Run 2) after about 40 days, and decreased to 3.57 (Run 3) by around 60 days. The tenacity decreased from 1.18 (Run 1) to 0.89 (Run 2) after about 40 days, and decreased to 0.79 (Run 3) by around 60 days. These results show the superiority of the PLA polymeric blends in maintaining strength and flexibility over time. FIG. 10 depicts the decrease in elongation at break, measured by ASTM D2256-10, of samples of Polymer Blend Yarn 19 over time and demonstrates how yarn made of 100% PLA 3052D has decreased ductility and increased brittleness over time, as compared to the blends described in Table 6. Such characteristics of the PLA homo-polymer have been reported by Ghazaryan et al., Rejuvenation of PLLA: Effect of Plastic Deformation and Orientation on Physical Aging in Poly(L-Lactic Acid) Films, Journal of Polymer Science, Part B: Polymer Physics 54: 2233-2244 (2016). The embrittlement observed for the homo-polymer of un-oriented PLA 3052D is the result of physical aging of the amorphous phase in this polymer. The time scale for this aging in this yarn is longer than the time scale reported in the paper because of the small size (˜10 μm diameter) of the fibers in this yarn.

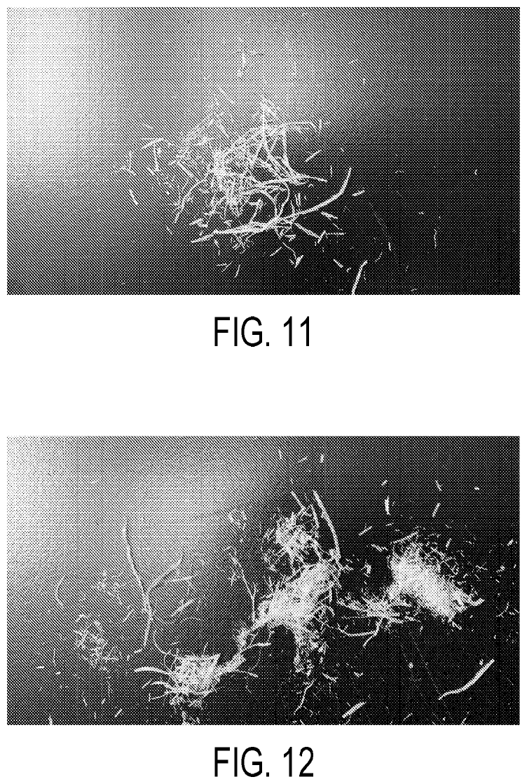

FIGS. 11 and 12 each depict a Polymer Blend Yarn that has been degraded at temperature and humidity conditions that simulate 6-12 months of ambient conditions. FIG. 11 depicts yarn composed of 95.3% PLA 3052D+4.7% Hytrel® 3078 after 35 days at 120° F./95% RH and then 14 days at 140° F./95% RH. FIG. 12 depicts yarn composed of 95.0% PLA 3052D+5.0% PBS FZ71 after 35 days at 120° F./95% RH and then 14 days at 140° F./95% RH. FIGS. 11 and 12 demonstrate that these polymer blend yarns are heavily degraded under these conditions, which are equivalent to approximately 6 to 12 months under ambient conditions.

### Knit Fabric Tests

Polymer Blend Yarns 2, 4-6, 8, 10, 16, 23, 30 and 33 were used for knit fabric testing. These yarns are made of PLA 3052D with Hytrel® 3078, PEBAX 2533, BioPBS FZ91, BioPBS FD92, or BioPBS FZ71. The percentage of the additive (wt. %) varied from about 4% to about 15%, with some blends being bi-component and others being tri-component blends, as described above. These Polymer Blend Yarns were extruded into yarn as described above for the Yarn Tests.

Each yarn of Polymer Blend Yarns 2, 4-6, 8, 10, 16, 23, 30 and 33 was wound onto a bobbin to create a yarn doff, as described above. For certain blends, a yarn doff of oriented yarn and a yarn doff of un-oriented yarn were knitted. Each doff was knitted on a Lawson-Hemphill Circular Sock Knitter (Model FAK, 220 Head, 54 Gauge) to create sock-like knitted fabric for evaluation. Table 7 provides a summary of the results. Each Polymer Blend Yarn was knitted into a sock-like fabric about 40 days after the yarn was drawn, at the same time it was tested in Run 2, above, for the Yarn Tests. Thus, the results for denier, tenacity, and elongation at break reported below in Table 7 are the same as the results reported above for Run 2 for the respective Polymer Blend Yarns.

TABLE 7

| Polymer | | | | | Elongation | | # of | |
|---|---|---|---|---|---|---|---|---|
| Blend | | Draw | Denier | Tenacity | at Break | Quality of | Broken | Density |
| Yarn | Material | Down | (g/9000 m) | (g/denier) | (%) | fabric | Yarns | (gm/m²) |
| 2 | 95.3% PLA | 3.00 | 225 | 2.59 | 26.17 | Very | 0 | 144.39 |
| | 3052D/ | | | | | good | | |
| | 4.7% Pebax | | | | | | | |
| | 2533 | | | | | | | |
| 4 | 90.3% PLA | 2.00 | 216 | 2.21 | 23.79 | Very | 0 | 150.16 |
| | 3052D/ | | | | | good | | |
| | 9.7% Pebax | | | | | | | |
| | 2533 | | | | | | | |
| 6 | 95.3% PLA | 3.00 | 223 | 2.31 | 23.25 | Very | 0 | 148.77 |
| | 3052D/ | | | | | good | | |
| | 4.7% | | | | | | | |
| | Hytrel | | | | | | | |
| | 3078 | | | | | | | |
| 10 | 90.4% PLA | 2.00 | 222 | 2.54 | 28.06 | Accept | 1 | 146.56 |
| | 3052D/ | | | | | able | | |
| | 9.6% | | | | | | | |
| | Hytrel | | | | | | | |
| | 3078 | | | | | | | |
| 16 | 85% PLA | 2.50 | 226 | 2.49 | 23.79 | Accept | 1 | 141.37 |
| | 3052D/ | | | | | able | | |
| | 15.0% PBS | | | | | | | |
| | FZ71 | | | | | | | |
| 23 | 85% PLA | 1.90 | 228 | 2.99 | 19.78 | Very | 0 | 134.62 |
| | 3052D/ | | | | | good | | |
| | 15.0% PBS | | | | | | | |
| | FD92 | | | | | | | |
| 30 | 86.8% PLA | 2.50 | 224 | 2.45 | 17.62 | bad | Multiple | 188.08 |
| | 3052D/ | | | | | | | |
| | 8.25% PBS | | | | | | | |
| | FD92/ | | | | | | | |
| | 4.95% | | | | | | | |
| | Hytrel | | | | | | | |
| | 3078 | | | | | | | |
| 33 | 86.8% PLA | 2.00 | 226 | 3.00 | 21.93 | Very | 0 | 155.20 |
| | 3052D/ | | | | | good | | |
| | 8.25% PBS | | | | | | | |
| | FD92/ | | | | | | | |
| | 4.95% | | | | | | | |
| | PEBAX | | | | | | | |
| | 2533 | | | | | | | |
| 5 | 95.3% PLA | UOY | 676 | 1.1 | 189.35 | Could | Multiple | N/A |
| | 3052D/ | | | | | not | | |
| | 4.7% | | | | | weave | | |
| | Hytrel | | | | | | | |
| | 3078 | | | | | | | |
| 8 | 90.4% PLA | UOY | 649 | 0.84 | 151.56 | Could | Multiple | N/A |
| | 3052D/ | | | | | not | | |
| | 9.6% | | | | | weave | | |
| | Hytrel | | | | | | | |
| | 3078 | | | | | | | |

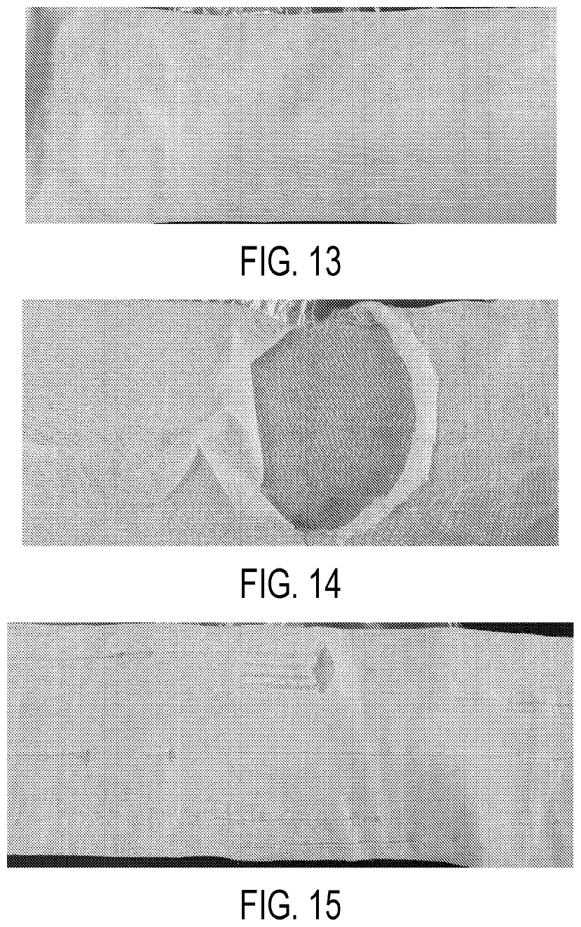

In Table 7, the quality of the knitted yarn doff samples were classified as: very good (no broken fibers in the fabric), acceptable (less than 2 broken fibers in the fabric), and bad (multiple broken fibers in the fabric, or the yarn could not be used to knit fabric). FIG. 13 shows a knitted fabric composed of Polymer Blend Yarn 6 (95.3% PLA 3052D/4.7% Hytrel® 3078), and is an example of a very good fabric with no broken fibers. FIG. 14 shows a knitted fabric composed of Polymer Blend Yarn 16 (85% PLA 3052D/15.0% PBS FZ71), and is an example of an acceptable fabric with only one broken fiber, which may be from an equipment malfunction. FIG. 15 shows a knitted fabric composed of Polymer Blend Yarn 30 (86.8% PLA 3052D/8.25% PBS FD92/4.95% Hytrel® 3078), and is an example of a bad fabric with multiple broken fibers.

The yarn from Polymer Blend Yarn 5 and 8 were made from un-oriented fibers with deniers greater than 600 that could not be weaved into fabric. Yarns with denier greater than 600 cannot be woven due to the larger fiber diameter and lower tenacity of these yarns, as shown in Table 7. The tenacity of the 600 plus denier fiber is ˜⅓ of the tenacity of the 200 denier fiber, which makes the fibers in the yarns much weaker and prone to breakage in the weaving operation.

Based on the results of Table 7, the polymer blends that produced the highest quality knitted samples were binary polymeric compositions with PLA and 5% to 10% of Hytrel® 3078 or Pebax® 2533. These binary polymeric blends had deniers between 200 and 250.

### Radiocarbon Testing

Radiocarbon testing was performed on a PLA polymeric blend of 90% PLA/10% Hytrel® 3078. The result, reported as % Biobased Carbon, indicates the percentage carbon from natural (plant or animal by-product) sources versus synthetic (petrochemical, such as coal and other fossil) sources. For reference, 100% Biobased Carbon indicates that a material is entirely sourced from plants or animal by-products and 0% Biobased Carbon indicates that a material did not contain any carbon from plants or animal by-products. A value in between represents a mixture of natural and fossil sources. The analytical measurement is provided as percent modern carbon (pMC), which is the percentage of C14 measured in the sample relative to a modern reference standard (in this case, NIST 4990C). The % Biobased Carbon content is calculated from pMC by applying a small adjustment factor for Carbon-14 in carbon dioxide in air today. Reported results are accredited to ISO/IEC 17025:2005 Testing Accreditation PJLA #59423 standards.

The results reported for the PLA polymeric blend of 90% PLA/10% Hytrel® 3078 were: 91% Biobased Carbon Content (as a fraction of total organic carbon); 90.88±0.22 pMC; atmospheric adjustment factor 100.0, =pMC/1.000. The results were obtained by measuring the ratio of radiocarbon (Carbon-14) in the blend sample relative to a National Institute of Standards and Technology (NIST) modern reference standard (SRM 4990C). This ratio was calculated as a percentage and reported as percent modern carbon (pMC). The value obtained relative to the NIST standard was normalized to the year 1950 AD by applying a small adjustment factor for Carbon-14 in carbon dioxide in air today; this adjustment calculates a carbon source value relative to today.

The blend was analyzed using ASTM D6866-18 Method B (AMS); other standards use the same analytical procedures for measuring radiocarbon content but may employ a different reporting format. Results are usually reported using the standardized terminology “% biobased carbon”. Only ASTM D6866 uses the term “% biogenic carbon” when the result represents all carbon present (total carbon) rather than just the organic carbon (total organic carbon). The terms “% biobased carbon” and “% biogenic carbon” are now the standard units in regulatory and industrial applications.

As demonstrated by these results, the pMC of the polymeric blend roughly corresponds to the percentage PLA of the blend, and pMC can be used to characterize the blends and products made with the blends.

### Global Warming Potential and Blue Water Consumption

Global Warming Potential (GWP) and Blue Water Consumption (BWC) of PLA made from corn stover were compared to GWP and BWC of PLA made from corn grain (Ingeo Polylactide (PLA), NatureWorks™), using a life cycle assessment model in GaBi ts®. The analysis was performed by WSP USA, Inc. (Boulder, Colo.) and is described in an ISO-Conformant LCA Report entitled Comparative LCA of Biobased and Conventional Plastics Production (January 2020), the contents of the publicly available version of which are hereby incorporated by reference in their entirety herein. For the process of producing PLA from corn stover, the model used production process information provided by Xyleco, Inc. Information about the process used to make the NatureWorks™ PLA from corn grain was sourced from a GaBi thinkstep dataset implementation of the process published for Ingeo Polylactide (PLA) biopolymer production by NatureWorks (Vink, E. T., Rabago, K. R., Glassner, D. A., & Gruber, P. R., Applications of life cycle assessment to NatureWorks™ polylactic (PLA) production. Polymer Degradation and Stability, 403-419 (2003)). GWP was quantified using the Intergovernmental Panel on Climate Change's (IPCC) Fifth Assessment Report (AR5) 100-year time-scale excluding biogenic carbon (IPCC AR5 GWP 100 excl. biogen), which measures GWP in carbon dioxide equivalents (kg CO₂eq). The GaBi® BWC characterization method was used to quantify blue water; BWC was measured in volume of water (liters). Blue water refers to surface and ground water and excludes rain water; water consumption is the portion of water use that is not returned to the original water source after being withdrawn and that therefore is no longer available for reuse (e.g., water lost via evaporation, or water incorporated into a product or plant, would be consumed water).

The PLA produced from corn stover according to the Xyleco process was associated with an 86% reduction in greenhouse gas emissions per kilogram of PLA, when compared to greenhouse gas emissions associated with the PLA produced from corn grain. The greenhouse gas emissions for PLA produced from corn stover were calculated to be 1.3 kgCO₂eq/kg PLA, whereas the greenhouse gas emissions for PLA produced from corn grain were calculated to be 2.5 kgCO₂eq/kg PLA. In addition, making PLA from corn stover was calculated to consume less blue water than making PLA from corn grain (21.2 liters blue water consumed per kg PLA for the PLA made from corn stover, versus 35.6 liters blue water consumed per kg PLA for the PLA made from corn grain). This difference in BWC represents a 68% reduction in BWC.

### Molecular Weight Determinations

Molecular weight determination by GPC was generally performed according to the following method: 20 mg of each sample was added to a 20 ml scintillation vial, followed by the addition of 4 ml 2,2,2 Trifluoroethanol (TFE) (Oakwood Chemical, #001273) to each vial. Samples were allowed to dissolve overnight, and then were filtered using a PTFE syringe filter (Acrodisk 13 mm Minispike PTFE Syringe Filter 0.45 μm (Pall Corporation #4553T)) into 2 ml HPLC vials. A PMMA calibration kit (Polymethyl Methacrylate EasiVial Tri-Pack, pre-weighed calibration kit (Agilent)) was used for the standards. The kit uses three vials per run; each of the three vials contains four different narrow molecular weight standards. To prepare the standards, 1.5 ml of TFE was added to each kit vial. The dissolved samples and standards were injected into a liquid chromatography system having a refractive index detector, as well as photodiode array (UV) and light scattering detectors. Three GPC columns were used (Polymer Standards Service, pfa0830071e3 (molecular weight range 10,000-1,000,000), pfa0830073e2 (molecular weight range 1,000-300,000), and pfa0830071e2 (molecular weight range 100-100,000), which allows for the analysis of polymers in the 100 to 1,000,000 dalton range. The parameters for chromatography were as follows: 40 minute run time, 40° C. column temperature, 100 μl injection volume.

Unlike proteins, molecules (or chains) in a sample of a polymeric composition are not all the same size or weight, and a given polymeric sample will have a distribution of sizes and molecular weights. Accordingly, several molecular weight values can be used to describe a polymeric composition; these molecular weights include: number average molecular weight (Mₙ), weight average molecular weight (M_{w}), and z average molecular weight (M_{z}). These molecular weights can be calculated as follows, where Mᵢ is the molecular weight of a molecular (chain) and Nᵢ is the number of molecules (chains) in the sample having that molecular weight:

$${M}_{n} = \frac{\sum {M}_{i} {N}_{i}}{\sum {N}_{i}}$$

$${M}_{w} = \frac{\sum {N}_{i} {M}_{i}^{2}}{\sum {N}_{i} {M}_{i}}$$

$${M}_{Z} = \frac{\sum {N}_{i} {M}_{i}^{3}}{\sum {N}_{i} {M}_{i}^{2}}$$

Mₙ provides a measure of the number of molecules having a particular weight. For the molecular weight distribution of a given polymeric sample, there will be equal numbers of molecules on each side of Mₙ in the distribution. M_{w} provides a measure of each molecule's contribution to the sample's average molecular weight; there will be an equal weight of molecules on each side of M_{w} in the sample's molecular weight distribution. M_{z} provides more weighting with respect to larger (higher molecular weight) molecules in the sample. The polydispersity index M_{w}/Mₙ is a measure of the broadness of the polymeric composition's molecular weight distribution; the larger the polydispersity index, the broader the molecular weight distribution (for a sample where all molecules have the same chain length, M_{w}/Mₙ=1). In the methods described herein involving molecular weight determination, a sample's chromatogram peak was analyzed to provide Mₙ, M_{w}, and/or M_{z}.

Other than in the examples herein, or unless otherwise expressly specified, all of the numerical ranges, amounts, values, and percentages, such as those for amounts of materials, elemental contents, times, and temperatures of reaction, ratios of amounts, and others, in the specification and attached claims may be read as if prefaced by the word “about” even though the term “about” may not expressly appear with the value, amount, or range. Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains error necessarily resulting from the standard deviation found in its underlying respective testing measurements. Furthermore, when numerical ranges are set forth herein, these ranges are inclusive of the recited range end points (e.g., end points may be used). When percentages by weight are used herein, the numerical values reported are relative to the total weight. Also, it should be understood that any numerical range recited herein is intended to include all sub-ranges subsumed therein. For example, a range of or from “1 to 10” is intended to include all sub-ranges between (and including) the recited minimum value of 1 and the recited maximum value of 10, that is, having a minimum value equal to or greater than 1 and a maximum value equal to or less than 10; in addition, a range of or from “1 to 5,” for example, would include sub-ranges 1 to 2, 1 to 3, etc., as well as 2 to 3, 2 to 4, etc., and so on. The terms “one,” “a,” or “an” as used herein are intended to include “at least one” or “one or more,” unless otherwise indicated.

Any patent, publication, or other disclosure material, in whole or in part, that is said to be incorporated by reference herein, but which conflicts with the statements or other disclosure material set forth herein, will only be incorporated to the extent that no conflict arises between that incorporated material and the disclosure set forth herein. To the extent necessary, the disclosure explicitly set forth herein supersedes any conflicting material incorporated herein by reference.

While this invention has been particularly shown and described with references to preferred embodiments thereof, in light of the present disclosure it will be understood by persons skilled in the art that various changes in form and details may be made therein without departing from the scope of the invention encompassed by the appended claims.

1. A binary polymeric composition comprising: polylactic acid (PLA) and an elastomeric additive.

2. The binary polymeric composition according to claim 1, wherein the binary polymeric composition comprises at least about 90 wt. % PLA and up to about 10 wt. % of the elastomeric additive.

3. The binary polymeric composition according to claim 1, wherein the binary polymeric composition comprises at least about 95 wt. % PLA and up to about 5 wt. % of the elastomeric additive.

4. The binary polymeric composition according to claim 1, wherein the PLA is present in an amount that is in the range of from 87 wt. % to 99 wt. %, and the elastomeric additive is present in an amount that is in the range of from 1 wt. % to 13 wt. %.

5. The binary polymeric composition according to claim 1, wherein the PLA is Ingeo™ Biopolymer 3052D.

6. The binary polymeric composition according to claim 1, wherein the elastomeric additive has an elongation at break, as measured by ASTM D638-14 on a tensile bar made of the elastomeric additive, that is greater than about 100 percent.

7. The binary polymeric composition according to claim 1, wherein the elastomeric additive has a hardness, as measured by ISO 868 at room temperature, that is in the range of from about 20 Shore D to about 60 Shore D.

8. The binary polymeric composition according to claim 1, wherein the elastomeric additive is Hytrel 3078, Hytrel 4068FG, PEBAX® 2533 SA 01, or ecoflex® F Blend C1200.

9. A binary polymeric composition comprising: polylactic acid (PLA) and a co-polymer additive.

10-206. (canceled)
